(19) United States
(12) Patent Application Publication
(10) Pub. No.: US 2026/0199865 A1
(43) Pub. Date: Jul. 16, 2026

(54) MODULAR MANUFACTURING FOR PHARMACEUTICALS

(71) Applicant: Beren Therapeutics P.B.C., West Hollywood, CA (US)

(72) Inventors: Steven Pfeiffer, West Hollywood, CA (US); Benjamin Rizkin, West Hollywood, CA (US)

(21) Appl. No.: 18/874,436

(22) PCT Filed: Jun. 13, 2023
(86) PCT No.: PCT/IB2023/056095

§ 371 Date: Dec. 12, 2024

Related U.S. Application Data
(60) Provisional application No. 63/351,716, filed on Jun. 13, 2022.

(51) Int. Cl. B01J 19/00; A61J 3/00

(52) U.S. Cl. CPC B01J 19/004; A61J 3/00; A61J 2200/42; A61J 2200/72; B01J 2219/0002

(57) ABSTRACT

Provided herein is a modular system for the production of pharmaceuticals. The system's modular design allows for customization and efficient operation of the system, as well as the ability to deliver pharmaceuticals on demand.

### CROSS-REFERENCE TO RELATED APPLICATIONS

This application is a 371 Application claiming priority to PCT/IB2023/056095 titled “MODULAR MANUFACTURING FOR PHARMACEUTICALS,” filed Jun. 13, 2023, which claims priority to U.S. Provisional Application No. 63/351,716 entitled “MODULAR MANUFACTURING FOR PHARMACEUTICALS” filed Jun. 13, 2022, the entire contents of which are incorporated herein by reference.

### SEQUENCE LISTING

The present application contains a Sequence Listing which has been submitted electronically in .XML format and is hereby incorporated by reference in its entirety. Said computer readable file was created on Dec. 16, 2025, is named “SubstituteSequenceListing-BTXP0034US01-SUPP.xml” and is 72,900 bytes in size.

### FIELD

The present disclosure is directed to systems and methods for modular production of pharmaceutical compositions (e.g., liquid pharmaceuticals, solid pharmaceuticals, pharmaceutical formulations, and/or combinations thereof); thus, it relates to the fields of pharmacy, medicine, and engineering.

### BACKGROUND

Manufacturing pharmaceuticals often requires specialized equipment and facilities, which often come at a high economic cost. Such facilities are often built to produce only one product.

### SUMMARY OF THE DISCLOSURE

Provided herein is a modular system for producing a pharmaceutical composition. The modular system comprises a plurality of modules, the plurality of modules comprising one or more flow modules, one or more mixing modules, one or more heat exchange modules, and one or more reactor modules. Each of the modules is operably connected to one or more other modules, and at least two modules are operably connected to the one or more reactors. In some embodiments, one or more modules in the system are mutually interchangeable. In some additional embodiments, the modular system further comprises a back pressure regulator. In still further embodiments, the pharmaceutical composition is a liquid pharmaceutical, a solid pharmaceutical, a pharmaceutical formulation, or a combination thereof.

In some embodiments, the system further comprises a controller in communication with at least one or more of the plurality of modules. In some aspects, the controller is connected electrically or wirelessly to at least one or more of the plurality of modules. In some additional aspects, the controller is configured to automatically adjust system parameters selected from the group consisting of temperature, pressure, flow rate, heat transfer rate, solvent content, solvent amount, filtration, or a combination thereof. In still further aspects, the controller is configured to be operated remotely.

In some embodiments, the plurality of modules is configured to be cleaned-in-place simultaneously with a chemical cleaning agent. In some aspects, each module does not need to be cleaned independently.

In some embodiments, the system comprises substituted and/or unsubstituted cyclodextrins, beta-cyclodextrins, hydroxypropyl beta-cyclodextrins, and combinations thereof as a pharmaceutical composition output. In other embodiments, the system comprises substituted and/or r unsubstituted cyclodextrins, beta-cyclodextrins, hydroxypropyl beta-cyclodextrins, and combinations thereof as a plurality of pharmaceutical composition outputs.

In some aspects, the system is configured to simultaneously produce a plurality of pharmaceutical composition outputs. In some additional aspects, the system is configured to produce a plurality of pharmaceutical composition outputs that comprise a mixture of common molecules in different constituent amounts.

In some embodiments, the system is configured to maintain flow rates and heat transfer rates in the plurality of modules at a predetermined level.

Further provided herein is a modular system for producing a pharmaceutical composition comprising a plurality of modules. The plurality of modules comprises a plurality of flow modules, a plurality of mixing modules, a plurality of heat exchange modules, and a plurality of reactor modules. Each of the modules is operably connected to one or more other modules to provide in-line manufacture of the pharmaceutical composition.

Further provided herein is a modular system for producing a pharmaceutical composition comprising a plurality of cases. The plurality of cases comprise two or more modules selected from one or more flow modules, one or more mixing modules, one or more heat exchange modules, and one or more reactor modules. The two or more modules are vertically stacked in each case.

Further provided herein is a modular system for producing a pharmaceutical composition comprising a plurality of modules, wherein each of the modules is operably connected to one or more other modules, and wherein the modules are stackable.

Further provided herein is a remote-controlled factory comprising any one or more of the modular systems described above.

### BRIEF DESCRIPTION OF THE FIGURES

FIG. 1 shows an exemplary system of the present disclosure.

FIG. 2 shows another view of an exemplary system of the present disclosure.

FIG. 3 shows an exemplary process flow sheet for producing hydroxypropyl cyclodextrin using a system of the present disclosure.

FIG. 4 shows a floor plan for a facility encompassing the system of the present disclosure.

FIG. 5A depicts a non-limiting example of a one enzyme reaction to convert sucrose to amylose, in accordance with embodiments of the disclosure.

FIG. 5B depicts a non-limiting example of a two enzyme reaction to convert sucrose to amylose, in accordance with embodiments of the disclosure.

FIG. 6 depicts a non-limiting example of an enzymatic reaction to convert amylose to alpha-cyclodextrin, in accordance with embodiments of the disclosure.

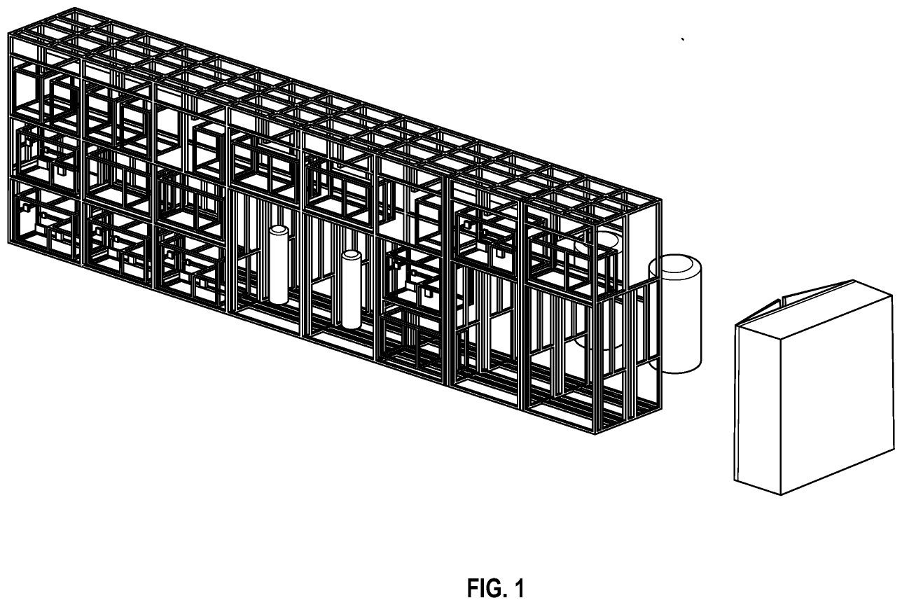

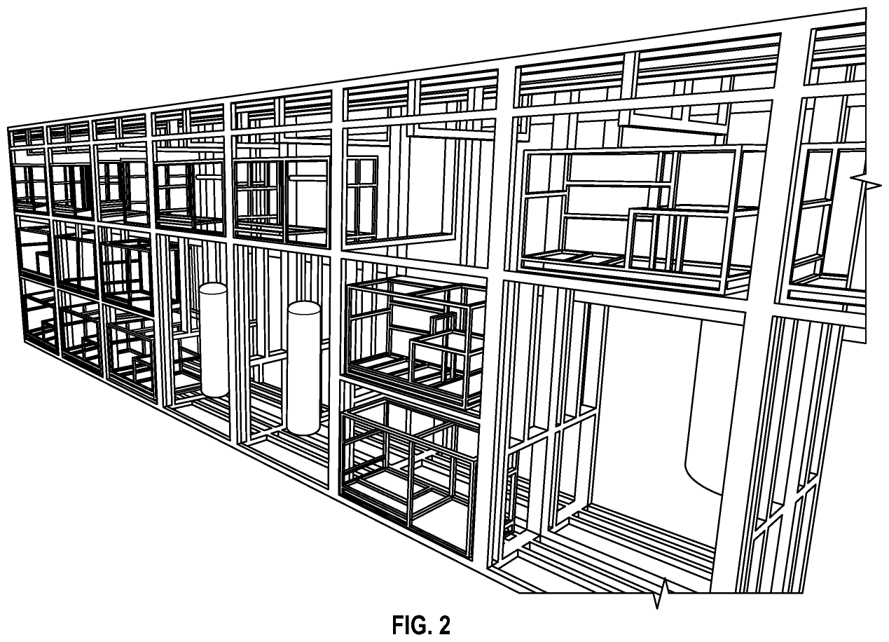

### DETAILED DESCRIPTION

Provided herein are systems for modular manufacturing of pharmaceuticals.

Specifically, the systems provided herein are useful for manufacturing liquid pharmaceuticals, solid pharmaceuticals, pharmaceutical formulations, and/or combinations thereof. The modular nature of the system allows for reconfiguration and optimization of the system. The systems provided herein may be used in remote geographic locations and/or controlled at a different physical location. In one aspect, the invention comprises a remote-controlled factory for the production of pharmaceutical compositions. In such a manner, skilled technicians may remotely program, implement, monitor, and revise the in-line manufacture of pharmaceutical compositions, without being physically present at the factory or facility. The present invention also provides cost-savings with minimal labor, limited waste output, and geographic flexibility to reduce supply chain costs. Moreover, the present invention provides cost-savings by providing in-line instrumentation that may be readily exchanged, substituted, or re-routed, thus avoiding prolonged shutdowns or wait times for service. Generally, the modular nature provides for quick repair and/or replacement of unit operations as the need to do so arises; for example, if a pump becomes damaged and must be replaced, the pump module is simply replaced with another pump module. In such a manner, the one or more modules may be mutually interchangeable. This minimizes down-time and increases production rates. It also has the benefit of enabling the production of multiple kinds of products within the same facility, or surge production of products which are in high demand. The Applicants have also determined that utilization of in-line instrumentation as described in the present invention (e.g., one or more flow modules, mixing modules, heat exchange modules, and/or reactor modules) may significantly reduce contamination, minimize human error, decrease batch variation, and improve the quality of the pharmaceutical composition being produced.

Moreover, the system may be constructed to meet particular regulatory specifications and criteria required by law. For example, the system and the facility housing the system may be designed and constructed to operate as a cleanroom, meeting ISO-7/Grade C cleanroom classification. Modules may be constructed to operate within these standards as well.

The systems provided herein include a plurality of modules. Each module may be designed and constructed to serve one or more functions. For example, a module may be a flow module, a mixing module, a heat exchange module, a reactor module, a storage module, or a measurement module (e.g., comprising a HPLC device, refractive index device, pH meter device, NMR device, LC-MS-MS device, MALDI-TOF MS device, mass spectroscopy device, or a combination thereof).

The system may include a controller in electrical or wireless communication with at least one or more of the plurality of modules. In general, the controller may include one or more processors and a non-transitory computer-readable storage medium having stored thereon instructions for causing the one or more processors to control one or more of startup, operation, or shutdown of any one or more of the various aspects of the system to facilitate safe and efficient operation. For example, the controller may interrupt power to any of the plurality of modules in the event an anomalous condition is detected. The controller may also be operable to open or close valves or adjust other system parameters to ensure safe and efficient operation of the system.

The controllers of a plurality of modules may communicate to one another and execute a protocol such that the modules perform tasks simultaneously to produce a liquid pharmaceutical (note: the term “liquid pharmaceutical” used herein may be alternatively substituted with pharmaceutical composition, solid pharmaceutical, or pharmaceutical formulation). For example, the controllers of a plurality of modules may communicate to one another and execute a protocol so that a liquid pharmaceutical is sequentially mixed, heated, cooled, pressurized, purified, and/or filtered through a plurality of modules (e.g., which each successive purification and/or filtration improving a property of the liquid pharmaceutical). Without being bound by theory, the improved property of the liquid pharmaceutical produced by the modular manufacturing process/system may be reduction in metals, reduction in toxins, reduction in average particle size, improvement in water solubility, improvement cholesterol solubility, improvement in bioavailability, improvement in hydrophobicity, or a combination thereof.

The pharmaceuticals produced by the present invention may be homogeneously dissolved solutions without precipitates or solid particles, so that they can be easily sterilized by filtration with full or nearly full recovery of the active pharmaceutical ingredient (API). The pharmaceuticals produced by the present invention may alternatively be a suspension, comprising a mixture of both liquid pharmaceutical and solid pharmaceutical. In one aspect, the current invention may comprise spray drying of the liquid pharmaceutical, which is a process that converts a liquid pharmaceutical to a dried solid particulate form. Optionally, an alternative or second drying process such as fluidized bed drying or vacuum drying may be used to reduce residual solvents to pharmaceutically acceptable levels. Typically, spray drying involves contacting a highly dispersed liquid suspension or solution, and a sufficient volume of hot gas to produce evaporation and drying of the liquid droplets. The preparation to be spray dried can be any solution, coarse suspension, slurry, colloidal dispersion, or paste that may be atomized using a spray drying apparatus. Generally, the pharmaceutical composition or formulation of the present invention may include any dosage form suitable for oral administration and in particular may include tablets (preferably direct compressed tablets and pills, either in a form for intact swallowing (e.g. also film-coated) or in a form capable of rapid disintegration (either in the oral cavity after ingestion or in a small amount of liquid prior to ingestion), including chewable forms, mini tablets, dry powders, granules, capsules or sachets containing these granules or mini-tablets (micro-tablets), wafers, lozenges, crystals, particulates, and the like. The form for intact swallowing may be film-coated, if desired. The pharmaceutical composition of the invention includes also powders or granules, which may be optionally compressed or compacted into tablets.

Further, the pharmaceuticals produced by the present invention may comprise the term pharmaceutical formulations (or formulations), which cover mixture of active ingredients (preferably one, two or three) and pharmaceutically acceptable excipients, and which are in a form adapted to the preparation/manufacturing of a pharmaceutical product (e.g. pharmaceutical composition). Choice of fillers and other excipients will depend on the chemical and physical properties of the pharmaceutical, behavior of the mixture during processing and the properties of the final pharmaceutical form. In the present invention the formulations may comprise powders or granules adapted for compaction or compression or direct compression into tablets. In the present invention the term compressed may cover any physical compaction process resulting in solid dosage units.

In another aspect, the controllers of a plurality of modules may communicate to one another and execute a protocol so that a liquid pharmaceutical is sequentially mixed, heated, cooled, pressurized, purified, and/or filtered through a plurality of modules in series or in parallel. A single stream may comprise a plurality of modules in a series. The system may also comprise a plurality of streams in series or in parallel. The system may be configured to produce liquid pharmaceuticals as a continuous process or batchwise. The system may also comprise one or more recycle loops.

In one embodiment, the system comprises a plurality of modules that may communicate to one another and execute a protocol so that a liquid pharmaceutical is sequentially mixed, heated, cooled, pressurized, purified, and/or filtered in parallel, wherein the system provides a plurality of liquid pharmaceutical outputs operable to generate a volume of at least about 50 mL, 100 mL, 200 mL, 500 mL, 750 mL, 1 L, 2 L, or 4 L. In such a configuration, if any one module in parallel has a mechanical failure or produces an undesirable liquid pharmaceutical output, the problem module or plurality of modules may be isolated, removed, or replaced without jeopardizing the other liquid pharmaceutical outputs in parallel.

The systems generally also include a controller that can automatically adjust system parameters (e.g., temperature, pressure, flow rate(s), heat transfer rate(s), solvent content and amount(s), residence time, filter selection, number of filtrations to be performed, and turn-on and shut-off connectivity between and among the plurality of modules) in response to data inputs from instrumentation included in the system. Each module contains piping and instrumentation that is operable to connect with one or more of the other modules and/or to the controller. Generally, each system contains at least one reactor module or plurality of reactor modules.

The flow modules may include piping and valves to direct the flow of material to a destination (e.g., another module). Any valves and piping known to those having skill in the art may be used; moreover, the skilled artisan will appreciate that different valve types and piping materials may be required based on process conditions and the materials used. The valves may be controlled via the controller. The flow modules may also include instrumentation such as flow rate sensors, temperature sensors, back pressure regulators, and pressure sensors that may be operably connected to the controller.

The mixing modules include a mixer operable to mix material into a homogeneous form. The mixer may include a static mixer (e.g., a helical static mixer in line) or any other mixer known to those having ordinary skill in the art. The mixing modules may include temperature sensors, flow rate sensors, pressure sensors, and/or level sensors that are operably connected to the controller. The controller may be operable to adjust parameters such as mixing speed or temperature in response to data inputs from the system.

The heat exchange modules include a heat exchange unit to perform heat exchange operations. The heat exchanger may be any heat exchanger known in the art, such as a shell and tube heat exchanger, a double tube heat exchanger, a tube in tube heat exchanger, or a plate heat exchanger. A heat exchange fluid (e.g., water or steam) may be provided to the heat exchange module, or the ambient environment may be suitable for heat exchange. Such heat exchange fluids are known to those having ordinary skill in the art. The heat exchange module may also include temperature sensors and/or flow sensors that are operably connected to the controller. The controller may be operable to adjust parameters such as flow rate or temperature in response to data inputs from the system.

The reactor modules include a reactor for performing chemical reactions. The reactor may be any reactor known in the art, such as a plug flow reactor, a continuously stirred tank reactor, a batch reactor, a semi-batch reactor, or any other reactor known in the art. In preferred embodiments, the reactor is a plug flow reactor. The reactor modules may include temperature sensors, pressure sensors, and/or flow sensors that are operably connected to the controller.

The reactor in each reactor module may comprise a plug flow reactor, which may comprise at least one coil of tubing. In some embodiments, the system may comprise two or more reactors. In additional embodiments, the plug flow reactor may comprise at least two coils of tubing. The reactor may have a volume of about 1 to about 1000 mL, about 1 to about 500 mL, about 1 to about 250 mL, or about 1 to about 100 ml; for example, about 1 mL, about 2 mL, about 3 mL, about 4 mL, about 5 mL, about 6 mL, about 7 mL, about 8 mL, about 9 mL, about 10 mL, about 20 mL, about 30 mL, about 40 mL, about 50 mL, about 60 mL, about 70 mL, about 80 mL, about 90 mL, about 100 mL, about 250 mL, about 500 mL, or about 1000 mL. The reactor may also have a volume of greater than 100 mL, greater than 250 mL, greater than 500 mL, or greater than 1000 mL.

The volume of the reactor in the reactor module and the flow rate of the reactants may be used to determine a residence time of the reactants in the reactor. The reactants may have a residence time in the reactor of about 1 minute to about 360 minutes, of about 3 minutes to about 180 minutes, about 5 minutes to about 90 minutes, or about 10 minutes to about 60 minutes; for example, about 10 minutes, about 15 minutes, about 20 minutes, about 25 minutes, about 30 minutes, about 35 minutes, about 40 minutes, about 45 minutes, about 50 minutes, about 55 minutes, or about 60 minutes. The reactants may have a residence time in the reactor greater than about 60 minutes, greater than about 90 minutes, greater than about 180 minutes, or greater than about 360 minutes.

The storage modules include a storage tank for storing products, reactants, and waste generated during or provided for the process. The storage modules may include temperature sensors, flow sensors, pressure sensors, and/or level sensors that are operably connected to the controller.

Additional modules or process units may be included in the systems of the present disclosure. For example, the system may further include a spray drier or a spray drier module. In another example, the system may include a cyclone separator or a cyclone separator module. In still another example, the system may include an extruder or an extruder module. Spray driers, cyclone separators, and extruders are generally well-known and described in the art. The system may also comprise and/or connect to one or more prefabricated modules available to those of skill in the art (e.g., Zeton modules).

Alternatively, the system may include storage systems separate from the modules of the present disclosure. These storage systems are operably connected to one or more modules of the system of the present disclosure.

The system may also include one or more filtration modules to purify the pharmaceutical composition. In particular, the filtration module may include a sterile filter (such as a capsule filter), a Nutsche filter, a nanofilter, a tangential flow filtration system, or combinations thereof. Much like the other components of the system described herein, the filtration modules may be operable to connect with one or more of the other modules and/or to the controller.

In embodiments including a nanofilter, the nanofilter may comprise a flat sheet membrane to accomplish the nanofiltration. Flat sheet membranes and methods of making and procuring flat sheet membranes for nanofiltration are generally known in the art. The flat sheet membrane may have an area of from about 0.010 m² to about 0.500 m², about 0.050 m² to about 0.100 m², or about 0.010 m² to about 0.050 m². For example, the flat sheet membrane may have an area of about 0.010 m², about 0.015 m², about 0.020 m², about 0.025 m², about 0.030 m², about 0.035 m², about 0.040 m², about 0.045 m², or about 0.050 m². The flat sheet membrane may have an area greater than 0.010 m², greater than about 0.025 m², greater than about 0.050 m², greater than about 0.100 m², or greater than about 0.500 m².

The nanofiltration permeate may be collected for a total of at least 1 diafiltration volumes, at least 2 diafiltration volumes, at least 3 diafiltration volumes, at least 4 diafiltration volumes, or at least 5 diafiltration volumes. For example, the nanofiltration permeate may be collected for a total of at least 5 diafiltration volumes, at least 6 diafiltration volumes, at least 7 diafiltration volumes, at least 8 diafiltration volumes, at least 9 diafiltration volumes, or at least 10 diafiltration volumes. In some embodiments, the nanofiltration permeate may be collected for greater than 10 diafiltration volumes.

The filtration retentate may be analyzed for propylene glycol content. Methods of analyzing a composition for propylene glycol content are generally known in the art, and may include mass spectrometry, high pressure liquid chromatography, gas chromatography, etc.

In a particular embodiment, the purification system may include an activated carbon purification module. The activated carbon purification module includes a vessel containing activated carbon. In some embodiments, the activated carbon may be prepared by first washing the activated carbon with purified water to remove any salts. The pharmaceutical composition produced by the system may be introduced to the activated carbon purification module and the activated carbon and the pharmaceutical composition may be agitated to ensure that the pharmaceutical composition makes sufficient contact with the activated carbon to remove impurities from the pharmaceutical composition.

The systems also include a plurality of cases. A case as defined herein is a structure that is operable to house one or more modules and the electronics or piping necessary to operably connect the one or more modules to other parts of the system, such as a controller or another case. Each case comprises one or more of the plurality of modules; for example, each case may comprise one module, two modules, three modules, four modules, and so on. Additionally, a case may be designed and constructed to house three modules but may only house one or two modules at a given time as the system requires. In preferred embodiments, the case is structured such that the modules are stacked vertically in each case.

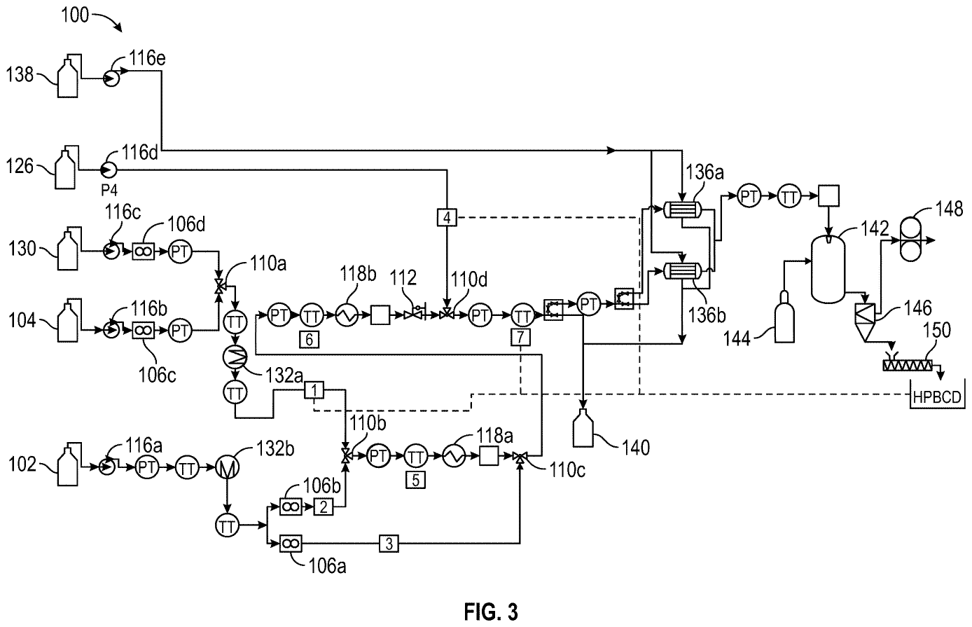

Referring now to FIG. 3, an exemplary system of the present disclosure is operable to produce hydroxypropyl beta-cyclodextrin (HPBCD). The system 100 includes at least one propylene oxide feed 102; however, it is noted that the system may include at least two propylene oxide feeds (i.e., a plurality of propylene oxide feeds), at least three propylene oxide feeds, and so on. The propylene oxide feed 102 may comprise a tank having piping and instrumentation operable to deliver the propylene oxide to the system 100. Although not shown in FIG. 3, the propylene oxide may be introduced into the system at one or more locations. The propylene oxide may be introduced at a flow rate of from about 0.1 g/min to about 10 g/min; for example, about 0.1 g/min, 0.2 g/min, 0.3 g/min, 0.4 g/min, 0.5 g/min, 0.6 g/min, 0.7 g/min, 0.8 g/min, 0.9 g/min, 1.0 g/min, 2.0 g/min, 3.0 g/min, 4.0 g/min, 5.0 g/min, 6.0 g/min, 7.0 g/min, 8.0 g/min, 9.0 g/min, or about 10.0 g/min. The propylene oxide may be dosed in one or more places in the system 100. In general, at least one dose of propylene oxide is dosed before a reactor 118. In some embodiments, the propylene oxide feed may comprise a racemic mixture of propylene oxide; in other embodiments, the propylene oxide feed may comprise an enantiopure propylene oxide. The propylene oxide may comprise deuterated propylene oxide.

The propylene oxide may be dosed at a concentration of from about 1 to about 20, from about 3.5 to about 20, from about 5 to about 20, from about 7 to about 20, from about 1 to about 15, from about 3.5 to about 15, from about 5 to about 15, or from about 7 to about 15 molar equivalents of beta-cyclodextrin (BCD). For example, the propylene oxide may be dosed at a concentration of about 1, about 2, about 3, about 4, about 5, about 6, about 7, about 8, about 9, about 10, about 11, about 12, about 13, about 14, about 15, about 16, about 17, about 18, about 19, or about 20 molar equivalents of BCD. In embodiments where the propylene oxide is dosed in two places, the first propylene oxide feed may provide propylene oxide at a concentration from about 7 to about 15 molar equivalents of BCD, and the second propylene oxide feed may provide propylene oxide at a concentration from about 3.5 to about 15 molar equivalents of BCD.

The system 100 includes at least one BCD feed 104. The BCD feed 104 may comprise a tank having piping and instrumentation operable to deliver the BCD to the system 100. The BCD may be introduced at a flow rate of from greater than 0.0 g/min up to about 20 g/min, from about 0.1 g/min to about 10 g/min, from about 0.5 g/min to about 7 g/min, or from about 1.0 g/min to about 5 g/min; for example, about 0.1 g/min, about 0.2 g/min, about 0.3 g/min, about 0.4 g/min, about 0.5 g/min, about 0.6 g/min, about 0.7 g/min, about 0.8 g/min, about 0.9 g/min, about 1.0 g/min, about 2.0 g/min, about 3.0 g/min, about 4.0 g/min, about 5.0 g/min, about 6.0 g/min, about 7.0 g/min, about 8.0 g/min, about 9.0 g/min, or about 10.0 g/min. The BCD feed may comprise deuterated BCD.

The system may further comprise a base or sodium hydroxide (NaOH) feed 130. The base or sodium hydroxide may be provided at a concentration of from about 1 to about 10, from about 3 to about 10, from about 5 to about 10, or from about 7 to about 10 molar equivalents of BCD, or more preferably about 5 to about 10 molar equivalents of BCD. In some embodiments, the BCD feed may comprise the base or sodium hydroxide.

The propylene oxide feed(s) 102 and/or the BCD feed(s) 104 may be pressurized. Pressurizing the feeds may be beneficial when low flow rates (e.g., about 1.5 g/min) of the reactants are required. The feeds may be pressurized with an inert gas, such as a noble gas (e.g., helium, neon, argon, krypton, or xenon), or another non-reactive gas, such as nitrogen or carbon dioxide. The inert gas may be provided in a pressurization tank operably connected to the feed.

The propylene oxide feed(s) 102, the BCD feed(s) 104, and/or the base or sodium hydroxide feed 130 may be operably connected to a mass flow controller (106a, 106b, 106c, 106d). The mass flow controller is operable to determine and adjust the mass flow rate of the propylene oxide or BCD. Mass flow controllers and methods of measuring and controlling mass flow rates are generally known in the art. Additional mass flow controllers may be included at other locations in the system to monitor the mass flow rate of the reactants and/or products.

The propylene oxide feed(s) 102, the BCD feed(s) 104, and/or the base or sodium hydroxide feed 130 may be operably connected to a mass flow meter. The mass flow meter is operable to determine the mass flow rate of the propylene oxide or BCD. Mass flow meters and methods of measuring mass flow rates are generally known in the art. Additional mass flow meters may be included at other locations in the system to monitor the mass flow rate of the reactants and/or products.

The mass flow meter(s) and/or the mass flow controller(s) (106a, 106b, 106c, 106d) may be operably connected to a controller. The controller may be operable to communicate electronically or wirelessly to any of the system components. In general, the controller may include one or more processors and a non-transitory computer-readable storage medium having stored thereon instructions for causing the one or more processors to control one or more of startup, operation, or shutdown of any one or more of the various aspects of the system to facilitate safe and efficient operation. For example, the controller may interrupt power to any of the system components in the event an anomalous condition is detected. The controller may also be operable to open or close valves or adjust other system parameters (e.g., temperature and pressure) to ensure safe and efficient operation of the system.

The system 100 may further comprise at least one static mixer (110a, 110b, 110c, 110d). The static mixer is operable to continuously mix the fluids flowing through the static mixer without the use of moving parts by directing flow to increase turbulence. Static mixers are generally well-known in the art and may comprise plates, baffles, helical elements, or geometric grids. In an exemplary embodiment, the static mixer is a helical static mixer. The system 100 may include one or more static mixers at various points in the system 100.

One or more of the feeds may be operably connected to a pump (116a, 116b, 116c, 116d, 116e). The pump may be any pump known in the art, including centrifugal pumps, positive displacement pumps, syringe pumps, etc. The pump may be operably connected to one or more of the feeds. In an exemplary embodiment, the system includes a syringe pump operably connected to the BCD feed.

In step 1 of FIG. 3, sodium hydroxide (NaOH) and beta-cyclodextrin (BCD) are pumped into a static mixer 110a for mixing and then are delivered to a heat exchanger 132a. Mass flow controllers 106c and 106d control the flow of each ingredient into the static mixer 110a.

In step 2, propylene oxide is heated in a heat exchange module 132b and split into two streams. The BCD mixture from step 1 and the propylene oxide from step 2 are mixed in a static mixer 110b. In step 5 of FIG. 3, this mixture then enters a plug flow reactor 118a, where the BCD reacts with the propylene oxide to form hydroxypropyl beta-cyclodextrin (HPBCD).

In step 3 more propylene oxide is added to the resultant mixture from Step 5. This mixture is then reacted in a second plug flow reactor 118b in step 6. Acid (such as hydrochloric acid) is then added to the mixture to decrease the pH of the mixture. The acid may be from acid feed 126. The acid feed 126 may be operably connected to the static mixer 110d. The acid feed 126 may comprise hydrochloric acid, sulfuric acid, lactic acid, acetic acid, formic acid, citric acid, oxalic acid, uric acid, malic acid, fumaric acid, tartaric acid, or a combination thereof.

The system 100 may further comprise a back pressure regulator 112. The back pressure regulator is operable to maintain a predetermined set pressure upstream from the back pressure regulator. Generally, the back pressure regulator 112 is placed near the end of the system 100. Thus, the back pressure regulator may be operably connected to the collection tank 124. The back pressure regulator may also be operably connected to a reactor. The back pressure regulator may be operable to maintain a back pressure of from about 0 psi to about 500 psi, from about 1 psi to about 400 psi, from about 1 psi to about 300 psi, from about 3 psi to about 200 psi, from about 5 psi to about 100 psi, or from about 10 psi to about 50 psi; for example, about 10 psi, about 15 psi, about 20 psi, about 25 psi, about 30 psi, about 35 psi, about 40 psi, about 45 psi, or about 50 psi. The back pressure regulator may be operable to maintain a back pressure greater than 5 psi, greater than 10 psi, greater than 25 psi, greater than 50 psi, greater than 100 psi, greater than 200 psi, greater than 300 psi, greater than 400 psi, or greater than 500 psi.

In step 7, the mixture is then pumped to one of two filtration modules (136a, 136b), such as two nanofiltration units. The filtration modules (136a, 136b) may be connected in parallel as shown such that one may be used while the other is off-line. Alternatively, in step 7, if the system is being purged or cleaned, the contents of the piping may be pumped to a waste disposal system 140. Once the mixture is filtered, the mixture is spray dried in an atomizer 142 in a dry nitrogen atmosphere, which is optionally provided by a nitrogen feed 144. The spray dried HPBCD is delivered to a cyclone separator 146, which is optionally operably connected to a vacuum pump 148, followed by an extruder 150. Optionally, the HPBCD may be recycled back into the system at various points, such as at steps 1, 4, or 7.

It will be understood to those having ordinary skill in the art that the various pressure transmitters (PT), temperature transmitters (TT), valves, and other equipment shown in FIG. 3 are optional and may be removed or differently organized without impacting the overall function of the system.

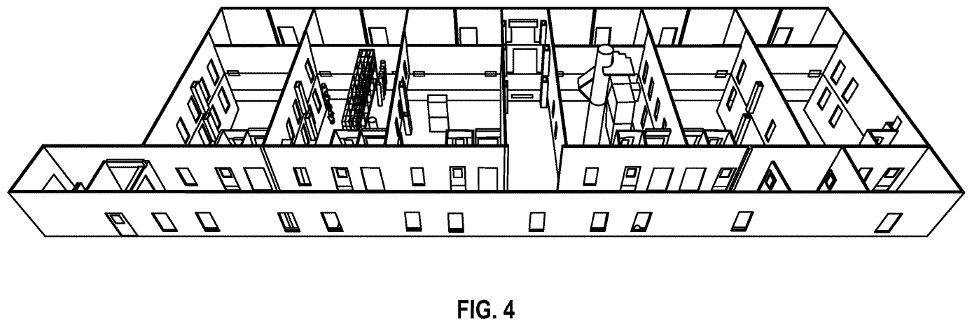

Referring now to FIG. 4, a facility may be constructed encompassing the system of the present disclosure. The facility may be built specifically to house the system and to provide further unit operations. The facility may be pre-manufactured and deployable at any location. Such deployability is important for meeting high or rapidly increasing demand in remote areas. Such deployability may also be important since the system of the present disclosure may be staffed by lay persons, unskilled workers, and/or individuals without specialized training (e.g., engineering, chemistry, biochemistry biology, pharmacology, or pharmacy). The system of the present disclosure is configured to provide production of liquid pharmaceuticals, wherein quality and/or system parameters may be controlled remotely and/or at a different physical location from the facility (e.g., more than about 5, 10, 25, 50, 100, 200, 300, 500, 1000, or 1500 miles away from the facility).

The facility may be designed and manufactured to clean room standards; e.g., meeting ISO-7/Grade C cleanroom classification. The facility may be FDA certified and/or have GMP certification. The facility may be manufactured to include HVAC, electrical, and plumbing systems operable to be used with the system of the present disclosure. In some examples, the facility may have corridors and compartments dedicated to such operations to keep them separated from the system of the present disclosure. The facility may also include amenities for personnel operating the facility.

The liquid pharmaceuticals may comprise, but are not limited to, mixtures of substituted and/or unsubstituted cyclodextrins, beta-cyclodextrins, hydroxypropyl beta-cyclodextrins, and combinations thereof. The systems provided herein are useful for manufacturing liquid pharmaceuticals of high purity (e.g., ≥90%, ≥95%, ≥96%, ≥97%, ≥98%, >99%, or ≥99.5% pure), including isomers, regioisomers, and/or stereoisomers thereof. The liquid pharmaceuticals described herein are understood to be pharmaceutically acceptable and suitable for administration to a human subject in need thereof (e.g., orally, intravenously, intrathecally, topically, subdermally, enterally, or parenterally).

In another aspect, the system comprises a feed tank comprising a motor to dissolve reagents. The reactants may be added individually or together. The reactants may be added, e.g., into a mixer module or reactor module as part of a one-pot-process. In another aspect, the system further comprises plurality of modules that are configured to be cleaned-in-place simultaneously with a chemical cleaning agent pumped through the module connections. The chemical cleaning agent may be heated and/or comprise an antimicrobial (e.g., bleach). The clean-in-place functionality may allow the entire system to be cleaned and ready for the next liquid pharmaceutical production run without having to clean and certify each individual module.

Further provided herein are compositions produced using one or more of the systems and/or methods provided herein, the compositions comprising a mixture of beta-cyclodextrin molecules wherein the mixture of beta-cyclodextrin molecules may include beta-cyclodextrin substituted with zero hydroxypropyl groups (“DS-0”, also referred to as “unsubstituted”), beta-cyclodextrin substituted with one hydroxypropyl group (“DS-1”), beta-cyclodextrin substituted with two hydroxypropyl groups (“DS-2”), beta-cyclodextrin substituted with three hydroxypropyl groups (“DS-3”), beta-cyclodextrin substituted with four hydroxypropyl groups (“DS-4”), beta-cyclodextrin substituted with five hydroxypropyl groups (“DS-5”), beta-cyclodextrin substituted with six hydroxypropyl groups (“DS-6”), beta-cyclodextrin substituted with seven hydroxypropyl groups (“DS-7”), beta-cyclodextrin substituted with eight hydroxypropyl groups (“DS-8”), beta-cyclodextrin substituted with nine hydroxypropyl groups (“DS-9”), beta-cyclodextrin substituted with ten hydroxypropyl groups (“DS-10”), beta-cyclodextrin substituted with eleven hydroxypropyl groups (“DS-11”), beta-cyclodextrin substituted with twelve hydroxypropyl groups (“DS-12”), beta-cyclodextrin substituted with thirteen hydroxypropyl groups (“DS-13”), and beta-cyclodextrin substituted with fourteen hydroxypropyl groups (“DS-14”). The degree of substitution of the mixture of beta-cyclodextrin molecules may be determined by matrix-assisted laser desorption ionization time-of-flight mass spectrometry (MALDI-TOF-MS). As relevant here, the number of hydroxypropyl groups per anhydroglucose unit in the mixture of beta-cyclodextrins is the “molar substitution”, or “MS”, and is determined according to the procedures set forth in the USP monograph on Hydroxypropyl Betadex (USP NF 2015) (“USP Hydroxypropyl Betadex monograph”), incorporated herein by reference in its entirety. In this disclosure, the term “average molar substitution”, or “MSₐ”, is used synonymously with “MS” as that term is used in the USP Hydroxypropyl Betadex monograph, and the term “glucose unit” is used as a synonym for “anhydroglucose unit” as that term is used in the USP Hydroxypropyl Betadex monograph. As further relevant here, the “average number of hydroxypropyl groups per beta-cyclodextrin,” also known as an “average degree of substitution,” “average DS,” or “DSₐ,” refers to the total number of hydroxypropyl groups in a population of beta-cyclodextrins divided by the number of beta-cyclodextrin molecules. In an illustrative example, an equal parts mixture of beta-cyclodextrins containing glucose units that are each substituted with one hydroxypropyl group and beta-cyclodextrins containing glucose units that are each substituted with two hydroxypropyl groups has a DSₐ=10.5 (average of equal parts beta-cyclodextrins with DS=7 and DS=14). In another illustrative example, a mixture of 33.3% beta-cyclodextrins in which only one of the seven glucose units is substituted with a hydroxypropyl group (i.e., DS=1) and 66.7% beta-cyclodextrins containing glucose units that are each substituted with one hydroxypropyl group (i.e., DS=7) has a DSₐ=5.0. The DSₐ is determined by multiplying the MS by 7. As further relevant here, the “degree of substitution” or “DS” refers to the total number of hydroxypropyl groups substituted directly or indirectly on a beta-cyclodextrin molecule. For example, a beta-cyclodextrin molecule containing glucose units, each of which is substituted with one hydroxypropyl group, has a DS=7. In another example, a beta-cyclodextrin molecule in which only one of the seven glucose units is substituted with a hydroxypropyl group, and that hydroxypropyl group is itself substituted with another hydroxypropyl group (e.g., a beta-cyclodextrin with a single occurrence of HP that comprises two hydroxypropyl groups), has a DS=2. As used herein, DSₐ is used synonymously with “degree of substitution” as that term is defined in the USP Hydroxypropyl Betadex monograph.

In certain embodiments, the pharmaceutical compositions of the disclosure comprise, as a pharmaceutically active ingredient, a mixture of unsubstituted beta-cyclodextrin molecules and beta-cyclodextrin molecules substituted at one or more hydroxyl positions by hydroxypropyl groups, wherein the mixture has an average number of hydroxypropyl groups per beta-cyclodextrin molecule (DSₐ) of about 3 to about 7.

In some embodiments, the DSₐ is from about 3 to about 5, such as from about 3 to about 4. In some embodiments, the DSₐ is 3.3±0.3, 3.5±0.3, or 3.7±0.3. In other embodiments, the DSₐ is 3.2±0.2, 3.3±0.2, 3.4±0.2, 3.5±0.2, 3.6±0.2, 3.7±0.2, or 3.8±0.2. In other embodiments, the DSₐ is 3.1±0.1, 3.2±0.1, 3.3±0.1, 3.4±0.1, ±0.1, 3.6±0.1, 3.7±0.1, 3.8±0.1, or 3.9±0.1.

In some embodiments, the DSₐ is from about 3.5 to about 5.5, such as from about 3.5 to about 4.5. In some embodiments, the DSₐ is 3.8±0.3, 4.0±0.3, or 4.2±0.3. In other embodiments, the DSₐ is 3.7±0.2, 3.8±0.2, 3.9±0.2, 4.0±0.2, 4.1±0.2, 4.2±0.2, or 4.3±0.2. In other embodiments, the DSₐ is 3.6±0.1, 3.7±0.1, 3.8±0.1, 3.9±0.1, 4.0±0.1, 4.1±0.1, 4.2±0.1, 4.3±0.1, or 4.4±0.1.

In some embodiments, the DSₐ is from about 4 to about 6, such as from about 4 to about 5. In some embodiments, the DSₐ is 4.3±0.3, 4.5±0.3, or 4.7±0.3. In other embodiments, the DSₐ is 4.2±0.2, 4.3±0.2, 4.4±0.2, 4.5±0.2, 4.6±0.2, 4.7±0.2, or 4.8±0.2. In other embodiments, the DSₐ is 4.1±0.1, 4.2±0.1, 4.3±0.1, 4.4±0.1, 4.5±0.1, 4.6±0.1, 4.7±0.1, 4.8±0.1, or 4.9±0.1.

In some embodiments, the DSₐ is from about 4.5 to about 6.5, such as from about 4.5 to about 5.5. In some embodiments, the DSₐ is 4.8±0.3, 5.0±0.3, or 5.2±0.3. In other embodiments, the DSₐ is 4.7±0.2, 4.8±0.2, 4.9±0.2, 5.0±0.2, 5.1±0.2, 5.2±0.2, or 5.3±0.2. In other embodiments, the DSₐ is 4.6±0.1, 4.7±0.1, 4.8±0.1, 4.9±0.1, 5.0±0.1, 5.1±0.1, 5.2±0.1, 5.3±0.1, or 5.4±0.1.

In some embodiments, the DSₐ is from about 5 to about 7, such as from about 5 to about 6. In some embodiments, the DSₐ is 5.3±0.3, 5.5±0.3, or 5.7±0.3. In other embodiments, the DSₐ is 5.2±0.2, 5.3±0.2, 5.4±0.2, 5.5±0.2, 5.6±0.2, 5.7±0.2, or 5.8±0.2. In other embodiments, the DSₐ is 5.1±0.1, 5.2±0.1, 5.3±0.1, 5.4±0.1, 5.5±0.1, 5.6±0.1, 5.7±0.1, 5.8±0.1, or 5.9±0.1.

In some embodiments, the DSₐ is from about 5.5 to about 6.5. In some embodiments, the DSₐ is 5.8±0.3, 6.0±0.3, or 6.2±0.3. In other embodiments, the DSₐ is 5.7±0.2, 5.8±0.2, 5.9±0.2, 6.0±0.2, 6.1±0.2, 6.2±0.2, or 6.3±0.2. In other embodiments, the DSₐ is 5.6±0.1, 5.7±0.1, 5.8±0.1, 5.9±0.1, 6.0±0.1, 6.1±0.1, 6.2±0.1, 6.3±0.1, or 6.4±0.1.

In some embodiments, the DSₐ is from about 6 to about 7. In some embodiments, the DSₐ is 6.3±0.3, 6.5±0.3, or 6.7±0.3. In other embodiments, the DSₐ is 6.2±0.2, 6.3±0.2, 6.4±0.2, 6.5±0.2, 6.6±0.2, 6.7±0.2, or 6.8±0.2. In other embodiments, the DSₐ is 6.1±0.1, 6.2±0.1, 6.3±0.1, 6.4±0.1, 6.5±0.1, 6.6±0.1, 6.7±0.1, 6.8±0.1, or 6.9±0.1.

In some embodiments, the DSₐ is about 4.1±15%, about 4.2±15%, about 4.3±15%, about 4.4±15%, or about 4.5±15%, such as about 4.1±10%, about 4.2±10%, about 4.3±10%, about 4.4±10%, or about 4.5±10%, such as about 4.1±5%, about 4.2±5%, about 4.3±5%, about 4.4±5%, or about 4.5±5%. For example, in certain embodiments, the DSₐ is about 4.31±10%, about 4.32±10%, about 4.33±10%, about 4.34±10%, about 4.35±10%, about 4.36±10%, or about 4.37±10%, such as about 4.31±5%, about 4.32±5%, about 4.33±5%, about 4.34±5%, about 4.35±5%, about 4.36±5%, or about 4.37±5%. In particular embodiments, the DSₐ is about 4.34±10%, such as about 4.34±5%.

In some embodiments, the DSₐ is about 4.3±15%, about 4.4±15%, about 4.5±15%, about 4.6±15%, or about 4.7±15%, such as about 4.3±10%, about 4.4±10%, about 4.5±10%, about 4.6±10%, or about 4.7±10%, such as about 4.3±5%, about 4.4±5%, about 4.5±5%, about 4.6±5%, or about 4.7±5%. For example, in certain embodiments, the DSₐ is about 4.47±10%, about 4.48±10%, about 4.49±10%, about 4.50±10%, about 4.51±10%, about 4.52±10%, or about 4.53±10%, such as about 4.47±5%, about 4.48±5%, about 4.49±5%, about 4.50±5%, about 4.51±5%, about 4.52±5%, or about 4.53±5%. In particular embodiments, the DSₐ is about 4.50±10%, such as about 4.50±5%.

In some embodiments, the DSₐ is about 6.1±15%, about 6.2±15%, about 6.3±15%, about 6.4±15%, or about 6.5±15%, such as about 6.1±10%, about 6.2±10%, about 6.3±10%, about 6.4±10%, or about 6.5±10%, such as about 6.1±5%, about 6.2±5%, about 6.3±5%, about 6.4±5%, or about 6.5±5%. For example, in certain embodiments, the DSₐ is about 6.34±10%, about 6.35±10%, about 6.36±10%, about 6.37±10%, about 6.38±10%, about 6.39±10%, or about 6.40±10%, such as about 6.34±5%, about 6.35±5%, about 6.36±5%, about 6.37±5%, about 6.38±5%, about 6.39±5%, or about 6.40±5%. In particular embodiments, the DSₐ is about 6.37±10%, such as about 6.37±5%.

In some embodiments, the DSₐ is about 6.3±15%, about 6.4±15%, about 6.5±15%, about 6.6±15%, or about 6.7±15%, such as about 6.3±10%, about 6.4±10%, about 6.5±10%, about 6.6±10%, or about 6.7±10%, such as about 6.3±5%, about 6.4±5%, about 6.5±5%, about 6.6±5%, or about 6.7±5%. For example, in certain embodiments, the DSₐ is about 6.50±10%, about 6.51±10%, about 6.52±10%, about 6.53±10%, about 6.54±10%, about 6.55±10%, or about 6.56±10%, such as about 6.50±5%, about 6.51±5%, about 6.52±5%, about 6.53±5%, about 6.54±5%, about 6.55±5%, or about 6.56±5%. In particular embodiments, the DSₐ is about 6.53±10%, such as about 6.53±5%.

The distribution of the degree of substitution within a mixture of unsubstituted beta-cyclodextrin molecules and beta-cyclodextrin molecules substituted at one or more hydroxyl positions by hydroxypropyl groups can vary. For example, an equal parts mixture of beta-cyclodextrins containing glucose units each of which is substituted with one hydroxypropyl group and beta-cyclodextrins containing glucose units each of which is substituted with two hydroxypropyl groups has a DSₐ=10.5 (average of equal parts beta-cyclodextrins with DS=7 and DS=14). Although DSₐ=10.5, in this example there are no beta-cyclodextrins having DS=10 or DS=11 within the mixture. In other cases, the majority of beta-cyclodextrins within the mixture of beta-cyclodextrins have DS that are close to the DSₐ.

In some embodiments of the disclosure, at least about 50%, e.g., at least about 55%, about 60%, about 65%, about 70%, about 75%, about 80%, about 85%, about 90%, about 95%, or about 97%, of the beta-cyclodextrins within the mixture have a DS within DSₐ±Xσ, wherein σ is the standard deviation, and X is 1, 2, or 3. For example, in some embodiments, at least about 50%, e.g., at least about 55%, about 60%, about 65%, about 70%, about 75%, about 80%, about 85%, about 90%, about 95%, or about 97%, of the beta-cyclodextrins within the mixture have a DS within DSₐ±1σ. In some embodiments, at least about 70% of the beta-cyclodextrins have a DS within DSₐ±1σ. In some embodiments, at least about 90% of the beta-cyclodextrins have a DS within DSₐ±1σ. In some embodiments, at least about 95% of the beta-cyclodextrins have a DS within DSₐ±1σ.

In some embodiments, at least about 50%, e.g., at least about 55%, about 60%, about 65%, about 70%, about 75%, about 80%, about 85%, about 90%, about 95%, or about 97%, of the beta-cyclodextrins within the mixture have a DS within DSₐ±2σ. In some embodiments, at least about 70% of the beta-cyclodextrins have a DS within DSₐ±2σ. In some embodiments, at least about 90% of the beta-cyclodextrins have a DS within DSₐ±2σ. In some embodiments, at least about 95% of the beta-cyclodextrins have a DS within DSₐ±2σ.

In some embodiments, at least about 50%, e.g., at least about 55%, about 60%, about 65%, about 70%, about 75%, about 80%, about 85%, about 90%, about 95%, or about 97%, of the beta-cyclodextrins within the mixture have a DS within DSₐ±3σ. In some embodiments, at least about 70% of the beta-cyclodextrins have a DS within DSₐ±3σ. In some embodiments, at least about 90% of the beta-cyclodextrins have a DS within

DSₐ±3σ. In some embodiments, at least about 95% of the beta-cyclodextrins have a DS within DSₐ±3σ.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±1. In some embodiments, at least about 70% of the beta-cyclodextrins have a DS within DSₐ±1. In some embodiments, at least about 90% of the beta-cyclodextrins have a DS within DSₐ±1. In some embodiments, at least about 95% of the beta-cyclodextrins have a DS within DSₐ±1.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.8. In some embodiments, at least about 70% of the beta-cyclodextrins have a DS within DSₐ±0.8. In some embodiments, at least about 90% of the beta-cyclodextrins have a DS within DSₐ±0.8. In some embodiments, at least about 95% of the beta-cyclodextrins have a DS within DSₐ±0.8.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.6. In some embodiments, at least about 70% of the beta-cyclodextrins have a DS within DSₐ±0.6. In some embodiments, at least about 90% of the beta-cyclodextrins have a DS within DSₐ±0.6. In some embodiments, at least about 95% of the beta-cyclodextrins have a DS within DSₐ±0.6.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.5. In some embodiments, at least about 70% of the beta-cyclodextrins have a DS within DSₐ±0.5. In some embodiments, at least about 90% of the beta-cyclodextrins have a DS within DSₐ±0.5. In some embodiments, at least about 95% of the beta-cyclodextrins have a DS within DSₐ±0.5.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.4. In some embodiments, at least about 70% of the beta-cyclodextrins have a DS within DSₐ±0.4. In some embodiments, at least about 90% of the beta-cyclodextrins have a DS within DSₐ±0.4. In some embodiments, at least about 95% of the beta-cyclodextrins have a DS within DSₐ±0.4.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.3. In some embodiments, at least about 70% of the beta-cyclodextrins have a DS within DSₐ±0.3. In some embodiments, at least about 90% of the beta-cyclodextrins have a DS within DSₐ±0.3. In some embodiments, at least about 95% of the beta-cyclodextrins have a DS within DSₐ±0.3.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.2. In some embodiments, at least about 70% of the beta-cyclodextrins have a DS within DSₐ±0.2. In some embodiments, at least about 90% of the beta-cyclodextrins have a DS within DSₐ±0.2. In some embodiments, at least about 95% of the beta-cyclodextrins have a DS within DSₐ±0.2.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.1. In some embodiments, at least about 70% of the beta-cyclodextrins have a DS within DSₐ±0.1. In some embodiments, at least about 90% of the beta-cyclodextrins have a DS within DSₐ±0.1. In some embodiments, at least about 95% of the beta-cyclodextrins have a DS within DSₐ±0.1.

In some embodiments, the MS ranges from 0.40 to 0.80, such as from 0.41 to 0.79, from 0.42 to 0.78, from 0.43 to 0.77, from 0.44 to 0.76, from 0.45 to 0.75, from 0.46 to 0.74, from 0.47 to 0.73, from 0.48 to 0.72, from 0.49 to 0.71, from 0.50 to 0.70, from 0.51 to 0.69, from 0.52 to 0.68, from 0.53 to 0.67, from 0.54 to 0.66, from 0.55 to 0.65, from 0.56 to 0.64, from 0.57 to 0.63, from 0.58 to 0.62, or from 0.59 to 0.61.

In certain embodiments, the MS is about 0.40, about 0.41, about 0.42, about 0.43, about 0.44, about 0.45, about 0.46, about 0.47, about 0.48, about 0.49, about 0.50, about 0.51, about 0.52, about 0.53, about 0.54, about 0.55, about 0.56, about 0.57, about 0.58, about 0.59, about 0.60, about 0.61, about 0.62, about 0.63, about 0.64, about 0.65, about 0.66, about 0.67, about 0.68, about 0.69, about 0.70, about 0.71, about 0.72, about 0.73, about 0.74, about 0.75, about 0.76, about 0.77, about 0.78, about 0.79, or about 0.80.

In certain embodiments, the MS is from about 0.571 to about 0.686 (DSₐ from about 4.0 to about 4.8). In some of these embodiments, the MS is in the range of about 0.58 to about 0.68. In currently preferred embodiments, the MS is in the range of 0.58-0.68.

In various embodiments, the MS is at least about 0.55. In certain embodiments, the MS is at least about 0.56, about 0.57, about 0.58, about 0.59, or about 0.60. In certain embodiments, the MS is no more than about 0.70. In specific embodiments, the MS is no more than about 0.69, about 0.68, about 0.67, about 0.66, or about 0.65.

Further provided herein are compositions produced using one or more of the systems and/or methods provided herein, the compositions comprising a mixture of beta-cyclodextrin molecules, wherein the mixture of beta-cyclodextrin molecules may include beta-cyclodextrin substituted with four hydroxypropyl groups (“DS-4”), beta-cyclodextrin substituted with five hydroxypropyl groups (“DS-5”), beta-cyclodextrin substituted with six hydroxypropyl groups (“DS-6”), beta-cyclodextrin substituted with seven hydroxypropyl groups (“DS-7”), beta-cyclodextrin substituted with eight hydroxypropyl groups (“DS-8”), beta-cyclodextrin substituted with nine hydroxypropyl groups (“DS-9”), beta-cyclodextrin substituted with ten hydroxypropyl groups (“DS-10”), beta-cyclodextrin substituted with eleven hydroxypropyl groups (“DS-11”), beta-cyclodextrin substituted with twelve hydroxypropyl groups (“DS-12”), beta-cyclodextrin substituted with thirteen hydroxypropyl groups (“DS-13”), and beta-cyclodextrin substituted with fourteen hydroxypropyl groups (“DS-14”). The degree of substitution of the mixture of beta-cyclodextrin molecules may be determined MALDI-TOF-MS.

In some embodiments, the composition may have an average degree of substitution of from about 7 to about 9; for example, the average degree of substitution may be about 7.0, about 7.1, about 7.2, about 7.3, about 7.4, about 7.5, about 7.6, about 7.7, about 7.8, about 7.9, about 8.0, about 8.1, about 8.2, about 8.3, about 8.4, about 8.5, about 8.6, about 8.7, about 8.8, about 8.9, or about 9.0. In an exemplary embodiment, the average degree of substitution of the mixture of beta-cyclodextrin molecules is about 7.7.

In some embodiments, the mixture of beta-cyclodextrin molecules may include less than 1% of DS-4; for example, the mixture of beta-cyclodextrin molecules may include about 0.9% of DS-4, about 0.8% of DS-4, about 0.7% of DS-4, about 0.6% of DS-4, about 0.5% of DS-4, about 0.4% of DS-4, about 0.3% of DS-4, about 0.2% of DS-4, or about 0.1% of DS-4. In some aspects, the mixture of beta-cyclodextrin molecules may include less than 1% to about 0.9% of DS-4, from about 0.9% to about 0.8% of DS-4, from about 0.8% to about 0.7% of DS-4, from about 0.7% to about 0.6% of DS-4, from about 0.7% to about 0.6% of DS-4, from about 0.6% to about 0.5% of DS-4, from about 0.5% to about 0.4% of DS-4, from about 0.4% to about 0.3% of DS-4, from about 0.3% to about 0.2% of DS-4, from about 0.2% to about 0.1% of DS-4, or less than 0.1% of DS-4. In some additional aspects, the mixture of beta-cyclodextrin molecules may include less than 1% to about 0.8% of DS-4, less than 1% to about 0.7% of DS-4, less than 1% to about 0.6% of DS-4, less than 1% to about 0.5% of DS-4, less than 1% to about 0.4% of DS-4, less than 1% to about 0.3% of DS-4, less than 1% to about 0.2% of DS-4, less than 1% to about 0.1% of DS-4, from about 0.9% to about 0.1% of DS-4, from about 0.8% to about 0.1% of DS-4, from about 0.7% to about 0.1% of DS-4, from about 0.6% to about 0.1% of DS-4, from about 0.5% to about 0.1% of DS-4, from about 0.4% to about 0.1% of DS-4, or from about 0.3% to about 0.1% of DS-4. In still further aspects, the mixture of beta-cyclodextrin may include less than 1% of DS-4, less than 0.9% of DS-4, less than 0.8% of DS-4, less than 0.7% of DS-4, less than 0.6% of DS-4, less than 0.5% of DS-4, less than 0.4% of DS-4, less than 0.3% of DS-4, less than 0.2% of DS-4, or less than 0.1% of DS-4. In still further aspects, the mixture of beta-cyclodextrin molecules may include about 0.001%, about 0.01%, about 0.05%, about 0.1%, about 0.2%, about 0.3%, about 0.4%, about 0.5%, about 0.6%, about 0.7%, about 0.8%, about 0.9%, or about 1% of DS-4. In some embodiments, the amount of DS-4 in the mixture of beta-cyclodextrin molecules may be determined by MALDI-TOF-MS. In an exemplary embodiment, the area of DS-4 in the MALDI-TOF-MS spectrum is 0.73%.

In some embodiments, the mixture of beta-cyclodextrin molecules may include from about 2% to about 5% of DS-5. In some aspects, the mixture of beta-cyclodextrin molecules may include from about 2% to about 2.5% of DS-5, from about 2.5% to about 3% of DS-5, from about 3% to about 3.5% of DS-5, from about 3.5% to about 4% of DS-5, from about 4% to about 4.5% of DS-5, or from about 4.5% to about 5% of DS-5. In some additional aspects, the mixture of beta-cyclodextrin molecules may include from about 2% to about 3% of DS-5, from about 2% to about 3.5% of DS-5, from about 2% to about 4% of DS-5, from about 2% to about 4.5% of DS-5, from about 2.5% to about 5% of DS-5, from about 3% to about 5% of DS-5, from about 3.5% to about 5% of DS-5, from about 4% of DS-5 to about 5% of DS-5, or from about 3% to about 4% of DS-5. In still further aspects, the mixture of beta-cyclodextrin molecules may include about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, or about 5.0% of DS-5. In some embodiments, the amount of DS-5 in the mixture of beta-cyclodextrin molecules may be determined by MALDI-TOF-MS. In an exemplary embodiment, the area of DS-5 in the MALDI-TOF-MS spectrum is 3.49%.

In some embodiments, the mixture of beta-cyclodextrin molecules may include from about 7% to about 13% of DS-6. In some aspects, the mixture of beta-cyclodextrin molecules may include from about 7% to about 7.5% of DS-6, from about 7.5% to about 8% of DS-6, from about 8% to about 8.5% of DS-6, from about 8.5% to about 9% of DS-6, from about 9% to about 9.5% of DS-6, from about 9.5% to about 10% of DS-6, from about 10% to about 10.5% of DS-6, from about 10.5% to about 11% of DS-6, from about 11% to about 11.5% of DS-6, from about 11.5% to about 12% of DS-6, from about 12% to about 12.5% of DS-6, or from about 12.5% to about 13% of DS-6. In some additional aspects, the mixture of beta-cyclodextrin molecules may include from about 7% to about 8% of DS-6, from about 7% to about 8.5% of DS-6, from about 7% to about 9% of DS-6, from about 7% to about 9.5% of DS-6, from about 7% to about 10% of DS-6, from about 7% to about 10.5% of DS-6, from about 7% to about 11% of DS-6, from about 7% to about 11.5% of DS-6, from about 7% to about 12% of DS-6, from about 7% to about 12.5% of DS-6, from about 7.5% to about 13% of DS-6, from about 8% to about 13% of DS-6, from about 8.5% to about 13% of DS-6, from about 9% to about 13% of DS-6, from about 9.5% to about 13% of DS-6, from about 10% to about 13% of DS-6, from about 10.5% to about 13% of DS-6, from about 11% to about 13% of DS-6, from about 11.5% to about 13% of DS-6, from about 12% to about 13% of DS-6, from about 8% to about 12% of DS-6, or from about 9% to about 11% of DS-6. In still further aspects, the mixture of beta-cyclodextrin molecules may include about 7.0%, about 7.1%, about 7.2%, about 7.3%, about 7.4%, about 7.5%, about 7.6%, about 7.7%, about 7.8%, about 7.9%, about 8.0%, about 8.1%, about 8.2%, about 8.3%, about 8.4%, about 8.5%, about 8.6%, about 8.7%, about 8.8%, about 8.9%, about 9.0%, about 9.1%, about 9.2%, about 9.3%, about 9.4%, about 9.5%, about 9.6%, about 9.7%, about 9.8%, about 9.9%, about 10.0%, about 10.1%, about 10.2%, about 10.3%, about 10.4%, about 10.5%, about 10.6%, about 10.7%, about 10.8%, about 10.9%, about 11.0%, about 11.1%, about 11.2%, about 11.3%, about 11.4%, about 11.5%, about 11.6%, about 11.7%, about 11.8%, about 11.9%, about 12.0%, about 12.1%, about 12.2%, about 12.3%, about 12.4%, about 12.5%, about 12.6%, about 12.7%, about 12.8%, about 12.9%, or about 13.0% of DS-6. In some embodiments, the amount of DS-6 in the mixture of beta-cyclodextrin molecules may be determined by MALDI-TOF-MS. In an exemplary embodiment, the area of DS-6 in the MALDI-TOF-MS spectrum is 10.66%.

In some embodiments, the mixture of beta-cyclodextrin molecules may include from about 21% to about 27% of DS-7. In some aspects, the mixture of beta-cyclodextrin molecules may include from about 21% to about 21.5% of DS-7, from about 21.5% to about 22% of DS-7, from about 22% to about 22.5% of DS-7, from about 22.5% to about 23% of DS-7, from about 23% to about 23.5% of DS-7, from about 23.5% of DS-7 to about 24% of DS-7, from about 24% to about 24.5% of DS-7, from about 24.5% to about 25% of DS-7, from about 25% to about 25.5% of DS-7, from about 25.5% to about 26% of DS-7, from about 26% to about 26.5% of DS-7, or from about 26.5% to about 27% of DS-7. In some additional aspects, the mixture of beta-cyclodextrin molecules may include from about 21% to about 22% of DS-7, from about 21% to about 22.5% of DS-7, from about 21% to about 23% of DS-7, from about 21% to about 23.5% of DS-7, from about 21% to about 24% of DS-7, from about 21% to about 24.5% of DS-7, from about 21% to about 25% of DS-7, from about 21% to about 25.5% of DS-7, from about 21% to about 26% of DS-7, from about 21% to about 26.5% of DS-7, from about 21.5% to about 27% of DS-7, from about 22% to about 27% of DS-7, from 22.5% to about 27% of DS-7, from about 23% to about 27% of DS-7, from about 23.5% to about 27% of DS-7, from about 24% to about 27% of DS-7, from about 24.5% to about 27% of DS-7, from about 25% to about 27% of DS-7, from about 25.5% to about 27% of DS-7, from about 26% to about 27% of DS-7, from about 22% to about 26% of DS-7, or from about 23% to about 25% of DS-7. In still further aspects, the mixture of beta-cyclodextrin molecules may include about 21.0%, about 21.1%, about 21.2%, about 21.3%, about 21.4%, about 21.5%, about 21.6%, about 21.7%, about 21.8%, about 21.9%, about 22.0%, about 22.1%, about 22.2%, about 22.3%, about 22.4%, about 22.5%, about 22.6%, about 22.7%, about 22.8%, about 22.9%, about 23.0%, about 23.1%, about 23.2%, about 23.3%, about 23.4%, about 23.5%, about 23.6%, about 23.7%, about 23.8%, about 23.9%, about 24.0%, about 24.1%, about 24.2%, about 24.3%, about 24.4%, about 24.5%, about 24.6%, about 24.7%, about 24.8%, about 24.9%, about 25.0%, about 25.1%, about 25.2%, about 25.3%, about 25.4%, about 25.5%, about 25.6%, about 25.7%, about 25.8%, about 25.9%, about 26.0%, about 26.1%, about 26.2%, about 26.3%, about 26.4%, about 26.5%, about 26.6%, about 26.7%, about 26.8%, about 26.9%, or about 27.0% of DS-7. In some embodiments, the amount of DS-7 may be determined by MALDI-TOF-MS. In an exemplary embodiment, the area of DS-7 in the MALDI-TOF-MS spectrum is 24.10%.

In some embodiments, the mixture of beta-cyclodextrin molecules may include from about 23% to about 29% of DS-8. In some aspects, the mixture of beta-cyclodextrin molecules may include from about 23% to about 23.5% of DS-8, from about 23.5% to about 24% of DS-8, from about 24% to about 24.5% of DS-8, from about 24.5% to about 25% of DS-8, from about 25% to about 25.5% of DS-8, from about 25.5% to about 26% of DS-8, from about 26% to about 26.5% of DS-8, from about 26.5% to about 27% of DS-8, from about 27% to about 27.5% of DS-8, from about 27.5% to about 28% of DS-8, from about 28% to about 28.5% of DS-8, or from about 28.5% to about 29% of DS-8. In some additional aspects, the mixture of beta-cyclodextrin molecules may include from about 23% to about 24% of DS-8, from about 23% to about 24.5% of DS-8, from about 23% to about 25% of DS-8, from about 23% to about 25.5% of DS-8, from about 23% to about 26% of DS-8, from about 23% to about 26.5% of DS-8, from about 23% to about 27% of DS-8, from about 23% to about 27.5% of DS-8, from about 23% to about 28% of DS-8, from about 23% to about 28.5% of DS-8, from about 23.5% to about 29% of DS-8, from about 24% to about 29% of DS-8, from about 24.5% to about 29% of DS-8, from about 25% to about 29% of DS-8, from about 25.5% to about 29% of DS-8, from about 26% to about 29% of DS-8, from about 26.5% to about 29% of DS-8, from about 27% to about 29% of DS-8, from about 27.5% to about 29% of DS-8, from about 28% to about 29% of DS-8, from about 24% to about 28% of DS-8, or from about 25% to about 27% of DS-8. In still further aspects, the mixture of beta-cyclodextrin molecules may include about 23.0%, about 23.1%, about 23.2%, about 23.3%, about 23.4%, about 23.5%, about 23.6%, about 23.7%, about 23.8%, about 23.9%, about 24.0%, about 24.1%, about 24.2%, about 24.3%, about 24.4%, about 24.5%, about 24.6%, about 24.7%, about 24.8%, about 24.9%, about 25.0%, about 25.1%, about 25.2%, about 25.3%, about 25.4%, about 25.5%, about 25.6%, about 25.7%, about 25.8%, about 25.9%, about 26.0%, about 26.1%, about 26.2%, about 26.3%, about 26.4%, about 26.5%, about 26.6%, about 26.7%, about 26.8%, about 26.9%, about 27.0%, about 27.1%, about 27.2%, about 27.3%, about 27.4%, about 27.5%, about 27.6%, about 27.7%, about 27.8%, about 27.9%, about 28.0%, about 28.1%, about 28.2%, about 28.3%, about 28.4%, about 28.5%, about 28.6%, about 28.7%, about 28.8%, about 28.9%, or about 29.0%. In some embodiments, the amount of DS-8 in the composition may be determined by MALDI-TOF-MS. In an exemplary embodiment, the area of DS-8 in the MALDI-TOF-MS spectrum is 26.43%.

In some embodiments, the mixture of beta-cyclodextrin molecules may include from about 15% to about 21% of DS-9. In some aspects, the mixture of beta-cyclodextrin molecules may include about from 15% to about 15.5% of DS-9, from about 15.5% to about 16% of DS-9, from about 16% to about 16.5% of DS-9, from about 16.5% to about 17% of DS-9, from about 17% to about 17.5% of DS-9, from about 17.5% to about 18% of DS-9, from about 18% to about 18.5% of DS-9, from about 18.5% to about 19% of DS-9, from about 19% to about 19.5% of DS-9, from about 19.5% to about 20% of DS-9, from about 20% to about 20.5% of DS-9, or from about 20.5% to about 21% of DS-9. In some additional aspects, the mixture of beta-cyclodextrin molecules may include from about 15% to about 16% of DS-9, from about 15% to about 16.5% of DS-9, from about 15% to about 17% of DS-9, from about 15% to about 17.5% of DS-9, from about 15% to about 18% of DS-9, from about 15% to about 18.5% of DS-9, from about 15% to about 19% of DS-9, from about 15% to about 19.5% of DS-9, from about 15% to about 20% of DS-9, from about 15% to about 20.5% of DS-9, from about 15.5% to about 21% of DS-9, from about 16% to about 21% of DS-9, from about 16.5% to about 21% of DS-9, from about 17% to about 21% of DS-9, from about 17.5% to about 21% of DS-9, from about 18% to about 21% of DS-9, from about 18.5% to about 21% of DS-9, from about 19% to about 21% of DS-9, from about 19.5% to about 21% of DS-9, from about 20% to about 21% of DS-9, from about 16% to about 20% of DS-9, or from about 17% to about 19% of DS-9. In still further aspects, the mixture of beta-cyclodextrin molecules may include about 15.0%, about 15.1%, about 15.2%, about 15.3%, about 15.4%, about 15.5%, about 15.6%, about 15.7%, about 15.8%, about 15.9%, about 16.0%, about 16.1%, about 16.2%, about 16.3%, about 16.4%, about 16.5%, about 16.6%, about 16.7%, about 16.8%, about 16.9%, about 17.0%, about 17.1%, about 17.2%, about 17.3%, about 17.4%, about 17.5%, about 17.6%, about 17.7%, about 17.8%, about 17.9%, about 18.0%, about 18.1%, about 18.2%, about 18.3%, about 18.4%, about 18.5%, about 18.6%, about 18.7%, about 18.8%, about 18.9%, about 19.0%, about 19.1%, about 19.2%, about 19.3%, about 19.4%, about 19.5%, about 19.6%, about 19.7%, about 19.8%, about 19.9%, about 20.0%, about 20.1%, about 20.2%, about 20.3%, about 20.4%, about 20.5%, about 20.6%, about 20.7%, about 20.8%, about 20.9%, or about 21.0% of DS-9. In some embodiments, the amount of DS-9 in the composition may be determined by MALDI-TOF-MS. In an exemplary embodiment, the area of DS-9 in the MALDI-TOF-MS spectrum is 18.09%.

In some embodiments, the mixture of beta-cyclodextrin molecules may include from about 6% to about 12% of DS-10. In some aspects, the mixture of beta-cyclodextrin molecules may include from about 6% to about 6.5% of DS-10, from about 6.5% to about 7% of DS-10, from about 7% to about 7.5% of DS-10, from about 7.5% to about 8% of DS-10, from about 8% to about 8.5% of DS-10, from about 8.5% to about 9% of DS-10, from about 9% to about 9.5% of DS-10, from about 9.5% to about 10% of DS-10, from about 10% to about 10.5% of DS-10, from about 10.5% to about 11% of DS-10, from about 11% to about 11.5% of DS-10, or from about 11.5% to about 12% of DS-10. In some additional aspects, the mixture of beta-cyclodextrin molecules may include from about 6% to about 7% of DS-10, from about 6% to about 7.5% of DS-10, from about 6% to about 8% of DS-10, from about 6% to about 8.5% of DS-10, from about 6% to about 9% of DS-10, from about 6% to about 9.5% of DS-10, from about 6% to about 10% of DS-10, from about 6% to about 10.5% of DS-10, from about 6% to about 11% of DS-10, from about 6% to about 11.5% of DS-10, from about 6.5% to about 12% of DS-10, from about 7% to about 12% of DS-10, from about 7.5% to about 12% of DS-10, from about 8% to about 12% of DS-10, from about 8.5% to about 12% of DS-10, from about 9% to about 12% of DS-10, from about 9.5% to about 12% of DS-10, from about 10% to about 12% of DS-10, from about 10.5% to about 12% of DS-10, from about 11% to about 12% of DS-10, from about 7% to about 11% of DS-10, or from about 8% to about 10% of DS-10. In still further aspects, the mixture of beta-cyclodextrin molecules may include about 6.0%, about 6.1%, about 6.2%, about 6.3%, about 6.4%, about 6.5%, about 6.6%, about 6.7%, about 6.8%, about 6.9%, about 7.0%, about 7.1%, about 7.2%, about 7.3%, about 7.4%, about 7.5%, about 7.6%, about 7.7%, about 7.8%, about 7.9%, about 8.0%, about 8.1%, about 8.2%, about 8.3%, about 8.4%, about 8.5%, about 8.6%, about 8.7%, about 8.8%, about 8.9%, about 9.0%, about 9.1%, about 9.2%, about 9.3%, about 9.4%, about 9.5%, about 9.6%, about 9.7%, about 9.8%, about 9.9%, about 10.0%, about 10.1%, about 10.2%, about 10.3%, about 10.4%, about 10.5%, about 10.6%, about 10.7%, about 10.8%, about 10.9%, about 11.0%, about 11.1%, about 11.2%, about 11.3%, about 11.4%, about 11.5%, about 11.6%, about 11.7%, about 11.8%, about 11.9%, or about 12.0% of DS-10. In some embodiments, the amount of DS-10 in the mixture of beta-cyclodextrin molecules may be determined by MALDI-TOF-MS. In an exemplary embodiment, the area of DS-10 in the MALDI-TOF-MS spectrum is 9.39%.

In some embodiments, the mixture of beta-cyclodextrin molecules may include from about 2% to about 6% of DS-11. In some aspects, the mixture of beta-cyclodextrin molecules may include from about 2% to about 2.5% of DS-11, from about 2.5% to about 3% of DS-11, from about 3% to about 3.5% of DS-11, from about 3.5% to about 4% of DS-11, from about 4% to about 4.5% of DS-11, from about 4.5% to about 5% of DS-11, from about 5% to about 5.5% of DS-11, or from about 5.5% to about 6% of DS-11. In some additional aspects, the mixture of beta-cyclodextrin molecules may include from about 2% to about 3% of DS-11, from about 2% to about 3.5% of DS-11, from about 2% to about 4% of DS-11, from about 2% to about 4.5% of DS-11, from about 2% to about 5% of DS-11, from about 2% to about 5.5% of DS-11, from about 2.5% to about 6% of DS-11, from about 3% to about 6% of DS-11, from about 3.5% to about 6% of DS-11, from about 4% to about 6% of DS-11, from about 4.5% to about 6% of DS-11, from about 5% to about 6% of DS-11, or from about 3% to about 5% of DS-11. In still additional aspects, the mixture of beta-cyclodextrin molecules may include about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, about 5.0%, about 5.1%, about 5.2%, about 5.3%, about 5.4%, about 5.5%, about 5.6%, about 5.7%, about 5.8%, about 5.9%, or about 6.0% of DS-11. In some embodiments, the amount of DS-11 in the mixture of beta-cyclodextrin molecules may be determined by MALDI-TOF-MS. In an exemplary embodiment, the area of DS-11 in the MALDI-TOF-MS spectrum is 4.58%.

In some embodiments, the mixture of beta-cyclodextrin molecules may include from about 0.5% to about 4% of DS-12. In some aspects, the mixture of beta-cyclodextrin molecules may include from about 0.5% to about 1% of DS-12, from about 1% to about 1.5% of DS-12, from about 1.5% to about 2% of DS-12, from about 2% to about 2.5% of DS-12, from about 2.5% to about 3% of DS-12, from about 3% to about 3.5% of DS-12, or from about 3.5% to about 4% of DS-12. In some additional aspects, the mixture of beta-cyclodextrin molecules may include from about 0.5% to about 1.5% of DS-12, from about 0.5% to about 2% of DS-12, from about 0.5% to about 2.5% of DS-12, from about 0.5% to about 3% of DS-12, from about 0.5% to about 3.5% of DS-12, from about 1% to about 4% of DS-12, from about 1.5% to about 4% of DS-12, from about 2% to about 4% of DS-12, from about 2.5% to about 4% of DS-12, from about 3% to about 4% of DS-12, or from about 1% to about 3% of DS-12. In still further aspects, the mixture of beta-cyclodextrin molecules may include about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, or about 4.0%. In some embodiments, the amount of DS-12 in the mixture of beta-cyclodextrin molecules may be determined by MALDI-TOF-MS. In an exemplary embodiment, the area of DS-12 in the MALDI-TOF-MS spectrum is 1.84%.

In some embodiments, the mixture of beta-cyclodextrin molecules may include less than 1% of DS-13; for example, the mixture of beta-cyclodextrin molecules may include about 0.9% of DS-13, about 0.8% of DS-13, about 0.7% of DS-13, about 0.6% of DS-13, about 0.5% of DS-13, about 0.4% of DS-13, about 0.3% of DS-13, about 0.2% of DS-13, or about 0.1% of DS-13. In some aspects, the mixture of beta-cyclodextrin molecules may include less than 1% to about 0.9% of DS-13, from about 0.9% to about 0.8% of DS-13, from about 0.8% to about 0.7% of DS-13, from about 0.7% to about 0.6% of DS-13, from about 0.7% to about 0.6% of DS-13, from about 0.6% to about 0.5% of DS-13, from about 0.5% to about 0.4% of DS-13, from about 0.4% to about 0.3% of DS-13, from about 0.3% to about 0.2% of DS-13, from about 0.2% to about 0.1% of DS-13, or less than 0.1% of DS-13. In some additional aspects, the mixture of beta-cyclodextrin molecules may include less than 1% to about 0.8% of DS-13, less than 1% to about 0.7% of DS-13, less than 1% to about 0.6% of DS-13, less than 1% to about 0.5% of DS-13, less than 1% to about 0.4% of DS-13, less than 1% to about 0.3% of DS-13, less than 1% to about 0.2% of DS-13, less than 1% to about 0.1% of DS-13, from about 0.9% to about 0.1% of DS-13, from about 0.8% to about 0.1% of DS-13, from about 0.7% to about 0.1% of DS-13, from about 0.6% to about 0.1% of DS-13, from about 0.5% to about 0.1% of DS-13, from about 0.4% to about 0.1% of DS-13, or from about 0.3% to about 0.1% of DS-13. In still further aspects, the mixture of beta-cyclodextrin may include less than 1% of DS-13, less than 0.9% of DS-13, less than 0.8% of DS-13, less than 0.7% of DS-13, less than 0.6% of DS-13, less than 0.5% of DS-13, less than 0.4% of DS-13, less than 0.3% of DS-13, less than 0.2% of DS-13, or less than 0.1% of DS-13. In some embodiments, the amount of DS-13 in the mixture of beta-cyclodextrin molecules may be determined by MALDI-TOF-MS. In an exemplary embodiment, the area of DS-13 in the MALDI-TOF-MS spectrum is 0.70%.

In some embodiments, the composition may include less than 1% of DS-14; for example, the mixture of beta-cyclodextrin molecules may include about 0.9% of DS-14, about 0.8% of DS-14, about 0.7% of DS-14, about 0.6% of DS-14, about 0.5% of DS-14, about 0.4% of DS-14, about 0.3% of DS-14, about 0.2% of DS-14, or about 0.1% of DS-14. In some aspects, the mixture of beta-cyclodextrin molecules may include less than 1% to about 0.9% of DS-14, from about 0.9% to about 0.8% of DS-14, from about 0.8% to about 0.7% of DS-14, from about 0.7% to about 0.6% of DS-14, from about 0.7% to about 0.6% of DS-14, from about 0.6% to about 0.5% of DS-14, from about 0.5% to about 0.4% of DS-14, from about 0.4% to about 0.3% of DS-14, from about 0.3% to about 0.2% of DS-14, from about 0.2% to about 0.1% of DS-14, or less than 0.1% of DS-14. In some additional aspects, the mixture of beta-cyclodextrin molecules may include less than 1% to about 0.8% of DS-14, less than 1% to about 0.7% of DS-14, less than 1% to about 0.6% of DS-14, less than 1% to about 0.5% of DS-14, less than 1% to about 0.4% of DS-14, less than 1% to about 0.3% of DS-14, less than 1% to about 0.2% of DS-14, less than 1% to about 0.1% of DS-14, from about 0.9% to about 0.1% of DS-14, from about 0.8% to about 0.1% of DS-14, from about 0.7% to about 0.1% of DS-14, from about 0.6% to about 0.1% of DS-14, from about 0.5% to about 0.1% of DS-14, from about 0.4% to about 0.1% of DS-14, or from about 0.3% to about 0.1% of DS-14. In still further aspects, the mixture of beta-cyclodextrin may optionally include less than 1% of DS-14, less than 0.9% of DS-14, less than 0.8% of DS-14, less than 0.7% of DS-14, less than 0.6% of DS-14, less than 0.5% of DS-14, less than 0.4% of DS-14, less than 0.3% of DS-14, less than 0.2% of DS-14, or less than 0.1% of DS-4. In still further aspects, the mixture of beta-cyclodextrin molecules may optionally include about 0.001%, about 0.01%, about 0.05%, about 0.1%, about 0.2%, about 0.3%, about 0.4%, about 0.5%, about 0.6%, about 0.7%, about 0.8%, about 0.9%, or about 1% of DS-14. In some embodiments, the amount of DS-14 in the mixture of beta-cyclodextrin molecules may be determined by MALDI-TOF-MS. In some embodiments, DS-14 is absent from the composition.

In an exemplary embodiment, the composition includes a mixture of beta-cyclodextrin molecules, wherein the mixture of beta-cyclodextrin molecules includes DS-4, DS-5, DS-6, DS-7, DS-8, DS-9, DS-10, DS-11, DS-12, DS-13, and DS-14, wherein the mixture of beta-cyclodextrin molecules includes less than 1% of DS-1, DS-2, DS-3, and DS-4.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises none or less than 1% unsubstituted beta-cyclodextrin (“DS-0”) and beta-cyclodextrin substituted with one hydroxypropyl group (“DS-1”); and, the mixture comprises from 5% to 25% beta-cyclodextrin substituted with six hydroxypropyl groups (“DS-6”).

The mixture may comprise less than 0.1% DS-0 and less than 0.1% DS-1, collectively. For example, the mixture may comprise none, less than 0.1%, less than 0.09%, less than 0.08%, less than 0.07%, less than 0.06%, less than 0.05%, less than 0.04%, less than 0.03%, less than 0.02%, or less than 0.01% DS-0; and/or the mixture may comprise none, less than 0.1%, less than 0.09%, less than 0.08%, less than 0.07%, less than 0.06%, less than 0.05%, less than 0.04%, less than 0.03%, less than 0.02%, or less than 0.01% DS-1. The mixture may comprise no DS-0 and/or no DS-1.

The mixture may comprise at least 8% beta-cyclodextrin substituted with six hydroxypropyl groups (“DS-6”). The mixture may comprise at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, or at least 25% DS-6. Alternatively, the mixture may comprise from about 8% to about 9%, from about 8% to about 10%, from about 8% to about 11%, from about 8% to about 12%, from about 8% to about 13%, from about 8% to about 14%, from about 8% to about 15%, from about 8% to about 16%, from about 8% to about 17%, from about 8% to about 18%, from about 8% to about 19%, from about 8% to about 20%, from about 8% to about 21%, from about 8% to about 22%, from about 8% to about 23%, from about 8% to about 24%, or from about 8% to about 25% DS-6. Alternatively, the mixture may comprise no more than 15%, no more than 14%, no more than 13%, no more than 12%, no more than 11%, no more than 10%, no more than 9%, or no more than 8% DS-6.

The amount of DS-0, DS-1, or DS-6 may be determined by peak height of an electrospray MS spectrum.

The mixture may have an average molar substitution in the range of from about 0.40 to about 0.80; for example, the mixture may have an average molar substitution of about 0.40, about 0.45, about 0.50, about 0.55, about 0.60, about 0.65, about 0.70, about 0.75, or about 0.80. The mixture may have an average degree of substitution (“DSₐ”) of from about 3 to about 7, from about 4 to about 7, from about 5 to about 7, or from about 6 to about 7. For example, the mixture may have an average degree of substitution of about 3, about 3.5, about 4, about 4.5, about 5, about 5.5, about 6, about 6.5, or about 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The composition may comprise no propylene glycol. The amount of propylene glycol may be measured by HPLC or gas chromatography.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The composition may comprise, no more than 0.09 ppm propylene oxide, no more than 0.08 ppm propylene oxide, no more than 0.07 ppm propylene oxide, no more than 0.06 ppm propylene oxide, no more than 0.05 ppm propylene oxide, no more than 0.04 ppm propylene oxide, no more than 0.03 ppm propylene oxide, no more than 0.02 ppm propylene oxide, or no more than 0.01 ppm propylene oxide. The composition may comprise, no more than 0.009 ppm propylene oxide, no more than 0.008 ppm propylene oxide, no more than 0.007 ppm propylene oxide, no more than 0.006 ppm propylene oxide, no more than 0.005 ppm propylene oxide, no more than 0.004 ppm propylene oxide, no more than 0.003 ppm propylene oxide, no more than 0.002 ppm propylene oxide, or no more than 0.001 ppm propylene oxide. The composition may comprise no propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the composition has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, about 3 mg, about 4 mg, about 5 mg, about 6 mg, about 7 mg, about 8 mg, about 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The mixture of beta-cyclodextrin molecules substituted at one or more hydroxyl positions by hydroxypropyl groups may have a concentration in a solution of from about 10 mg/mL to about 200 mg/mL. For example, the mixture of beta-cyclodextrin molecules substituted at one or more hydroxyl positions by hydroxypropyl groups may have a concentration in a solution from about 10 mg/mL to about 20 mg/mL, about 10 mg/mL to about 30 mg/mL, about 10 mg/mL to about 40 mg/mL, about 10 mg/mL to about 50 mg/mL, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/mL to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/mL to about 200 mg/mL, about 60 mg/mL to about 200 mg/mL, about 70 mg/ml to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises none or less than 1% unsubstituted beta-cyclodextrin (“DS-0”) and beta-cyclodextrin substituted with one hydroxypropyl group

(“DS-1”); and, the mixture comprises from 1% to 10% beta-cyclodextrin substituted with seven hydroxypropyl groups (“DS-7”).

The mixture may comprise less than 0.1% DS-0 and less than 0.1% DS-1, collectively. For example, the mixture may comprise none, less than 0.1%, less than 0.09%, less than 0.08%, less than 0.07%, less than 0.06%, less than 0.05%, less than 0.04%, less than 0.03%, less than 0.02%, or less than 0.01% DS-0; and/or the mixture may comprise none, less than 0.1%, less than 0.09%, less than 0.08%, less than 0.07%, less than 0.06%, less than 0.05%, less than 0.04%, less than 0.03%, less than 0.02%, or less than 0.01% DS-1. The mixture may comprise no DS-0 and/or no DS-1.

The mixture may comprise from about 1% to about 10% DS-7; for example, the mixture may comprise from about 1% to about 2%, from about 1% to about 3%, from about 1% to about 4%, from about 1% to about 5%, from about 1% to about 6%, from about 1% to about 7%, from about 1% to about 8%, from about 1% to about 9%, from about 2% to about 10%, from about 3% to about 10%, from about 4% to about 10%, from about 5% to about 10%, from about 6% to about 10%, from about 7% to about 10%, from about 8% to about 10%, from about 9% to about 10%, from about 2% to about 9%, from about 3% to about 8%, from about 4% to about 7%, or from about 5% to about 6% DS-7. The mixture may comprise about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, or about 10% DS-7. Alternatively, the composition may have less than about 10%, less than about 9%, less than about 8%, less than about 7%, less than about 6%, less than about 5%, less than about 4%, less than about 3%, less than about 2%, or less than about 1% DS-7.

The amount of DS-0, DS-1, or DS-7 may be determined by peak height of an electrospray MS spectrum.

The mixture may have an average molar substitution in the range of from about 0.40 to about 0.80; for example, the mixture may have an average molar substitution of about 0.40, about 0.45, about 0.50, about 0.55, about 0.60, about 0.65, about 0.70, about 0.75, or about 0.80. The mixture may have an average degree of substitution (“DSₐ”) of about 3 to about 7, from about 4 to about 7, from about 5 to about 7, or from about 6 to about 7. For example, the mixture may have an average degree of substitution of about 3, about 3.5, about 4, about 4.5, about 5, about 5.5, about 6, about 6.5, or about 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The composition may comprise no propylene glycol. The amount of propylene glycol may be measured by HPLC or gas chromatography.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography, or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The composition may comprise no propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the composition has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, about 3 mg, about 4 mg, about 5 mg, about 6 mg, about 7 mg, about 8 mg, about 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The mixture of beta-cyclodextrin molecules substituted at one or more hydroxyl positions by hydroxypropyl groups may have a concentration in a solution from about 10 mg/mL to about 200 mg/mL. For example, the mixture of beta-cyclodextrin molecules substituted at one or more hydroxyl positions by hydroxypropyl groups may have a concentration in a solution from about 10 mg/mL to about 20 mg/mL, about 10 mg/mL to about 30 mg/mL, about 10 mg/mL to about 40 mg/mL, about 10 mg/mL to about 50 mg/mL, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/ml to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/ml to about 200 mg/mL, about 60 mg/mL to about 200 mg/mL, about 70 mg/mL to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

### Methods of Making Beta-Cyclodextrin

The beta cyclodextrin (BCD) used in the systems and methods described herein may be produced via an enzymatic synthesis process. Suitable enzymatic synthesis processes are disclosed in, for example, PCT/IB2023/055977, the disclosure of which is incorporated herein by reference.

In some cases, the method for producing the BCD, or for producing a composition comprising cyclodextrin, comprises (a) contacting sucrose with an enzyme, or an enzyme mixture, capable of converting sucrose to amylose under conditions that permit the conversion of the sucrose to amylose, thereby producing amylose. In some cases, the method further comprises (b) contacting the amylose with an enzyme capable of converting amylose to cyclodextrin under conditions that permit the conversion of the amylose to cyclodextrin, thereby producing the composition comprising cyclodextrin. In some cases, the enzyme capable of converting amylose to cyclodextrin is a variant enzyme capable of producing a greater amount and/or concentration (e.g., wt %, mol % or w/v) of beta-cyclodextrin than alpha-cyclodextrin, gamma-cyclodextrin, or both, relative to a wild-type enzyme capable of converting amylose to cyclodextrin. In some cases, the composition comprising cyclodextrin comprises beta-cyclodextrin, and may optionally further comprise alpha-cyclodextrin, gamma-cyclodextrin, or any combination thereof. In some cases, the composition comprising cyclodextrin comprises beta-cyclodextrin in an amount and/or concentration (e.g., wt %, mol % or w/v) greater than alpha-cyclodextrin, gamma-cyclodextrin, or both. In some cases, the amount and/or concentration of alpha-cyclodextrin, beta-cyclodextrin, and gamma-cyclodextrin is measured by high-performance liquid chromatography (HPLC).

### Method Step (a) for Enzymatic Conversion of Sucrose to Amylose

The methods provided herein may involve the enzymatic conversion of sucrose to amylose. In some cases, the amylose is alpha-amylose. In some embodiments, the methods involve contacting sucrose with an enzyme, or an enzyme mixture, capable of converting sucrose to amylose under conditions that permit the conversion of the sucrose to amylose, thereby producing amylose. In one aspect, the methods involve the use of a single enzyme to convert sucrose to amylose. In alternative aspects, the methods involve the use of an enzyme mixture (e.g., two enzymes), which collectively or in combination, convert sucrose to amylose. In some cases, the sucrose is deuterated sucrose (e.g., one or more hydrogens have been replaced with deuterium). In some cases, the sucrose, and/or any one or more reagents used in the synthesis reaction are deuterated.

One Enzyme Method for Producing Amylose from Sucrose

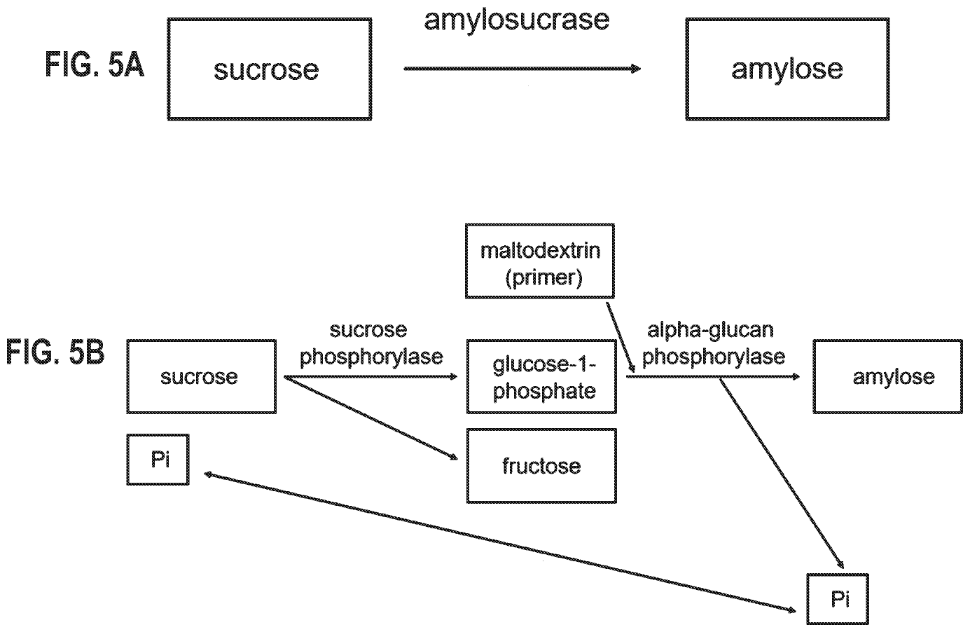

In some aspects, the enzyme is amylosucrase. FIG. 5A depicts a schematic of a single enzyme method of producing amylose from sucrose. In this example, sucrose is contacted with amylosucrase which converts the sucrose to amylose. In some cases, the amylosucrase is a wild-type amylosucrase. For example, the wild-type amylosucrase may be Cellulomonas carboniz T26 amylosucrase (NCBI Accession No. N868_11335). In some cases, the wild-type Cellulomonas carboniz T26 amylosucrase may have the amino acid sequence of SEQ ID NO: 1. In some cases, the wild-type amylosucrase may be Neisseria polysaccharea amylosucrase (NCBI Accession No. AJ011781). In some cases, the wild-type Neisseria polysaccharea amylosucrase may have the amino acid sequence of SEQ ID NO: 2. Table 1 below depicts non-limiting examples of wild-type amylosucrase enzymes (and their amino acid sequences) that can be used in accordance with the methods provided herein.

TABLE 1
Non-limiting examples of wild-type amylosucrase enzymes

| Enzyme | SEQ ID NO: | Sequence (5′ to 3′) |
|---|---|---|
| Cellulomonas | SEQ ID NO: 1 | MRVSEPLHPSVTAAVAAARDPRTSAEHWAAIEARVAREWP |
| carboniz T26 | | RLERLFLEVYGEGERTRSELAALAHQLVVSAQERPADLRAV |
| amylosucrase | | DVAREADPAWFTSHRMLGGVCYVDRYAGDLEGLRRHIPYL |
| | | RELGLTYLHLMPLFEAPAENSDGGYAVSSYRRVNPALGTM |
| | | EQLTALAAELRENGISLVLDFIFNHTSDEHEWARRALAGERE |
| | | YEDYYWVFPDREMPDAYERTVREIFPDDHPGSFVPMPDSP |
| | | DGSRTGRWIWATFHSFQWDLNYANPAVFRAMAGEMLFLA |
| | | NKGVDVLRMDAVAFIWKQLGTACESLPQAHLLIQAFNAALRI |
| | | AAPGVLFKSEAIVHPDEVVQYISPDECQISYNPLQMALIWSS |
| | | LATREANLLQQALERRHALPPGTAWVNYVRSHDDIGWTFA |
| | | DEDAAELGIDGFQHRRFLNAFYVDRFPGSFARGVPFQDNP |
| | | RTGDCRISGTTASLAGLEARDPGAVDRILLAHSIVLSTGGIPL |
| | | LYLGDEVGQLNDYSYRDQPGLAEDSRWVNRPWYPAQAYA |
| | | NRLVPSTAAGRVFRGLRHLLEVRRRTPELAGGTLVPFDAHN |
| | | RHVVGYQRPGELDGVPTTVLCLASFADEPQAVEPLTLSGM |
| | | PAEAEDLLTGATVDLRAGLVLRPHGFVWLRVRHAA |
| Neisseria | SEQ ID NO: 2 | MLTPTQQVGLILQYLKTRILDIYTPEQRAGIEKSEDWRQFSR |
| polysaccharea | | RMDTHFPKLMNELDSVYGNNEALLPMLEMLLAQAWQSYSQ |
| amylosucrase | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLREIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |

In some embodiments, the amylosucrase is a variant amylosucrase comprising at least one amino acid variant relative to a wild-type amylosucrase. The variant amylosucrase may comprise one or more amino acid substitutions, deletions, insertions, and/or modifications relative to a wild-type amylosucrase. In some cases, the variant amylosucrase is capable of producing a greater amount and/or concentration of amylose from sucrose relative to a wild-type amylosucrase.

In some cases, the variant amylosucrase comprises at least one amino acid variant relative to wild-type Cellulomonas carboniz T26 amylosucrase (SEQ ID NO: 1). In some cases, the variant amylosucrase comprises at least one amino acid variant relative to wild-type Neisseria polysaccharea amylosucrase (SEQ ID NO: 2). In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of wild-type Cellulomonas carboniz T26 amylosucrase. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 1. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of wild-type Neisseria polysaccharea amylosucrase. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2.

In some cases, the at least one amino acid variant comprises at least one amino acid substitution relative to a wild-type amylosucrase. In some cases, the at least one amino acid variant comprises at least one amino acid substitution relative to wild-type Cellulomonas carboniz T26 amylosucrase. In some cases, the at least one amino acid variant comprises at least one amino acid substitution relative to wild-type Neisseria polysaccharea amylosucrase. In some cases, the at least one amino acid substitution comprises or consists of an amino acid substitution at amino acid position 234 relative to the amino acid sequence of SEQ ID NO: 2. In some cases, the amino acid substitution at amino acid position 234 relative to the amino acid sequence of SEQ ID NO: 2 is selected from the group consisting of: R234Q, R234G, R234A, R234S, R234M, R234C, R234K, R2341, R234D, R234Y, R234W, R234E, R234L, and R234H. In a preferred embodiment, the amino acid substitution at amino acid position 234 relative to the amino acid sequence of SEQ ID NO: 2 is selected from the group consisting of: R234Q, R234G, R234A, R234S, R234M, R234C, and R234K. In this regard, it will be appreciated that R234Q denotes that the arginine (R) at amino acid position 234 relative to the amino acid sequence of SEQ ID NO: 2 is substituted with a glutamine (Q), etc. In some cases, the amino acid substitution at amino acid position 234 relative to the amino acid sequence of SEQ ID NO: 2 is R234Q (e.g., SEQ ID NO: 3 in Table 2). In some cases, the amino acid substitution at amino acid position 234 relative to the amino acid sequence of SEQ ID NO: 2 is R234G (e.g., SEQ ID NO: 4 in Table 2). In some cases, the amino acid substitution at amino acid position 234 relative to the amino acid sequence of SEQ ID NO: 2 is R234A (e.g., SEQ ID NO: 5 in Table 2). In some cases, the amino acid substitution at amino acid position 234 relative to the amino acid sequence of SEQ ID NO: 2 is R234S (e.g., SEQ ID NO: 6 in Table 2). In some cases, the amino acid substitution at amino acid position 234 relative to the amino acid sequence of SEQ ID NO: 2 is R234M (e.g., SEQ ID NO: 7 in Table 2). In some cases, the amino acid substitution at amino acid position 234 relative to the amino acid sequence of SEQ ID NO: 2 is R234C (e.g., SEQ ID NO: 8 in Table 2). In some cases, the amino acid substitution at amino acid position 234 relative to the amino acid sequence of SEQ ID NO: 2 is R234K (e.g., SEQ ID NO: 9 in Table 2). In some cases, the amino acid substitution at amino acid position 234 relative to the amino acid sequence of SEQ ID NO: 2 is R2341 (e.g., SEQ ID NO: 10 in Table 2). In some cases, the amino acid substitution at amino acid position 234 relative to the amino acid sequence of SEQ ID NO: 2 is R234D (e.g., SEQ ID NO: 11 in Table 2). In some cases, the amino acid substitution at amino acid position 234 relative to the amino acid sequence of SEQ ID NO: 2 is R234Y (e.g., SEQ ID NO: 12 in Table 2). In some cases, the amino acid substitution at amino acid position 234 relative to the amino acid sequence of SEQ ID NO: 2 is R234W (e.g., SEQ ID NO: 13 in Table 2). In some cases, the amino acid substitution at amino acid position 234 relative to the amino acid sequence of SEQ ID NO: 2 is R234E (e.g., SEQ ID NO: 14 in Table 2). In some cases, the amino acid substitution at amino acid position 234 relative to the amino acid sequence of SEQ ID NO: 2 is R234L (e.g., SEQ ID NO: 15 in Table 2). In some cases, the amino acid substitution at amino acid position 234 relative to the amino acid sequence of SEQ ID NO: 2 is R234H (e.g., SEQ ID NO: 16 in Table 2). In some aspects, the variant amylosucrase comprises or consists of an amino acid sequence according to any one of SEQ ID NOS: 3-16 or 48, depicted in Table 2, or an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) to an amino acid sequence according to any one of SEQ ID NOS: 3-16 or 48, depicted in Table 2. In a preferred embodiment, the variant amylosucrase comprises or consists of an amino acid sequence according to any one of SEQ ID NOS: 3-9 or 48, depicted in Table 2.

TABLE 2
Non-limiting examples of variant amylosucrase enzymes.

| Enzyme | SEQ ID NO: | Sequence (5′ to 3′) |
|---|---|---|
| Amylosucrase | SEQ ID NO: 3 | MLTPTQQVGLILQYLKTRILDIYTPEQRAGIEKSEDWRQFSR |
| R234Q | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLQEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 4 | MLTPTQQVGLILQYLKTRILDIYTPEQRAGIEKSEDWRQFSR |
| R234G | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLGEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 5 | MLTPTQQVGLILQYLKTRILDIYTPEQRAGIEKSEDWRQFSR |
| R234A | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLAEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 6 | MLTPTQQVGLILQYLKTRILDIYTPEQRAGIEKSEDWRQFSR |
| R234S | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLSEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 7 | MLTPTQQVGLILQYLKTRILDIYTPEQRAGIEKSEDWRQFSR |
| R234M | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLMEIFPDQHPGGFS |
| | | QLEDGRWVWTTFNSFQWDLNYSNPWVFRAMAGEMLFLAN |
| | | LGVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 8 | MLTPTQQVGLILQYLKTRILDIYTPEQRAGIEKSEDWRQFSR |
| R234C | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLCEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 9 | MLTPTQQVGLILQYLKTRILDIYTPEQRAGIEKSEDWRQFSR |
| R234K | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLKEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234I | 10 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLIEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234D | 11 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLDEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234Y | 12 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLYEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234W | 13 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLWEIFPDQHPGGFS |
| | | QLEDGRWVWTTFNSFQWDLNYSNPWVFRAMAGEMLFLAN |
| | | LGVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234E | 14 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLEEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234L | 15 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLLEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234H | 16 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLHEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MGLILQYLKTRILDIYTPEQRAGIEKSEDWRQFSRRMDTHFP |
| R234Ndelta8 | 48 | KLMNELDSVYGNNEALLPMLEMLLAQAWQSYSQRNSSLKD |
| AA | | IDIARENNPDWILSNKQVGGVCYVDLFAGDLKGLKDKIPYFQ |
| | | ELGLTYLHLMPLFKCPEGKSDGGYAVSSYRDVNPALGTIGD |
| | | LREVIAALHEAGISAVVDFIFNHTSNEHEWAQRCAAGDPLFD |
| | | NFYYIFPDRRMPDQYDRTLNEIFPDQHPGGFSQLEDGRWV |
| | | WTTFNSFQWDLNYSNPWVFRAMAGEMLFLANLGVDILRMD |
| | | AVAFIWKQMGTSCENLPQAHALIRAFNAVMRIAAPAVFFKS |
| | | EAIVHPDQVVQYIGQDECQIGYNPLQMALLWNTLATREVNL |
| | | LHQALTYRHNLPEHTAWVNYVRSHDDIGWTFADEDAAYLGI |
| | | SGYDHRQFLNRFFVNRFDGSFARGVPFQYNPSTGDCRVS |
| | | GTAAALVGLAQDDPHAVDRIKLLYSIALSTGGLPLIYLGDEV |
| | | GTLNDDDWSQDSNKSDDSRWAHRPRYNEALYAQRNDPST |
| | | AAGQIYQGLRHMIAVRQSNPRFDGGRLVTFNTNNKHIIGYIR |
| | | NNALLAFGNFSEYPQTVTAHTLQAMPFKAHDLIGGKTVSLN |
| | | QDLTLQPYQVMWLEIA |

In some aspects, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and an amino acid substitution at amino acid position 234 relative to SEQ ID NO: 2. In this regard, and as used throughout the disclosure, the stated sequence identity includes the amino acid substitution (i.e., the sequence identity is calculated based on the entire amino acid sequence of the variant enzyme, including the amino acid substitution). In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and an amino acid substitution at amino acid position 234 relative to SEQ ID NO: 2 selected from the group consisting of: R234Q, R234G, R234A, R234S, R234M, R234C, R234K, R2341, R234D, R234Y, R234W, R234E, R234L, and R234H. In a preferred embodiment, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and an amino acid substitution at amino acid position 234 relative to SEQ ID NO: 2 selected from the group consisting of: R234Q, R234G, R234A, R234S, R234M, R234C, and R234K. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234Q relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234G relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234A relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234S relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234M relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234C relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234K relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R2341 relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234D relative to SEQ ID NO: 2. In some cases, the variant amylosucrase comprises or consists an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234Y relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234W relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234E relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234L relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234H relative to SEQ ID NO: 2.

In some embodiments, the amylosucrase is derived from a microbial cell. In some cases, the amylosucrase is isolated and/or purified from a microbial cell. In some cases, the microbial cell is a bacterial cell. In some cases, the bacterial cell is Escherichia coli. In some embodiments, the amylosucrase is derived from Neisseria polysaccharea. In some embodiments, the amylosucrase is derived from Cellulomonas carboniz T26. In some embodiments, the amylosucrase may be produced within a microbial cell. In some embodiments, the amylosucrase is expressed in a recombinant host cell (e.g., from a recombinant polynucleotide). In some cases, the amylosucrase is recombinantly produced. In some cases, the amylosucrase is produced (e.g., recombinantly produced) in a yeast cell. In some cases, the yeast cell is a Pichia yeast cell, such as a Pichia pastoris cell.

Two Enzyme Method for Producing Amylose from Sucrose

In some aspects, the methods involve contacting sucrose with an enzyme mixture capable of converting sucrose to amylose under conditions that permit the conversion of the sucrose to amylose, thereby producing amylose. In some cases, the methods involve contacting sucrose with an enzyme mixture that contains at least two enzymes, which, collectively or in combination, are capable of converting the sucrose to amylose. For example, the enzyme mixture may contain at least sucrose phosphorylase and alpha-glucan phosphorylase. The methods may involve contacting sucrose with the at least two enzymes simultaneously or substantially simultaneously. Alternatively, the methods may involve contacting sucrose with the at least two enzymes sequentially. FIG. 5B depicts a schematic of a two enzyme method of producing amylose from sucrose. In this example, sucrose is contacted with sucrose phosphorylase to convert the sucrose to glucose-1-phosphate. The glucose-1-phosphate is then contacted with alpha-glucan phosphorylase to convert the glucose-1-phosphate to amylose. In some cases, the sucrose phosphorylase and the alpha-glucan phosphorylase are contacted with the sucrose simultaneously or substantially simultaneously. In other cases, the sucrose phosphorylase and the alpha-glucan phosphorylase are added sequentially (e.g., the sucrose phosphorylase is contacted with the sucrose first to generate glucose-1-phosphate, then the alpha-glucan phosphorylase is added to generate the amylose). In some cases, the glucose-1-phosphate generated from the reaction with sucrose phosphorylase is isolated and/or purified prior to contacting the glucose-1-phosphate with the alpha-glucan phosphorylase. In other cases, the glucose-1-phosphate generated from the reaction with sucrose phosphorylase is not isolated and/or purified prior to contacting the glucose-1-phosphate with the alpha-glucan phosphorylase. The term “substantially simultaneously” when used in context with the addition of two or more components to a reaction mixture as described herein means the two or more components are added to the reaction mixture within 10 seconds or less of one another.

In some cases, the sucrose phosphorylase is a wild-type sucrose phosphorylase. For example, the wild-type sucrose phosphorylase may be Bifidobacterium longum sucrose phosphorylase (e.g., NCBI Accession No. AAO84039). In some cases, the wild-type Bifidobacterium longum sucrose phosphorylase may have the amino acid sequence according to SEQ ID NO: 17. In some cases, the wild-type sucrose phosphorylase may be Leuconostoc mesenteroide sucrose phosphorylase (e.g., NCBI Accession No. D90314.1). In some cases, the wild-type Leuconostoc mesenteroide sucrose phosphorylase may have the amino acid sequence according to SEQ ID NO: 18. In some cases, the wild-type sucrose phosphorylase may be Streptococcus mutans sucrose phosphorylase (e.g., NCBI Accession No. NZ_CP013237.1). In some cases, the wild-type Streptococcus mutans sucrose phosphorylase may have the amino acid sequence according to SEQ ID NO: 19 (e.g., NCBI Accession No. P10249). In some cases, the sucrose phosphorylase enzyme is a variant sucrose phosphorylase enzyme. In some cases, the variant sucrose phosphorylase has one or more amino acid substitutions relative to a wild-type sucrose phosphorylase. In some cases, the variant sucrose phosphorylase has an amino acid substitution at one or more of, or all of, amino acid residues T47, S62, Y77, V128, K140, Q144, N155, and D249, relative to SEQ ID NO: 19. In some cases, the amino acid substitution at amino acid position 47 relative to SEQ ID NO: 19 is T47S. In some cases, the amino acid substitution at amino acid position 62 relative to SEQ ID NO: 19 is S62P. In some cases, the amino acid substitution at amino acid position 77 relative to SEQ ID NO: 19 is Y77H. In some cases, the amino acid substitution at amino acid position 128 relative to SEQ ID NO: 19 is V128L. In some cases, the amino acid substitution at amino acid position 140 relative to SEQ ID NO: 19 is K140M. In some cases, the amino acid substitution at amino acid position 144 relative to SEQ ID NO: 19 is Q144R. In some cases, the amino acid substitution at amino acid position 155 relative to SEQ ID NO: 19 is N155S. In some cases, the amino acid substitution at amino acid position 249 relative to SEQ ID NO: 19 is D249G. In some cases, the variant sucrose phosphorylase has amino acid substitutions T47S, S62P, Y77H, V128L, K140M, Q144R, N155S, and D249G, relative to SEQ ID NO: 19. In some cases, the variant sucrose phosphorylase comprises or consists of an amino acid sequence according to SEQ ID NO: 20. Table 3 below depicts non-limiting examples of sucrose phosphorylase enzymes (and their amino acid sequences) that can be used in accordance with the methods provided herein.

TABLE 3
Non-limiting examples of sucrose phosphorylase enzymes

| Enzyme | SEQ ID NO: | Sequence (5′ to 3′) |
|---|---|---|
| Bifidobacterium | SEQ ID NO: | MKNKVQLITYADRLGDGTLSSMADILRTRFDGVYDGVHILPF |
| longum | 17 | FTPFDGADAGFDPIDHTKVDERLGSWDDVAELSKTHNIMVD |
| sucrose | | AIVNHMSWESKQFQDVLEKGEESEYYPMFLTMSSVFPNGA |
| phosphorylase | | TEEDLAGIYRPRPGLPFTHYKFAGKTRLVWVSFTPQQVDID |
| | | TDSDKGWEYLMSIFDQMAASHVSYIRLDAVGYGAKEAGTS |
| | | CFMTPKTFKLISRLREEGVKRGLEILIEVHSYYKKQVEIASKV |
| | | DRVYDFALPPLLLHSLFTGHVEPVAHWTEIRPNNAVTVLDT |
| | | HDGIGVIDIGSDQLDRSLKGLVPDEDVDNLVNTIHANTHGES |
| | | QAATGAAASNLDLYQVNSTYYSALGCNDQHYLAARAVQFF |
| | | LPGVPQVYYVGALAGRNDMELLRRTNNGRDINRHYYSTAEI |
| | | DENLERPVVKALNALAKFRNELPAFDGEFSYEVDGDTSITF |
| | | RWTAADGTSTAALTFEPGRGLGTDNATPVASLAWSDAAGD |
| | | HETRDLLANPPIADID |
| Leuconostoc | SEQ ID NO: | MEIQNKAMLITYADSLGKNLKDVHQVLKEDIGDAIGGVHLLP |
| mesenteroides | 18 | FFPSTGDRGFAPADYTRVDAAFGDWADVEALGEEYYLMFD |
| sucrose | | FMINHISRESVMYQDFKKNHDDSKYKDFFIRWEKFWAKAGE |
| phosphorylase | | NRPTQADVDLIYKRKDKAPTQEITFDDGTTENLWNTFGEEQI |
| | | DIDVNSAIAKEFIKTTLEDMVKHGANLIRLDAFAYAVKKVDTN |
| | | DFFVEPEIWDTLNEVREILTPLKAEILPEIHEHYSIPKKINDHG |
| | | YFTYDFALPMTTLYTLYSGKTNQLAKWLKMSPMKQFTTLDT |
| | | HDGIGVVDARDILTDDEIDYASEQLYKVGANVKKTYSSASYN |
| | | NLDIYQINSTYYSALGNDDAAYLLSRVFQVFAPGIPQIYYVGL |
| | | LAGENDIALLESTKEGRNINRHYYTREEVKSEVKRPVVANLL |
| | | KLLSWRNESPAFDLAGSITVDTPTDTTIVVTRQDENGQNKA |
| | | VLTADAANKTFEIVENGQTVMSSDNLTQN |
| Streptococcus | SEQ ID NO: | MPIINKTMLITYADSLGKNLKELNENIENYFGDAVGGVHLLPF |
| mutans | 19 | FPSTGDRGFAPIDYHEVDSAFGDWDDVKCLGEKYYLMFDF |
| sucrose | | MINHISRQSKYYKDYQEKHEASAYKDLFLNWDKFWPKNRP |
| phosphorylase | | TQEDVDLIYKRKDRAPKQEIQFADGSVEHLWNTFGEEQIDL |
| | | DVTKEVTMDFIRSTIENLAANGCDLIRLDAFAYAVKKLDTND |
| | | FFVEPEIWTLLDKVRDIAAVSGAEILPEIHEHYTIQFKIADHDY |
| | | YVYDFALPMVTLYSLYSSKVDRLAKWLKMSPMKQFTTLDTH |
| | | DGIGVVDVKDILTDEEITYTSNELYKVGANVNRKYSTAEYNN |
| | | LDIYQINSTYYSALGDDDQKYFLARLIQAFAPGIPQVYYVGFL |
| | | AGKNDLELLESTKEGRNINRHYYSSEEIAKEVKRPVVKALLN |
| | | LFTYRNQSAAFDLDGRIEVETPNEATIVIERQNKDGSHIAKA |
| | | EINLQDMTYRVTENDQTISFE |
| SP3-M8 | SEQ ID NO: | MPITNKTMLITYADSLGKNLKELNENIENYFGDAVGGVHLLP |
| (T47S, S62P, | 20 | FFPSSGDRGFAPIDYHEVDPAFGDWDDVKRLGEKHYLMFD |
| Y77H, V128L, | | FMINHISRQSKYYKDYQEKHEASAYKDLFLNWDKFWPKNR |
| K140M, Q144R, | | PTQEDLDLIYKRKDRAPMQEIRFADGSVEHLWSTFGEEQID |
| N155S and | | LDVTKEVTMDFIRSTIENLAANGCDLIRLDAFAYAVKKLDTND |
| D249G) | | FFVEPEIWTLLDKVRDIAAVSGAEILPEIHEHYTIQFKIADHGY |
| | | YVYDFALPMVTLYSLYSGKVDRLAKWLKMSPMKQFTTLDT |
| | | HDGIGVVDVKDILTDEEITYTSNELYKVGANVNRKYSTAEYN |
| | | NLDIYQINSTYYSALGDDDQKYFLARLIQAFAPGIPQVYYVG |
| | | FLAGKNDLELLESTKEGRNINRHYYSSEEIAKEVKRPVVKAL |
| | | LNLFTYRNQSAAFDLDGRIEVETPNEATIVIERQNKDGSHIAT |
| | | AEINLQDMTYRVTENDQTISFE |

In some cases, the sucrose phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type Bifidobacterium longum sucrose phosphorylase. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 17. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type Leuconostoc mesenteroides sucrose phosphorylase. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 18. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type Streptococcus mutans sucrose phosphorylase. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 19. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 20, and comprises the amino acid substitutions T47S, S62P, Y77H, V128L, K140M, Q144R, N155S, and D249G, relative to SEQ ID NO: 19.

In some embodiments, the sucrose phosphorylase is derived from a microbial cell. In some cases, the sucrose phosphorylase is isolated and/or purified from a microbial cell. In some cases, the microbial cell is a bacterial cell. In some cases, the bacterial cell is Escherichia coli. In some embodiments, the sucrose phosphorylase is derived from Bifidobacterium longum. In some embodiments, the sucrose phosphorylase is derived from Leuconostoc mesenteroides. In some embodiments, the sucrose phosphorylase is derived from Streptococcus mutans. In some embodiments, the sucrose phosphorylase may be produced within a microbial cell. In some embodiments, the sucrose phosphorylase is expressed in a recombinant host cell (e.g., from a recombinant polynucleotide). In some cases, the sucrose phosphorylase is recombinantly produced. In some cases, the sucrose phosphorylase is produced (e.g., recombinantly produced) in a yeast cell. In some cases, the yeast cell is a Pichia yeast cell, such as a Pichia pastoris cell.

In some aspects, the alpha-glucan phosphorylase is a wild-type alpha-glucan phosphorylase. In some cases, the wild-type alpha-glucan phosphorylase may be Solanum tuberosum alpha-glucan phosphorylase (e.g., NCBI Accession No. D00520.1). In some cases, the wild-type Solanum tuberosum alpha-glucan phosphorylase may have the amino acid sequence according to SEQ ID NO: 21. In some cases, the wild-type alpha-glucan phosphorylase may be S. tokodaii strain 7 alpha-glucan phosphorylase (e.g., NCBI Accession No. NC_003106.2). In some cases, the wild-type S. tokodaii strain 7 alpha-glucan phosphorylase may have the amino acid sequence according to SEQ ID NO: 22. In some cases, the wild-type alpha-glucan phosphorylase may be C. callunae DSM 20145 alpha-glucan phosphorylase (e.g., NCBI Accession No. AY102616.1). In some cases, the wild-type C. callunae DSM 20145 alpha-glucan phosphorylase may have the amino acid sequence according to SEQ ID NO: 23. In some cases, the alpha-glucan phosphorylase enzyme is a variant alpha-glucan phosphorylase enzyme. In some cases, the variant alpha-glucan phosphorylase has one or more amino acid substitutions relative to a wild-type alpha-glucan phosphorylase. In some cases, the variant alpha-glucan phosphorylase has an amino acid substitution at one or more of, or all of, amino acid residues F39, N135, and T706, relative to SEQ ID NO: 21. In some cases, the amino acid substitution at amino acid position 39 relative to SEQ ID NO: 21 is F39L. In some cases, the amino acid substitution at amino acid position 135 relative to SEQ ID NO: 21 is N135S. In some cases, the amino acid substitution at amino acid position 706 relative to SEQ ID NO: 21 is T7061. In some cases, the variant alpha-glucan phosphorylase has amino acid substitutions F39L, N135S, and T7061, relative to SEQ ID NO: 21. In some cases, the variant alpha-glucan phosphorylase enzyme comprises or consists of the amino acid sequence according to SEQ ID NO: 24. Table 4 below depicts non-limiting examples of alpha-glucan phosphorylase enzymes (and their amino acid sequences) that can be used in accordance with the methods provided herein.

TABLE 4
Non-limiting examples of alpha-glucan phosphorylase enzymes

| | SEQ ID NO: | Sequence (5′ to 3′) |
|---|---|---|
| Solanum | SEQ ID NO: | TLSEKIHHPITEQGGESDLSSFAPDAASITSSIKYHAEFTPVF |
| tuberosum | 21 | SPERFELPKAFFATAQSVRDSLLINWNATYDIYEKLNMKQAY |
| alpha-glucan | | YLSMEFLQGRALLNAIGNLELTGAFAEALKNLGHNLENVAS |
| phosphorylase | | QEPDAALGNGGLGRLASCFLDSLATLNYPAWGYGLRYKYG |
| | | LFKQRITKDGQEEVAEDWLEIGSPWEVVRNDVSYPIKFYGK |
| | | VSTGSDGKRYWIGGEDIKAVAYDVPIPGYKTRTTISLRLWST |
| | | QVPSADFDLSAFNAGEHTKACEAQANAEKICYILYPGDESE |
| | | EGKILRLKQQYTLCSASLQDIISRFERRSGDRIKWEEFPEKV |
| | | AVQMNDTHPTLCIPELMRILIDLKGLNWNEAWNITQRTVAYT |
| | | NHTVLPEALEKWSYELMQKLLPRHVEIIEAIDEELVHEIVLKY |
| | | GSMDLNKLEEKLTTMRILENFDLPSSVAELFIKPEISVDDDTE |
| | | TVEVHDKVEASDKVVTNDEDDTGKKTSVKIEAAAEKDIDKKT |
| | | PVSPEPAVIPPKKVRMANLCVVGGHAVNGVAEIHSEIVKEEV |
| | | FNDFYELWPEKFQNKTNGVTPRRWIRFCNPPLSAIITKWTG |
| | | TEDWVLKTEKLAELQKFADNEDLQNEWREAKRSNKIKVVSF |
| | | LKEKTGYSVVPDAMFDIQVKRIHEYKRQLLNIFGIVYRYKKM |
| | | KEMTAAERKTNFVPRVCIFGGKAFATYVQAKRIVKFITDVGA |
| | | TINHDPEIGDLLKVVFVPDYNVSVAELLIPASDLSEHISTAGM |
| | | EASGTSNMKFAMNGCIQIGTLDGANVEIREEVGEENFFLFG |
| | | AQAHEIAGLRKERADGKFVPDERFEEVKEFVRSGAFGSYN |
| | | YDDLIGSLEGNEGFGRADYFLVGKDFPSYIECQEKVDEAYR |
| | | DQKRWTTMSILNTAGSYKFSSDRTIHEYAKDIWNIEAVEIA |
| S. tokodaii | SEQ ID NO: | MRKHLKGKAHKKLHMIISITAELGIDFGENFAGGLGVLEGDK |
| strain 7 alpha- | 22 | FYASARLGIDYTVFTLFYRKGYTGNEEKQKELLKNLVKEWE |
| glucan | | TEIELKKGKIKIEYLTYKLNTAKAIFINILSPDWAKRLNEKLYIE |
| phosphorylase | | NSEEDRFYKYLVLAKATEKYISEKIGWDKIKYVDLQEAYPSF |
| | | LPLLKYFPRYRIIIHTPAPWGHPTFPARYFKEEFGFEFPFDPV |
| | | VMTEIGLSSAVQGIVVSKKMLHHVSKTFPHHMHKIKAITNAV |
| | | EIPRWRHPLLNNVKDLDDFIKKKKEVKKESLKKLGKESDKPT |
| | | IGWVRRITQYKRPEFILRLIDELRDDVVFIIGGKAHPYEYYGV |
| | | ELEKKFKEYAQKRNNVIYVQGVDIQQMKLAIWSSDIWTFTPY |
| | | SGWEASGTSFMKAGVNGVPSVASRDGAVPEIIKDGYNGWL |
| | | YGEDRYELLPVDTYDREYEEFARKVKEALNKYYEVGYNAY |
| | | HTFSDFCSMDRLMKEYAL |
| C. callunae | SEQ ID NO: | MSPEKQPLPAALVGSHVRAAAGTPADLATDRKFWTGLSRA |
| DSM 20145 | 23 | VQERIADDWERTREAYGAARQQHYFSAEFLMGRALLNNLT |
| alpha-glucan | | NLGLVDEAAAATRELGHELTDILEIENDAALGNGGLGRLAAC |
| phosphorylase | | FLDSAVTQDYPVTGYGLLYRFGLFRQSFNEGFQVEKPDPW |
| | | REEEYPFTIRRASDQLVVCFDDMKTRAIPYDMPITGYGTHN |
| | | VGTLRLWKAEPWEEFDYDAFNSQRFTDAIIERERVSDICRV |
| | | LYPNDTTYEGKKLRVRQQYFFTSASLQAMIQDHLAHHKDLS |
| | | NFAEFHSVQLNDTHPVLAIPELMRLLMDEHDMGWEESWAI |
| | | VSKTFAYTNHTVLTEALEQWDEQIFQQLFWRVWEIIAEIDRR |
| | | FRLERAADGLDEETINRMAPIQHGTVHMAWIACYAAYSING |
| | | VAALHTEIIKAETLADWYALWPEKFNNKTNGVTPRRWLRMI |
| | | NPGLSDLLTRLSGSDDWVTDLDELKKLRSYADDKSVLEELR |
| | | AIKAANKQDFAEWILERQGIEIDPESIFDVQIKRLHEYKRQLM |
| | | NALYVLDLYFRIKEDGLTDIPARTVIFGAKAAPGYVRAKAIIKL |
| | | INSIADLVNNDPEVSPLLKVVFVENYNVSPAEHILPASDVSE |
| | | QISTAGKEASGTSNMKFMMNGALTLGTMDGANVEIVDSVG |
| | | EENAYIFGARVEELPALRESYKPYELYETVPGLKRALDALDN |
| | | GTLNDNNSGLFYDLKHSLIHGYGKDASDTYYVLGDFADYRE |
| | | TRDRMAADYASDPLGWARMAWINICESGRFSSDRTIRDYA |
| | | TEIWKLEPTPAVKK |
| GP-M3 (GP | SEQ ID NO: | TLSEKIHHPITEQGGESDLSSFAPDAASITSSIKYHAELTPVF |
| F39L N135S | 24 | SPERFELPKAFFATAQSVRDSLLINWNATYDIYEKLNMKQAY |
| T7061) | | YLSMEFLQGRALLNAIGNLELTGAFAEALKNLGHNLENVAS |
| | | QEPDAALGSGGLGRLASCFLDSLATLNYPAWGYGLRYKYG |
| | | LFKQRITKDGQEEVAEDWLEIGSPWEVVRNDVSYPIKFYGK |
| | | VSTGSDGKRYWIGGEDIKAVAYDVPIPGYKTRTTISLRLWST |
| | | QVPSADFDLSAFNAGEHTKACEAQANAEKICYILYPGDESE |
| | | EGKILRLKQQYTLCSASLQDIISRFERRSGDRIKWEEFPEKV |
| | | AVQMNDTHPTLCIPELMRILIDLKGLNWNEAWNITQRTVAYT |
| | | NHTVLPEALEKWSYELMQKLLPRHVEIIEAIDEELVHEIVLKY |
| | | GSMDLNKLEEKLTTMRILENFDLPSSVAELFIKPEISVDDDTE |
| | | TVEVHDKVEASDKVVTNDEDDTGKKTSVKIEAAAEKDIDKKT |
| | | PVSPEPAVIPPKKVRMANLCVVGGHAVNGVAEIHSEIVKEEV |
| | | FNDFYELWPEKFQNKTNGVTPRRWIRFCNPPLSAIITKWTG |
| | | TEDWVLKTEKLAELQKFADNEDLQNEWREAKRSNKIKVVSF |
| | | LKEKTGYSVVPDAMFDIQVKRIHEYKRQLLNIFGIVYRYKKM |
| | | KEMTAAERKTNFVPRVCIFGGKAFATYVQAKRIVKFIIDVGA |
| | | TINHDPEIGDLLKVVFVPDYNVSVAELLIPASDLSEHISTAGM |
| | | EASGTSNMKFAMNGCIQIGTLDGANVEIREEVGEENFFLFG |
| | | AQAHEIAGLRKERADGKFVPDERFEEVKEFVRSGAFGSYN |
| | | YDDLIGSLEGNEGFGRADYFLVGKDFPSYIECQEKVDEAYR |
| | | DQKRWTTMSILNTAGSYKFSSDRTIHEYAKDIWNIEAVEIA |

In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type Solanum tuberosum alpha-glucan phosphorylase. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 21. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type S. tokodaii strain 7 alpha-glucan phosphorylase. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 22. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type C. callunae DSM 20145 alpha-glucan phosphorylase. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 23. In some cases, the sucrose phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 24, and comprises the amino acid substitutions F39L, N135S, and T7061, relative to SEQ ID NO: 21.

In some embodiments, the alpha-glucan phosphorylase is derived from a microbial cell. In some cases, the alpha-glucan phosphorylase is isolated and/or purified from a microbial cell. In some cases, the microbial cell is a bacterial cell. In some cases, the bacterial cell is Escherichia coli. In some embodiments, the alpha-glucan phosphorylase is derived from Solanum tuberosum. In some embodiments, the alpha-glucan phosphorylase is derived from S. tokodaii strain 7. In some embodiments, the alpha-glucan phosphorylase is derived from C. callunae DSM 20145. In some embodiments, the alpha-glucan phosphorylase may be produced within a microbial cell. In some embodiments, the alpha-glucan phosphorylase is expressed in a recombinant host cell (e.g., from a recombinant polynucleotide). In some cases, the alpha-glucan phosphorylase is recombinantly produced. In some cases, the alpha-glucan phosphorylase is produced (e.g., recombinantly produced) in a yeast cell. In some cases, the yeast cell is a Pichia yeast cell, such as a Pichia pastoris cell.

### Method Step (b) for Enzymatic Conversion of Amylose to Beta-Cyclodextrin

In various aspects, the methods further comprise enzymatically converting the amylose (e.g., produced by the methods (e.g. method step (a)) provided herein) to cyclodextrin, preferably beta-cyclodextrin. In some cases, the methods comprise contacting the amylose with an enzyme or an enzyme mixture (e.g., such as two or more enzymes) capable of converting amylose to cyclodextrin under conditions that permit the conversion of the amylose to cyclodextrin. In some cases, the enzyme capable of converting amylose to cyclodextrin is a variant enzyme capable of producing a greater amount and/or concentration of beta-cyclodextrin than alpha-cyclodextrin, gamma-cyclodextrin, or both, relative to a wild-type enzyme capable of converting amylose to cyclodextrin.

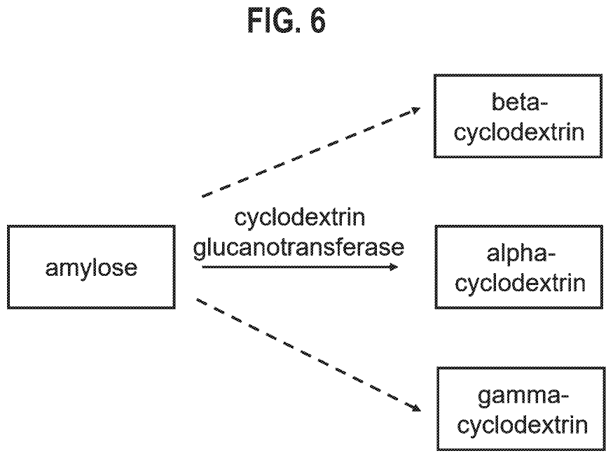

In some aspects, the enzyme capable of converting the amylose to cyclodextrin comprises a variant cyclodextrin glucanotransferase. In some cases, the variant cyclodextrin glucanotransferase comprises at least one amino acid variant relative to a wild-type cyclodextrin glucanotransferase. FIG. 6 depicts the enzymatic conversion of amylose to beta-cyclodextrin with cyclodextrin glucanotransferase. Preferably, the cyclodextrin glucanotransferase produces beta-cyclodextrin from amylose in an amount and/or concentration greater than an amount and/or concentration of alpha-cyclodextrin and/or gamma-cyclodextrin.

In some embodiments, the cyclodextrin glucanotransferase is a variant cyclodextrin glucanotransferase comprising at least one amino acid variant relative to a wild-type cyclodextrin glucanotransferase. The variant cyclodextrin glucanotransferase may comprise one or more amino acid substitutions, deletions, insertions, and/or modifications relative to a wild-type cyclodextrin glucanotransferase. In some cases, the variant cyclodextrin glucanotransferase is capable of producing a greater amount and/or concentration of beta-cyclodextrin relative to alpha-cyclodextrin and/or gamma-cyclodextrin from amylose relative to a wild-type cyclodextrin glucanotransferase.

In some cases, the variant cyclodextrin glucanotransferase comprises at least one amino acid variant relative to wild-type Bacillus sp. (strain no. 38-2) cyclodextrin glucanotransferase (e.g., NCBI Accession No. M19880.1; SEQ ID NO: 25). In some cases, the variant cyclodextrin glucanotransferase comprises at least one amino acid variant relative to wild-type B. circulans strain 251 cyclodextrin glucanotransferase (e.g., NCBI Accession No. X78145.1; SEQ ID NOS: 26 or 27). In some cases, the variant cyclodextrin glucanotransferase comprises at least one amino acid variant relative to wild-type B. circulans strain 251 cyclodextrin glucanotransferase of SEQ ID NO: 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 25. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOs: 26 or 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27.

In some cases, the at least one amino acid variant comprises at least one amino acid substitution relative to a wild-type cyclodextrin glucanotransferase. In some cases, the at least one amino acid substitution comprises an amino acid substitution at amino acid position 31 relative to the amino acid sequence of SEQ ID NO: 27. In some cases, the amino acid substitution at amino acid position 31 relative to the amino acid sequence of SEQ ID NO: 27 is A31R (e.g., SEQ ID NO: 28 in Table 5). In some cases, the amino acid substitution at amino acid position 31 relative to the amino acid sequence of SEQ ID NO: 27 is A31P (e.g., SEQ ID NO: 29 in Table 5). In some cases, the amino acid substitution at amino acid position 31 relative to the amino acid sequence of SEQ ID NO: 27 is A31T (e.g., SEQ ID NO: 30 in Table 5). In some aspects, the cyclodextrin glucanotransferase comprises or consists of an amino acid sequence according to any one of SEQ ID NOS: 25-30, depicted in Table 5.

In some cases, the variant cyclodextrin glucanotransferase comprises at least one amino acid variant relative to wild-type Paenibacillus macerans cyclodextrin glucanotransferase (e.g., NCBI Accession No. AAA22298.1 or X59045.1; e.g., SEQ ID NOS: 31-34). In some cases, the variant cyclodextrin glucanotransferase comprises at least one amino acid variant relative to any one of SEQ ID NOS: 31-34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of wild-type Paenibacillus macerans cyclodextrin n glucanotransferase. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of any one of SEQ ID NOS: 31-34.

In some cases, the at least one amino acid variant comprises at least one amino acid substitution relative to a wild-type cyclodextrin glucanotransferase. In some cases, the at least one amino acid substitution comprises an amino acid substitution at amino acid position 146 relative to the amino acid sequence of SEQ ID NO: 34. In some cases, the amino acid substitution at amino acid position 146 relative to the amino acid sequence of SEQ ID NO: 34 is R146A (e.g., SEQ ID NO: 35 in Table 5). In some cases, the amino acid substitution at amino acid position 146 relative to the amino acid sequence of SEQ ID NO: 34 is R146P (e.g., SEQ ID NO: 36 in Table 5). In some cases, the at least one amino acid substitution comprises an amino acid substitution at amino acid position 147 relative to the amino acid sequence of SEQ ID NO: 34. In some cases, the amino acid substitution at amino acid position 147 relative to the amino acid sequence of SEQ ID NO: 34 is D147A (e.g., SEQ ID NO: 37 in Table 5). In some cases, the amino acid substitution at amino acid position 147 relative to the amino acid sequence of SEQ ID NO: 34 is D147P (e.g., SEQ ID NO: 38 in Table 5). In some cases, the at least one amino acid substitution comprises an amino acid substitution at amino acid positions 146 and 147 relative to the amino acid sequence of SEQ ID NO: 34. In some cases, the amino acid substitution at amino acid position 146 relative to the amino acid sequence of SEQ ID NO: 34 is R146A, and the amino acid substitution at amino acid position 147 relative to the amino acid sequence of SEQ ID NO: 34 is D147P (e.g., SEQ ID NO: 39 in Table 5). In some cases, the amino acid substitution at amino acid position 146 relative to the amino acid sequence of SEQ ID NO: 34 is R146P, and the amino acid substitution at amino acid position 147 relative to the amino acid sequence of SEQ ID NO: 34 is D147A (e.g., SEQ ID NO: 40 in Table 5). In some cases, the amino acid substitution at amino acid position 146 relative to the amino acid sequence of SEQ ID NO: 34 is R146P, and the amino acid substitution at amino acid position 147 relative to the amino acid sequence of SEQ ID NO: 34 is D147P (e.g., SEQ ID NO: 41 in Table 5).

In some cases, the at least one amino acid substitution comprises an amino acid substitution at amino acid position 372 relative to the amino acid sequence of SEQ ID NO: 32 or SEQ ID NO: 34. In some cases, the amino acid substitution at amino acid position 372 relative to the amino acid sequence of SEQ ID NO: 32 or SEQ ID NO: 34 is D372K (e.g., SEQ ID NO: 42 (relative to SEQ ID NO: 32), and SEQ ID NO: 45 (relative to SEQ ID NO: 34), in Table 5). In some cases, the at least one amino acid substitution comprises an amino acid substitution at amino acid position 89 relative to the amino acid sequence of SEQ ID NO: 32 or SEQ ID NO: 34. In some cases, the amino acid substitution at amino acid position 89 relative to the amino acid sequence of SEQ ID NO: 32 or SEQ ID NO: 34 is Y89R (e.g., SEQ ID NO: 43 (relative to SEQ ID NO: 32), and SEQ ID NO: 47 (relative to SEQ ID NO: 34), in Table 5). In some cases, the at least one amino acid substitution comprises an amino acid substitution at amino acid position 372 relative to the amino acid sequence of SEQ ID NO: 32 or SEQ ID NO: 34, and an amino acid substitution at amino acid position 89 relative to the amino acid sequence of SEQ ID NO: 32 or SEQ ID NO: 34. In some cases, the amino acid substitution at amino acid position 372 relative to the amino acid sequence of SEQ ID NO: 32 or 34 is D372K, and the amino acid substitution at amino acid position 89 relative to the amino acid sequence of SEQ ID NO: 32 or 34 is Y89R (e.g., SEQ ID NO: 44 (relative to SEQ ID NO: 32), and SEQ ID NO: 47 (relative to SEQ ID NO: 34), in Table 5).

In some aspects, the cyclodextrin glucanotransferase comprises or consists of an amino acid sequence according to any one of SEQ ID NOS: 31-47, depicted in Table 5. In some aspects, the cyclodextrin glucanotransferase comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence of any one of SEQ ID NOS: 31-47, depicted in Table 5.

In a particular aspect, the cyclodextrin glucanotransferase comprises or consists of the amino acid sequence according to SEQ ID NO: 34, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 34.

In another particular aspect, the cyclodextrin glucanotransferase comprises or consists of the amino acid sequence according to SEQ ID NO: 39, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 39.

In another particular aspect, the cyclodextrin glucanotransferase comprises or consists of the amino acid sequence according to SEQ ID NO: 40, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 40.

In another particular aspect, the cyclodextrin glucanotransferase comprises or consists of the amino acid sequence according to SEQ ID NO: 41, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 41.

In another particular aspect, the cyclodextrin glucanotransferase comprises or consists of the amino acid sequence according to SEQ ID NO: 47, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 47.

TABLE 5
Non-limiting examples of cyclodextrin glucanotransferase enzymes

| | SEQ ID NO: | Sequence (5′ to 3′) |
|---|---|---|
| Wild-type | SEQ ID NO: | MKRFMKLTAVWTLWLSLTLGLLSPVHAAPDTSVSNKQNFST |
| Bacillus sp. | 25 | DVIYQIFTDRFSDGNPANNPTGAAFDGSCTNLRLYCGGDW |
| (strain no. | | QGIINKINDGYLTGMGITAIWISQPVENIYSVINYSGVHNTAY |
| 2) | | HGYWARDFKKTNPAYGTMQDFKNLIDTAHAHNIKVIIDFAPN |
| 38-cyclodextrin | | HTSPASSDDPSFAENGRLYDNGNLLGGYTNDTQNLFHHYG |
| glucano- | | GTDFSTIENGIYKNLYDLADLNHNNSSVDVYLKDAIKMWLDL |
| transferase | | GVDGIRVDAVKHMPFGWQKSFMSTINNYKPVFNFGEWFLG |
| | | VNEISPEYHQFANESGMSLLDFPFAQKARQVFRDNTDNMY |
| | | GLKAMLEGSEVDYAQVNDQVTFIDNHDMERFHTSNGDRRK |
| | | LEQALAFTLTSRGVPAIYYGSEQYMSGGNDPDNRARIPSFS |
| | | TTTTAYQVIQKLAPLRKSNPAIAYGSTQERWINNDVIIYERKF |
| | | GNNVAVVAINRNMNTPASITGLVTSLPQGSYNDVLGGILNG |
| | | NTLTVGAGGAASNFTLAPGGTAVWQYTTDATAPINGNVGP |
| | | MMAKAGVTITIDGRASARQGTVYFGTTAVTGADIVAWEDTQ |
| | | IQVKILRVPGGIYDIRVANAAGAASNIYDNFEVLTGDQVTVRF |
| | | VINNATTALGQNVFLTGNVSELGNWDPNNAIGPMYNQVVY |
| | | QYPTWYYDVSVPAGQTIEFKFLKKQGSTVTWEGGANRTFT |
| | | TPTSGTATVNVNWQP |
| Wild-type B. | SEQ ID NO: | MKKFLKSTAALALGLSLTFGLFSPAQAAPDTSVSNKQNFST |
| circulans | 26 | DVIYQIFTDRFSDGNPANNPTGAAFDGTCTNLRLYCGGDW |
| strain 251 | | QGIINKINDGYLTGMGVTAIWISQPVENIYSIINYSGVNNTAY |
| cyclodextrin | | HGYWARDFKKTNPAYGTIADFQNLIAAAHAKNIKVIIDFAPNH |
| glucano- | | TSPASSDQPSFAENGRLYDNGTLLGGYTNDTQNLFHHNGG |
| transferase | | TDFSTTENGIYKNLYDLADLNHNNSTVDVYLKDAIKMWLDL |
| | | GIDGIRMDAVKHMPFGWQKSFMAAVNNYKPVFTFGEWFLG |
| | | VNEVSPENHKFANESGMSLLDFRFAQKVRQVFRDNTDNMY |
| | | GLKAMLEGSAADYAQVDDQVTFIDNHDMERFHASNANRRK |
| | | LEQALAFTLTSRGVPAIYYGTEQYMSGGTDPDNRARIPSFS |
| | | TSTTAYQVIQKLAPLRKCNPAIAYGSTQERWINNDVLIYERK |
| | | FGSNVAVVAVNRNLNAPASISGLVTSLPQGSYNDVLGGLLN |
| | | GNTLSVGSGGAASNFTLAAGGTAVWQYTAATATPTIGHVG |
| | | PMMAKPGVTITIDGRGFGSSKGTVYFGTTAVSGADITSWED |
| | | TQIKVKIPAVAGGNYNIKVANAAGTASNVYDNFEVLSGDQV |
| | | SVRFVVNNATTALGQNVYLTGSVSELGNWDPAKAIGPMYN |
| | | QWVYQYPNWYYDVSVPAGKTIEFKFLKKQGSTVTWEGGSN |
| | | HTFTAPSSGTATINVNWQP |
| Wild-type B. | SEQ ID NO: | APDTSVSNKQNFSTDVIYQIFTDRFSDGNPANNPTGAAFDG |
| circulans | 27 | TCTNLRLYCGGDWQGIINKINDGYLTGMGVTAIWISQPVENI |
| strain 251 | | YSIINYSGVNNTAYHGYWARDFKKTNPAYGTIADFQNLIAAA |
| cyclodextrin | | HAKNIKVIIDFAPNHTSPASSDQPSFAENGRLYDNGTLLGGY |
| glucano- | | TNDTQNLFHHNGGTDFSTTENGIYKNLYDLADLNHNNSTVD |
| transferase | | VYLKDAIKMWLDLGIDGIRMDAVKHMPFGWQKSFMAAVNN |
| (mature chain) | | YKPVFTFGEWFLGVNEVSPENHKFANESGMSLLDFRFAQK |
| | | VRQVFRDNTDNMYGLKAMLEGSAADYAQVDDQVTFIDNHD |
| | | MERFHASNANRRKLEQALAFTLTSRGVPAIYYGTEQYMSG |
| | | GTDPDNRARIPSFSTSTTAYQVIQKLAPLRKCNPAIAYGSTQ |
| | | ERWINNDVLIYERKFGSNVAVVAVNRNLNAPASISGLVTSLP |
| | | QGSYNDVLGGLLNGNTLSVGSGGAASNFTLAAGGTAVWQ |
| | | YTAATATPTIGHVGPMMAKPGVTITIDGRGFGSSKGTVYFG |
| | | TTAVSGADITSWEDTQIKVKIPAVAGGNYNIKVANAAGTASN |
| | | VYDNFEVLSGDQVSVRFVVNNATTALGQNVYLTGSVSELG |
| | | NWDPAKAIGPMYNQVVYQYPNWYYDVSVPAGKTIEFKFLK |
| | | KQGSTVTWEGGSNHTFTAPSSGTATINVNWQP |
| Cyclodextrin | SEQ ID NO: | APDTSVSNKQNFSTDVIYQIFTDRFSDGNPRNNPTGAAFDG |
| glucano- | 28 | TCTNLRLYCGGDWQGIINKINDGYLTGMGVTAIWISQPVENI |
| transferase | | YSIINYSGVNNTAYHGYWARDFKKTNPAYGTIADFQNLIAAA |
| A31R | | HAKNIKVIIDFAPNHTSPASSDQPSFAENGRLYDNGTLLGGY |
| | | TNDTQNLFHHNGGTDFSTTENGIYKNLYDLADLNHNNSTVD |
| | | VYLKDAIKMWLDLGIDGIRMDAVKHMPFGWQKSFMAAVNN |
| | | YKPVFTFGEWFLGVNEVSPENHKFANESGMSLLDFRFAQK |
| | | VRQVFRDNTDNMYGLKAMLEGSAADYAQVDDQVTFIDNHD |
| | | MERFHASNANRRKLEQALAFTLTSRGVPAIYYGTEQYMSG |
| | | GTDPDNRARIPSFSTSTTAYQVIQKLAPLRKCNPAIAYGSTQ |
| | | ERWINNDVLIYERKFGSNVAVVAVNRNLNAPASISGLVTSLP |
| | | QGSYNDVLGGLLNGNTLSVGSGGAASNFTLAAGGTAVWQ |
| | | YTAATATPTIGHVGPMMAKPGVTITIDGRGFGSSKGTVYFG |
| | | TTAVSGADITSWEDTQIKVKIPAVAGGNYNIKVANAAGTASN |
| | | VYDNFEVLSGDQVSVRFVVNNATTALGQNVYLTGSVSELG |
| | | NWDPAKAIGPMYNQVVYQYPNWYYDVSVPAGKTIEFKFLK |
| | | KQGSTVTWEGGSNHTFTAPSSGTATINVNWQP |
| Cyclodextrin | SEQ ID NO: | APDTSVSNKQNFSTDVIYQIFTDRFSDGNPPNPTGAAFDGT |
| glucano- | 29 | CTNLRLYCGGDWQGIINKINDGYLTGMGVTAIWISQPVENIY |
| transferase | | SIINYSGVNNTAYHGYWARDFKKTNPAYGTIADFQNLIAAAH |
| A31P | | AKNIKVIIDFAPNHTSPASSDQPSFAENGRLYDNGTLLGGYT |
| | | NDTQNLFHHNGGTDFSTTENGIYKNLYDLADLNHNNSTVDV |
| | | YLKDAIKMWLDLGIDGIRMDAVKHMPFGWQKSFMAAVNNY |
| | | KPVFTFGEWFLGVNEVSPENHKFANESGMSLLDFRFAQKV |
| | | RQVFRDNTDNMYGLKAMLEGSAADYAQVDDQVTFIDNHD |
| | | MERFHASNANRRKLEQALAFTLTSRGVPAIYYGTEQYMSG |
| | | GTDPDNRARIPSFSTSTTAYQVIQKLAPLRKCNPAIAYGSTQ |
| | | ERWINNDVLIYERKFGSNVAVVAVNRNLNAPASISGLVTSLP |
| | | QGSYNDVLGGLLNGNTLSVGSGGAASNFTLAAGGTAVWQ |
| | | YTAATATPTIGHVGPMMAKPGVTITIDGRGFGSSKGTVYFG |
| | | TTAVSGADITSWEDTQIKVKIPAVAGGNYNIKVANAAGTASN |
| | | VYDNFEVLSGDQVSVRFVVNNATTALGQNVYLTGSVSELG |
| | | NWDPAKAIGPMYNQVVYQYPNWYYDVSVPAGKTIEFKFLK |
| | | KQGSTVTWEGGSNHTFTAPSSGTATINVNWQP |
| Cyclodextrin | SEQ ID NO: | APDTSVSNKQNFSTDVIYQIFTDRFSDGNPTNPTGAAFDGT |
| glucano- | 30 | CTNLRLYCGGDWQGIINKINDGYLTGMGVTAIWISQPVENIY |
| transferase | | SIINYSGVNNTAYHGYWARDFKKTNPAYGTIADFQNLIAAAH |
| A31T | | AKNIKVIIDFAPNHTSPASSDQPSFAENGRLYDNGTLLGGYT |
| | | NDTQNLFHHNGGTDFSTTENGIYKNLYDLADLNHNNSTVDV |
| | | YLKDAIKMWLDLGIDGIRMDAVKHMPFGWQKSFMAAVNNY |
| | | KPVFTFGEWFLGVNEVSPENHKFANESGMSLLDFRFAQKV |
| | | RQVFRDNTDNMYGLKAMLEGSAADYAQVDDQVTFIDNHD |
| | | MERFHASNANRRKLEQALAFTLTSRGVPAIYYGTEQYMSG |
| | | GTDPDNRARIPSFSTSTTAYQVIQKLAPLRKCNPAIAYGSTQ |
| | | ERWINNDVLIYERKFGSNVAVVAVNRNLNAPASISGLVTSLP |
| | | QGSYNDVLGGLLNGNTLSVGSGGAASNFTLAAGGTAVWQ |
| | | YTAATATPTIGHVGPMMAKPGVTITIDGRGFGSSKGTVYFG |
| | | TTAVSGADITSWEDTQIKVKIPAVAGGNYNIKVANAAGTASN |
| | | VYDNFEVLSGDQVSVRFVVNNATTALGQNVYLTGSVSELG |
| | | NWDPAKAIGPMYNQVVYQYPNWYYDVSVPAGKTIEFKFLK |
| | | KQGSTVTWEGGSNHTFTAPSSGTATINVNWQP |
| Wild-type | SEQ ID NO: | MKSRYKRLTSLALSLSMALGISLPAWASPDTSVDNKVNFST |
| Paenibacillus | 31 | DVIYQIVTDRFADGDRTNNPAGDAFSGDRSNLKLYFGGDW |
| macerans | | QGIIDKINDGYLTGMGVTALWISQPVENITSVIKYSGVNNTSY |
| cyclodextrin | | HGYWARDFKQTNDAFGDFADFQNLIDTLTLITSRSDRLRPQ |
| glucano- | | PHVSGRAGTNPGFAENGALYDNGSLLGAYSNDTAGLFHHN |
| transferase | | GGTDFSTIEDGIYKNLYDLADINHNNNAMDAYFKSAIDLWLG |
| (PMcgt1) | | MGVDGIRFDAVKQYPFGWQKSFVSSIYGGDHPVFTFGEWY |
| | | LGADQTDGDNIKFANESGMNLLDFEYAQEVREVFRDKTET |
| | | MKDLYEVLASTESQYDYINNMVTFIDNHDMDRFQVAGSGT |
| | | RATEQALALTLTSRGVPAIYYGTEQYMTGDGDPNNRAMMT |
| | | SFNTGTTAYKVIQALAPLRKSNPAIAYGTTTERWVNNDVLIIE |
| | | RKFGSSAALVAINRNSSAAYPISGLLSSLPAGTYSDVLNGLL |
| | | NGNSITVGSGGAVTNFTLAAGGTAVWQYTAPETSPAIGNVG |
| | | PTMGQPGNIVTIDGRGFGGTAGTVYFGTTAVTGSGIVSWED |
| | | TQIKAVIPKVAAGKTGVSVKTSSGTASNTFKSFNVLTGDQVT |
| | | VRFLVNQANTNYGTNVYLVGNAAELGTWDPNKAIGPMYNQ |
| | | VIAKYPSWYYDVSVPAGTKLDFKFIKKGGGTVTWEGGGNH |
| | | TYTTPASGVGTVTVDWQN |
| Wild-type | SEQ ID NO: | SPDTSVDNKVNFSTDVIYQIVTDRFADGDRTNNPAGDAFSG |
| Paenibacillus | 32 | DRSNLKLYFGGDWQGIIDKINDGYLTGMGVTALWISQPVENI |
| macerans | | TSVIKYSGVNNTSYHGYWARDFKQTNDAFGDFADFQNLIDT |
| cyclodextrin | | LTLITSRSDRLRPQPHVSGRAGTNPGFAENGALYDNGSLLG |
| glucano- | | AYSNDTAGLFHHNGGTDFSTIEDGIYKNLYDLADINHNNNA |
| transferase | | MDAYFKSAIDLWLGMGVDGIRFDAVKQYPFGWQKSFVSSIY |
| (PMcgt1) | | GGDHPVFTFGEWYLGADQTDGDNIKFANESGMNLLDFEYA |
| mature chain | | QEVREVFRDKTETMKDLYEVLASTESQYDYINNMVTFIDNH |
| | | DMDRFQVAGSGTRATEQALALTLTSRGVPAIYYGTEQYMT |
| | | GDGDPNNRAMMTSFNTGTTAYKVIQALAPLRKSNPAIAYGT |
| | | TTERWVNNDVLIIERKFGSSAALVAINRNSSAAYPISGLLSSL |
| | | PAGTYSDVLNGLLNGNSITVGSGGAVTNFTLAAGGTAVWQ |
| | | YTAPETSPAIGNVGPTMGQPGNIVTIDGRGFGGTAGTVYFG |
| | | TTAVTGSGIVSWEDTQIKAVIPKVAAGKTGVSVKTSSGTASN |
| | | TFKSFNVLTGDQVTVRFLVNQANTNYGTNVYLVGNAAELGT |
| | | WDPNKAIGPMYNQVIAKYPSWYYDVSVPAGTKLDFKFIKKG |
| | | GGTVTWEGGGNHTYTTPASGVGTVTVDWQN |
| Wild-type | SEQ ID NO: | MKSRYKRLTSLALSLSMALGISLPAWASPDTSVDNKVNFST |
| Paenibacillus | 33 | DVIYQIVTDRFADGDRTNNPAGDAFSGDRSNLKLYFGGDW |
| macerans | | QGIIDKINDGYLTGMGVTALWISQPVENITSVIKYSGVNNTSY |
| cyclodextrin | | HGYWARDFKQTNDAFGDFADFQNLIDTAHAHNIKVVIDFAP |
| glucano | | NHTSPADRDNPGFAENGGMYDNGSLLGAYSNDTAGLFHH |
| -erase | | NGGTDFSTIEDGIYKNLYDLADINHNNNAMDAYFKSAIDLWL |
| (PMcgt2) | | GMGVDGIRFDAVKHMPFGWQKSFVSSIYGGDHPVFTFGE |
| | | WYLGADQTDGDNIKFANESGMNLLDFEYAQEVREVFRDKT |
| | | ETMKDLYEVLASTESQYDYINNMVTFIDNHDMDRFQVAGSG |
| | | TRATEQALALTLTSRGVPAIYYGTEQYMTGDGDPNNRAMM |
| | | TSFNTGTTAYKVIQALAPLRKSNPAIAYGTTTERWVNNDVLII |
| | | ERKFGSSAALVAINRNSSAAYPISGLLSSLPAGTYSDVLNGL |
| | | LNGNSITVGSGGAVTNFTLAAGGTAVWQYTAPETSPAIGNV |
| | | GPTMGQPGNIVTIDGRGFGGTAGTVYFGTTAVTGSGIVSW |
| | | EDTQIKAVIPKVAAGKTGVSVKTSSGTASNTFKSFNVLTGDQ |
| | | VTVRFLVNQANTNYGTNVYLVGNAAELGSWDPNKAIGPMY |
| | | NQVIAKYPSWYYDVSVPAGTKLDFKFIKKGGGTVTWEGGG |
| | | NHTYTTPASGVGTVTVDWQN |
| Wild-type | SEQ ID NO: | SPDTSVDNKVNFSTDVIYQIVTDRFADGDRTNNPAGDAFSG |
| Paenibacillus | 34 | DRSNLKLYFGGDWQGIIDKINDGYLTGMGVTALWISQPVENI |
| macerans | | TSVIKYSGVNNTSYHGYWARDFKQTNDAFGDFADFQNLIDT |
| cyclodextrin | | AHAHNIKVVIDFAPNHTSPADRDNPGFAENGGMYDNGSLL |
| glucano- | | GAYSNDTAGLFHHNGGTDFSTIEDGIYKNLYDLADINHNNN |
| transferase | | AMDAYFKSAIDLWLGMGVDGIRFDAVKHMPFGWQKSFVSS |
| (PMcgt2) | | IYGGDHPVFTFGEWYLGADQTDGDNIKFANESGMNLLDFE |
| mature | | YAQEVREVFRDKTETMKDLYEVLASTESQYDYINNMVTFID |
| protein | | NHDMDRFQVAGSGTRATEQALALTLTSRGVPAIYYGTEQY |
| | | MTGDGDPNNRAMMTSFNTGTTAYKVIQALAPLRKSNPAIAY |
| | | GTTTERWVNNDVLIIERKFGSSAALVAINRNSSAAYPISGLLS |
| | | SLPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146A | 35 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADADNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146P | 36 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADPDNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| D147A | 37 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADRANPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| D147P | 38 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADRPNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146A D147P | 39 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADAPNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146P | 40 | DRSNLKLYFGGDWQGIIDKINDGYLTGMGVTALWISQPVENI |
| D147A | | TSVIKYSGVNNTSYHGYWARDFKQTNDAFGDFADFQNLIDT |
| | | AHAHNIKVVIDFAPNHTSPADPANPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146P | 41 | DRSNLKLYFGGDWQGIIDKINDGYLTGMGVTALWISQPVENI |
| D147P | | TSVIKYSGVNNTSYHGYWARDFKQTNDAFGDFADFQNLIDT |
| | | AHAHNIKVVIDFAPNHTSPADPPNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt1 | SEQ ID NO: | SPDTSVDNKVNFSTDVIYQIVTDRFADGDRTNNPAGDAFSG |
| D372K | 42 | DRSNLKLYFGGDWQGIIDKINDGYLTGMGVTALWISQPVENI |
| | | TSVIKYSGVNNTSYHGYWARDFKQTNDAFGDFADFQNLIDT |
| | | LTLITSRSDRLRPQPHVSGRAGTNPGFAENGALYDNGSLLG |
| | | AYSNDTAGLFHHNGGTDFSTIEDGIYKNLYDLADINHNNNA |
| | | MDAYFKSAIDLWLGMGVDGIRFDAVKQYPFGWQKSFVSSIY |
| | | GGDHPVFTFGEWYLGADQTDGDNIKFANESGMNLLDFEYA |
| | | QEVREVFRDKTETMKDLYEVLASTESQYDYINNMVTFIDNH |
| | | DMDRFQVAGSGTRATEQALALTLTSRGVPAIYYGTEQYMT |
| | | GDGKPNNRAMMTSFNTGTTAYKVIQALAPLRKSNPAIAYGT |
| | | TTERWVNNDVLIIERKFGSSAALVAINRNSSAAYPISGLLSSL |
| | | PAGTYSDVLNGLLNGNSITVGSGGAVTNFTLAAGGTAVWQ |
| | | YTAPETSPAIGNVGPTMGQPGNIVTIDGRGFGGTAGTVYFG |
| | | TTAVTGSGIVSWEDTQIKAVIPKVAAGKTGVSVKTSSGTASN |
| | | TFKSFNVLTGDQVTVRFLVNQANTNYGTNVYLVGNAAELGT |
| | | WDPNKAIGPMYNQVIAKYPSWYYDVSVPAGTKLDFKFIKKG |
| | | GGTVTWEGGGNHTYTTPASGVGTVTVDWQN |
| PMcgt1 Y89R | SEQ ID NO: | SPDTSVDNKVNFSTDVIYQIVTDRFADGDRTNNPAGDAFSG |
| | 43 | DRSNLKLYFGGDWQGIIDKINDGYLTGMGVTALWISQPVENI |
| | | TSVIKRSGVNNTSYHGYWARDFKQTNDAFGDFADFQNLIDT |
| | | LTLITSRSDRLRPQPHVSGRAGTNPGFAENGALYDNGSLLG |
| | | AYSNDTAGLFHHNGGTDFSTIEDGIYKNLYDLADINHNNNA |
| | | MDAYFKSAIDLWLGMGVDGIRFDAVKQYPFGWQKSFVSSIY |
| | | GGDHPVFTFGEWYLGADQTDGDNIKFANESGMNLLDFEYA |
| | | QEVREVFRDKTETMKDLYEVLASTESQYDYINNMVTFIDNH |
| | | DMDRFQVAGSGTRATEQALALTLTSRGVPAIYYGTEQYMT |
| | | GDGDPNNRAMMTSFNTGTTAYKVIQALAPLRKSNPAIAYGT |
| | | TTERWVNNDVLIIERKFGSSAALVAINRNSSAAYPISGLLSSL |
| | | PAGTYSDVLNGLLNGNSITVGSGGAVTNFTLAAGGTAVWQ |
| | | YTAPETSPAIGNVGPTMGQPGNIVTIDGRGFGGTAGTVYFG |
| | | TTAVTGSGIVSWEDTQIKAVIPKVAAGKTGVSVKTSSGTASN |
| | | TFKSFNVLTGDQVTVRFLVNQANTNYGTNVYLVGNAAELGT |
| | | WDPNKAIGPMYNQVIAKYPSWYYDVSVPAGTKLDFKFIKKG |
| | | GGTVTWEGGGNHTYTTPASGVGTVTVDWQN |
| PMcgt1 | SEQ ID NO: | SPDTSVDNKVNFSTDVIYQIVTDRFADGDRTNNPAGDAFSG |
| D372K Y89R | 44 | DRSNLKLYFGGDWQGIIDKINDGYLTGMGVTALWISQPVENI |
| | | TSVIKRSGVNNTSYHGYWARDFKQTNDAFGDFADFQNLIDT |
| | | LTLITSRSDRLRPQPHVSGRAGTNPGFAENGALYDNGSLLG |
| | | AYSNDTAGLFHHNGGTDFSTIEDGIYKNLYDLADINHNNNA |
| | | MDAYFKSAIDLWLGMGVDGIRFDAVKQYPFGWQKSFVSSIY |
| | | GGDHPVFTFGEWYLGADQTDGDNIKFANESGMNLLDFEYA |
| | | QEVREVFRDKTETMKDLYEVLASTESQYDYINNMVTFIDNH |
| | | DMDRFQVAGSGTRATEQALALTLTSRGVPAIYYGTEQYMT |
| | | GDGKPNNRAMMTSFNTGTTAYKVIQALAPLRKSNPAIAYGT |
| | | TTERWVNNDVLIIERKFGSSAALVAINRNSSAAYPISGLLSSL |
| | | PAGTYSDVLNGLLNGNSITVGSGGAVTNFTLAAGGTAVWQ |
| | | YTAPETSPAIGNVGPTMGQPGNIVTIDGRGFGGTAGTVYFG |
| | | TTAVTGSGIVSWEDTQIKAVIPKVAAGKTGVSVKTSSGTASN |
| | | TFKSFNVLTGDQVTVRFLVNQANTNYGTNVYLVGNAAELGT |
| | | WDPNKAIGPMYNQVIAKYPSWYYDVSVPAGTKLDFKFIKKG |
| | | GGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| D372K | 45 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADRDNPGFAENGGMYDNGSLL |
| | | GAYSNDTAGLFHHNGGTDFSTIEDGIYKNLYDLADINHNNN |
| | | AMDAYFKSAIDLWLGMGVDGIRFDAVKHMPFGWQKSFVSS |
| | | IYGGDHPVFTFGEWYLGADQTDGDNIKFANESGMNLLDFE |
| | | YAQEVREVFRDKTETMKDLYEVLASTESQYDYINNMVTFID |
| | | NHDMDRFQVAGSGTRATEQALALTLTSRGVPAIYYGTEQY |
| | | MTGDGKPNNRAMMTSFNTGTTAYKVIQALAPLRKSNPAIAY |
| | | GTTTERWVNNDVLIIERKFGSSAALVAINRNSSAAYPISGLLS |
| | | SLPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 Y89R | SEQ ID NO: | SPDTSVDNKVNFSTDVIYQIVTDRFADGDRTNNPAGDAFSG |
| | 46 | DRSNLKLYFGGDWQGIIDKINDGYLTGMGVTALWISQPVENI |
| | | TSVIKRSGVNNTSYHGYWARDFKQTNDAFGDFADFQNLIDT |
| | | AHAHNIKVVIDFAPNHTSPADRDNPGFAENGGMYDNGSLL |
| | | GAYSNDTAGLFHHNGGTDFSTIEDGIYKNLYDLADINHNNN |
| | | AMDAYFKSAIDLWLGMGVDGIRFDAVKHMPFGWQKSFVSS |
| | | IYGGDHPVFTFGEWYLGADQTDGDNIKFANESGMNLLDFE |
| | | YAQEVREVFRDKTETMKDLYEVLASTESQYDYINNMVTFID |
| | | NHDMDRFQVAGSGTRATEQALALTLTSRGVPAIYYGTEQY |
| | | MTGDGDPNNRAMMTSFNTGTTAYKVIQALAPLRKSNPAIAY |
| | | GTTTERWVNNDVLIIERKFGSSAALVAINRNSSAAYPISGLLS |
| | | SLPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| D372K Y89R | 47 | DRSNLKLYFGGDWQGIIDKINDGYLTGMGVTALWISQPVENI |
| | | TSVIKRSGVNNTSYHGYWARDFKQTNDAFGDFADFQNLIDT |
| | | AHAHNIKVVIDFAPNHTSPADRDNPGFAENGGMYDNGSLL |
| | | GAYSNDTAGLFHHNGGTDFSTIEDGIYKNLYDLADINHNNN |
| | | AMDAYFKSAIDLWLGMGVDGIRFDAVKHMPFGWQKSFVSS |
| | | IYGGDHPVFTFGEWYLGADQTDGDNIKFANESGMNLLDFE |
| | | YAQEVREVFRDKTETMKDLYEVLASTESQYDYINNMVTFID |
| | | NHDMDRFQVAGSGTRATEQALALTLTSRGVPAIYYGTEQY |
| | | MTGDGKPNNRAMMTSFNTGTTAYKVIQALAPLRKSNPAIAY |
| | | GTTTERWVNNDVLIIERKFGSSAALVAINRNSSAAYPISGLLS |
| | | SLPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 25. In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 26 or 27.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27, and an amino acid substitution at amino acid position 31 relative to SEQ ID NO: 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27, and the amino acid substitution A31R relative to SEQ ID NO: 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27, and the amino acid substitution A31P relative to SEQ ID NO: 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27, and the amino acid substitution A31T relative to SEQ ID NO: 27.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and an amino acid substitution at amino acid position 146 relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and the amino acid substitution R146A relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and the amino acid substitution R146P relative to SEQ ID NO: 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and an amino acid substitution at amino acid position 147 relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and the amino acid substitution D147P relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and the amino acid substitution D147A relative to SEQ ID NO: 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, an amino acid substitution at amino acid position 146 relative to SEQ ID NO: 34, and an amino acid substitution at amino acid position 147 relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, the amino acid substitution R146A relative to SEQ ID NO: 34, and the amino acid substitution D147P relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, the amino acid substitution R146P relative to SEQ ID NO: 34, and the amino acid substitution D147A relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, the amino acid substitution R146P relative to SEQ ID NO: 34, and the amino acid substitution D147P relative to SEQ ID NO: 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, and an amino acid substitution at amino acid position 372 relative to SEQ ID NOS: 32 or 34. In some cases, the variant cyclodextrin glucanotransferase comprises or consists of an amino acid sequence having at least about 70% sequence (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, and the amino acid substitution D372K relative to SEQ ID NOS: 32 or 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, and an amino acid substitution at amino acid position 89 relative to SEQ ID NOS: 32 or 34. In some cases, the variant cyclodextrin glucanotransferase comprises or consists of an amino acid sequence having at least about 70% sequence (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, and the amino acid substitution Y89R relative to SEQ ID NOS: 32 or 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, an amino acid substitution at amino acid position 372 relative to SEQ ID NOS: 32 or 34, and an amino acid substitution at amino acid position 89 relative to SEQ ID NOS: 32 or 34. In some cases, the variant cyclodextrin glucanotransferase comprises or consists of an amino acid sequence having at least about 70% sequence (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, the amino acid substitution D372K relative to SEQ ID NOS: 32 or 34, and the amino acid substitution Y89R relative to SEQ ID NOS: 32 or 34.

In some embodiments, the cyclodextrin glucanotransferase is derived from a microbial cell. In some cases, the cyclodextrin glucanotransferase is isolated and/or purified from a microbial cell. In some cases, the microbial cell is a bacterial cell. In some cases, the bacterial cell is Escherichia coli. In some embodiments, the cyclodextrin glucanotransferase is derived from Bacillus sp. (strain no. 38-2). In some embodiments, the cyclodextrin glucanotransferase is derived from B. circulans strain 251. In some embodiments, the cyclodextrin glucanotransferase may be produced within a microbial cell. In some embodiments, the cyclodextrin glucanotransferase is expressed in a recombinant host cell (e.g., from a recombinant polynucleotide). In some cases, the cyclodextrin glucanotransferase is recombinantly produced. In some cases, the cyclodextrin glucanotransferase is produced (e.g., recombinantly produced) in a yeast cell. In some cases, the yeast cell is a Pichia yeast cell, such as a Pichia pastoris cell.

In various aspects, the methods provided herein produce a higher ratio of beta-cyclodextrin to alpha-cyclodextrin, gamma-cyclodextrin, or both. For example, in some cases, the methods provided herein provide ratios of beta-cyclodextrin to alpha-cyclodextrin, gamma-cyclodextrin, or both, of at least 2:1, at least 3:1, at least 4:1, at least 5:1, at least 6:1, at least 7:1, at least 8:1, at least 9:1, at least 10:1, at least 20:1, at least 30:1, at least 40:1, at least 50:1, at least 60:1, at least 70:1, at least 80:1, at least 90:1, at least 100:1, or greater. In a preferred embodiment, the methods provided herein provide ratios of beta-cyclodextrin to alpha-cyclodextrin of at least 10:1. For example, the ratios may be at least 20:1, at least 30:1, at least 40:1, at least 50:1, at least 60:1, at least 70:1, at least 80:1, at least 90:1, at least 100:1, or greater. In a preferred embodiment, the methods provided herein provide ratios of beta-cyclodextrin to gamma-cyclodextrin of at least 5:1. For example, the ratios may be at least 10:1, at least 20:1, at least 30:1, at least 40:1, at least 50:1, at least 60:1, at least 70:1, at least 80:1, at least 90:1, at least 100:1, or greater. In a preferred embodiment, the methods provided herein provide ratios of beta-cyclodextrin to both alpha- and gamma-cyclodextrin of at least 3.5:1. For example, the ratios may be at least 5:1, at least 10:1, at least 20:1, at least 30:1, at least 40:1, at least 50:1, at least 60:1, at least 70:1, at least 80:1, at least 90:1, at least 100:1, or greater.

Methods are outlined throughout the disclosure for attaining robust enzyme activity in each step to obtain higher yields of beta-cyclodextrin than is currently achievable. In some embodiments, the first enzymatic step of converting sucrose to amylose (e.g., as described herein) is carried out for a first time period, thereby enabling catalytic conversion of sucrose to amylose, followed by the second enzymatic step of converting the amylose to beta-cyclodextrin (e.g., as described herein), which is carried out for a second time period, thereby enabling catalytic conversion of amylose to beta-cyclodextrin. In some embodiments, the first enzymatic reaction (e.g., converting sucrose to amylose, e.g., as described herein) and the second enzymatic reaction (e.g., converting amylose to beta-cyclodextrin, e.g., as described herein) are carried out in the same reservoir (e.g., one-pot synthesis method).

In some embodiments, the first time period is at least 30 minutes, at least 45 minutes, at least 60 minutes, at least 85 minutes, at least 90 minutes, at least 105 minutes, at least 120 minutes, at least 135 minutes, at least 150 minutes, at least 165 minutes, at least 180 minutes, at least 195 minutes, at least 210 minutes, at least 225 minutes, at least 240 minutes, at least 255 minutes, at least 270 minutes, at least 285 minutes, or at least 300 minutes. In some embodiments, the second time period is at least 30 minutes, at least 45 minutes, at least 60 minutes, at least 85 minutes, at least 90 minutes, at least 105 minutes, at least 120 minutes, at least 135 minutes, at least 150 minutes, at least 165 minutes, at least 180 minutes, at least 195 minutes, at least 210 minutes, at least 225 minutes, at least 240 minutes, at least 255 minutes, at least 270 minutes, at least 285 minutes, or at least 300 minutes. In some embodiments, the first time period is shorter than the second time period. In some embodiments, the first time period is longer than the second time period. In some embodiments, the first time period is the same or substantially the same length as the second time period. In some embodiments, sucrose is added to the reaction reservoir in batches. In some embodiments, the enzymes used in the first enzymatic reaction step (e.g., to convert sucrose to amylose, e.g., as described herein) are added once at the beginning of the reaction period and then again after a period of time has elapsed to expedite the catalytic activity. In some embodiments, sucrose is added once at the beginning of the reaction period and then again after a period of time has elapsed to replenish the sucrose. In some embodiments, the enzymes involved in the first enzymatic reaction step (e.g., to convert sucrose to amylose, e.g., as described herein) are added at the same time as the enzymes involved in the second enzymatic reaction step (e.g., to convert amylose to beta-cyclodextrin) in the same reaction reservoir. In some embodiments, the enzymes involved in the first enzymatic reaction step (e.g., to convert sucrose to amylose, e.g., as described herein) are added at a different time than (e.g., before) the enzymes involved in the second enzymatic reaction step (e.g., to convert amylose to beta-cyclodextrin).

In some embodiments, the sucrose concentration is maximized for highly efficient conversion to amylose. In some embodiments, the starting concentration of sucrose in the reaction is at least about 50 g/L. In some embodiments, the starting concentration of sucrose in the reaction is at least about 100 g/L. In some embodiments, the starting concentration of sucrose in the reaction is at least about 150 g/L. In some embodiments, the starting concentration of sucrose in the reaction is at least about 200 g/L. In some embodiments, the starting concentration of sucrose in the reaction is at least about 250 g/L. In some embodiments, the starting concentration of sucrose in the reaction is at least about 300 g/L. In some embodiments, the starting concentration of sucrose in the reaction is at least about 350 g/L.

In some embodiments, the reaction time is an important consideration for obtaining maximum yield of beta-cyclodextrin. In some embodiments, production of beta-cyclodextrin may be accompanied by breakdown of the product to glucose, maltose, and other sugars. It is therefore important to obtain beta-cyclodextrin without allowing its breakdown. In some embodiments, the total (e.g., method step (a) and method step (b)) reaction is carried out for no more than 12 hours. In some embodiments, the total (e.g., method step (a) and method step (b)) reaction is carried out for no more than 8 hours. In some embodiments, the total reaction is carried out for no more than 7 hours. In some embodiments, the total reaction is carried out for no more than 6 hours. In some embodiments, the total reaction is carried out for no more than 5 hours. In some embodiments, the total reaction is carried out for no more than 4 hours. In some embodiments, the total reaction is carried out for no more than 3 hours. In some embodiments, the total reaction is carried out for no more than 2 hours. In some embodiments, the total reaction is carried out for no more than 1 hour.

Temperature is an important consideration for maximizing the yield of beta-cyclodextrin. In some embodiments, one or more of the enzymatic reactions is carried out at from about 30° C. to about 55° C., such as from about 40° C. to about 50° C. In some embodiments, one or more of the enzymatic reactions is carried out at about 40° C. In some embodiments, one or more of the enzymatic reactions is carried out at about 41° C. In some embodiments, one or more of the enzymatic reactions is carried out at about 42° C. In some embodiments, one or more of the enzymatic reactions is carried out at about 43° C. In some embodiments, one or more of the enzymatic reactions is carried out at about 44° C. In some embodiments, one or more of the enzymatic reactions is carried out at about 45° C. In some embodiments, one or more of the enzymatic reactions is carried out at about 46° C. In some embodiments, one or more of the enzymatic reactions is carried out at about 47° C. In some embodiments, one or more of the enzymatic reactions is carried out at about 48° C. In some embodiments, one or more of the enzymatic reactions is carried out at about 49° C. In some embodiments, one or more of the enzymatic reactions is carried out at about 50° C. Preferably, one or more of the reactions is carried out at about 45° C.

In some embodiments, the enzymatic reaction of step (a) is carried out at from about 40° C. to about 55° C., such as from about 45° C. to about 50° C. In some embodiments, the enzymatic reaction of step (b) is carried out at from about 40° C. to about 50° C. Step (a) and step (b) may be carried out at different temperatures, or preferably step (a) and step (b) are carried out at about the same temperature. Where step (a) involves the use of a single enzyme (e.g. amylosucrase), the enzymatic reaction of step (a) is preferably carried out at about 45° C. In this embodiment, the enzymatic reaction of step (b) is preferably also carried out at about 45° C. Where step (a) involves the use of at least two enzymes (e.g., sucrose phosphorylase and alpha-glucan phosphorylase), the enzymatic reaction of step (a) is preferably carried out at about 45° C. or at about 50° C. In this embodiment, the enzymatic reaction of step (b) is preferably also carried out at about 45° C. or at about 50° C. respectively.

In a one-pot synthesis, it is taken into consideration that the enzyme mixture(s) should be maximally functional even though the optimum temperature for each enzyme may be slightly different.

In some embodiments, the reaction is carried out in a reservoir having a reservoir volume of from about 1 mL to about 1,000,000 L. For example, the reaction may be carried out in a reservoir having a reservoir volume of from about 100 mL to about 10 L, such as a reservoir volume of about 500 mL or about 10 L.

In some embodiments, the total reaction volume is from about 1 mL to about 1,000,000 L. For example, the total reaction volume may be from about 100 mL to about 10 L, such as a total reaction volume of about 500 mL or about 5 L. In some embodiments, the total reaction volume is less than the reservoir volume. For example, a total reaction volume of about 5 L may be used in a reaction carried out in a reservoir having a reservoir volume of about 10 L.

In some embodiments, the reaction is carried out in a stirred tank reactor (STR), a loop reactor, a plug flow reactor, a single or multi-stage continuous stirred tank reactor, or any other suitable reactor known in the art. In some embodiments, the reaction is carried out in a stirred tank reactor, wherein the reaction is stirred at from about 100 to about 200 rpm, such as about 160 rpm.

The pH of the reaction mixture may be an important consideration for maximizing the yield of beta-cyclodextrin. In some embodiments, one or more of the enzymatic reactions is carried out at a pH of from about 6 to about 8, for example the pH may be from about 6.5 to about 7.5. In a preferred embodiment, one or more of the enzymatic reactions is carried out at a pH of from about 7.0 to about 7.5. Preferably, step (a) is carried out at a pH of from about 7.0 to about 7.5. Preferably, step (b) is carried out at a pH of from about 7.0 to about 7.5. Step (a) and step (b) may be carried out at different pH, but preferably step (a) and step (b) are carried out at the same pH.

In some embodiments, one or more of the enzymatic reactions is carried out in a reaction mixture comprising a buffer. Any suitable buffer known in the art may be used. For example, the buffer may be selected from the group consisting of sodium citrate, disodium hydrogen phosphate, and Tris-HCl. The buffer may be present in the reaction mixture at a concentration of from about 50 mM to about 200 mM, for example at about 100 mM.

In some embodiments, one or more of the enzymatic reactions is carried out in a reaction mixture comprising an organic solvent, preferably toluene. The reaction mixture preferably also comprises water. Without wishing to be bound by any theory set out herein, the inventors have identified that addition of the organic solvent surprisingly increases the yield of the beta-cyclodextrin obtained from the enzymatic reactions. For example, the addition of the organic solvent may increase the yield of the beta-cyclodextrin by at least about 5%, for example by at least about 10%, for example by at least about 15%, for example by at least about 20%, for example by at least about 50%, for example by at least about 100%, for example by at least about 150%, for example by at least about 200%, for example by at least about 250%, for example by at least about 300%, for example by at least about 350%, for example by at least about 400% compared to the yield obtained from the enzymatic reactions carried out without the organic solvent. It is believed that the addition of the organic solvent increases the yield of the beta-cyclodextrin by decreasing the solubility of the beta-cyclodextrin in the reaction mixture, thereby causing the beta-cyclodextrin to precipitate, which reduces the concentration of beta-cyclodextrin in the reaction mixture. This prevents breakdown of the beta-cyclodextrin by the enzymes.

In some embodiments, the amount of the organic solvent (preferably toluene) in the reaction mixture is from about 0.1% to about 40% v/v of the reaction mixture, such as from about 1% to about 35% v/v, such as from about 5% to about 25% v/v.

In some embodiments, the organic solvent is introduced at the start, or during, the enzymatic reaction of step (a). In some preferred embodiments, the organic solvent is introduced at the start, or during, the enzymatic reaction of step (b). For example, in embodiments where the total (e.g., method step (a) and method step (b)) reaction is carried out for no more than 8 hours, the organic solvent may be introduced about 1 hour after the start of enzymatic reaction (b).

In some embodiments, the enzyme used in step (a) is amylosucrase. In some embodiments, the starting concentration of amylosucrase in the reaction mixture is from about 1 to about 30 U/mL, for example from about 5 to about 25 U/mL, for example from about 8 to about 25 U/mL.

In some embodiments, the enzyme mixture used in step (a) comprises sucrose phosphorylase and alpha-glucan phosphorylase. In some embodiments, the starting concentration of sucrose phosphorylase in the reaction mixture is from about 1 to about 30 U/mL, for example from about 5 to about 25 U/mL, for example from about 8 to about 25 U/mL. In some embodiments, the starting concentration of alpha-glucan phosphorylase in the reaction mixture is from about 1 to about 30 U/mL, for example from about 5 to about 25 U/mL, for example from about 8 to about 25 U/mL.

In some embodiments, the enzymes are provided in whole cell lysate, preferably wherein the ratio of the starting concentration (measured as volume of whole cell lysate) of enzymes in step (b) to the enzymes in step (a) is from about 1:1 to about 50:1, such as from about 2:1 to about 50:1, such as from about 5:1 to about 40:1, such as from about 10:1 to about 30:1. In a preferred embodiment, the ratio is about 20:1.

In certain embodiments, any one of the enzymatic reactions provided herein (e.g., the first enzymatic reaction to convert sucrose to amylose and/or the second enzymatic reaction to convert amylose to beta-cyclodextrin) may take place within a microbial host cell. In some cases, the microbial cell is a bacterial cell. In some cases, the bacterial cell is Escherichia coli. For example, the microbial host cell may comprise one or more heterologous nucleic acid molecules that encode for one or more the enzymes provided herein. The microbial host cell may express one or more of the enzymes provided herein. In some cases, the microbial host cell can be fed sucrose and/or one or more intermediates of the enzymatic reaction. For example, sucrose may be fed to the microbial host cell, and the conversion of sucrose to beta-cyclodextrin may occur within the microbial host cell.

In some embodiments, one or more of the enzymes used in the enzymatic reactions provided herein may be immobilized on a resin. For example, the enzymes may be covalently linked to a resin. Alternatively, the enzymes may be non-covalently linked to the resin. For example, the enzymes may be linked to a Ni-resin via a His-tag. For example, the enzyme of (a) may be a variant amylosucrase (for example wherein the variant amylosucrase may comprise or consist of an amino acid sequence according to SEQ ID NO: 3) and the enzyme may be immobilized on a resin. Alternatively, or additionally, the enzyme of (b) may be a variant cyclodextrin glucanotransferase (for example wherein the variant cyclodextrin glucanotransferase may comprise or consist of an amino acid sequence according to SEQ ID NO: 28) and the enzyme may be immobilized on a resin. Optionally, the enzyme or enzyme mixture of (a) and the enzyme of (b) are immobilized on the same resin.

The immobilized resin enzymes may be re-used in the methods described herein. However, the present inventors have found that the beta-cyclodextrin yield tends to decrease when the immobilized resin enzymes are re-used, which is believed to be due to the enzyme leaching from the resin during use which results in a lower enzymatic conversion. It would therefore be desirable to improve the enzyme stability on the resin and hence prevent enzyme leaching, because this would allow the immobilized resin enzymes to be re-used more often and/or with a higher rate of enzymatic conversion, thereby increasing the yield of the reaction.

The present inventors have found that enzyme stability may be improved by using freeze-dried enzymes, by spray drying the enzymes, and/or by introducing additives.

In some embodiments, the enzymes are provided in a cell slurry or in whole cell lysate. For example, a cell slurry comprising recombinant cells expressing the enzymes may be suspended in buffer (such as sodium citrate buffer), lysed, and centrifuged to provide a whole cell lysate comprising the enzymes. Methods of cell lysis are known in the art. For example, the cells may be lysed by homogenization, chemical lysis, sonication, freeze/thaw, lytic enzymes, acidic lysis, and/or alkaline lysis. In a preferred embodiment, the cells are lysed by homogenization.

In some embodiments, the cell slurry or whole cell lysate further comprises an additive. In some embodiments, the additive is selected from the group consisting of PEG, maltose, sorbitol, sucrose, glucose, mannitol, lactose, milk powder, starch, and combinations thereof. In some embodiments, the additive is added in an amount of from about 0.1% w/v to about 10% w/v of the cell slurry or whole cell lysate, for example from about 0.5% w/v to about 5% w/v. For example, the additive may be added at 0.5% w/v, 1.0% w/v, or 5% w/v of the cell slurry or whole cell lysate. In a preferred embodiment, the additive is mannitol, sorbitol, sucrose, or a combination thereof.

In some embodiments, the cell slurry or cell lysate may be freeze-dried. For example, cell slurry or cell lysate may be freeze-dried over 2 days. Methods of freeze-drying are known in the art.

The inventors have found that the addition of an additive to the cell slurry or whole cell lysate (as described above) increases the enzyme stability compared to a cell slurry or whole cell lysate which does not contain an additive, and that freeze-drying the cell slurry or whole cell lysate (as described above) increases the enzyme stability compared to a cell slurry or whole cell lysate which has not been freeze-dried. The cell slurry or cell lysate may be resuspended and shaken to redissolve prior to use in the methods described herein.

In some embodiments, the methods described herein produce a composition comprising at least 18 g/L of beta-cyclodextrin. In some embodiments, the methods produce a composition comprising at least 25 g/L of beta-cyclodextrin, at least 30 g/L of beta-cyclodextrin, at least 40 g/L of beta-cyclodextrin, at least 50 g/L beta-cyclodextrin, or at least 60 g/L beta-cyclodextrin. In a preferred embodiment, the methods described herein produce a composition comprising at least 50 g/L of beta-cyclodextrin.

In some embodiments, the percentage yield of beta-cyclodextrin is at least about 10%, for example at least about 20%, for example at least about 30%, for example at least about 40%, or for example at least about 50%, for example at least about 60%, wherein the percentage yield is calculated by dividing the total amount of beta-cyclodextrin produced in the methods described herein by the maximum theoretical amount of beta-cyclodextrin which could be produced from the starting sucrose reagent.

Also provided herein are compositions comprising cyclodextrin, wherein the cyclodextrin comprises beta-cyclodextrin and may optionally further comprise alpha-cyclodextrin, gamma-cyclodextrin, or any combination thereof, and wherein the composition comprising cyclodextrin comprises beta-cyclodextrin in an amount and/or concentration greater than alpha-cyclodextrin, gamma-cyclodextrin, or both. Preferably, the compositions are obtained from the methods provided herein. In some cases, the composition does not comprise alpha-cyclodextrin and/or gamma-cyclodextrin. Preferably, the composition comprises ratios of beta-cyclodextrin to alpha-cyclodextrin, ratios of beta-cyclodextrin to gamma-cyclodextrin, or both ratios of beta-cyclodextrin and ratios of beta-cyclodextrin to alpha-cyclodextrin, of at least 2:1, at least 3:1, at least 4:1, at least 5:1, at least 6:1, at least 7:1, at least 8:1, at least 9:1, at least 10:1, at least 20:1, at least 30:1, at least 40:1, at least 50:1, at least 60:1, at least 70:1, at least 80:1, at least 90:1, at least 100:1, or greater. Preferably, the composition comprises ratios of beta-cyclodextrin to alpha-cyclodextrin, ratios of beta-cyclodextrin to gamma-cyclodextrin, or both ratios of beta-cyclodextrin and ratios of beta-cyclodextrin to alpha-cyclodextrin, of at least 10:1, such as at least 20:1, at least 30:1, at least 40:1, at least 50:1, at least 60:1, at least 70:1, at least 80:1, at least 90:1, at least 100:1, or greater.

In a preferred embodiment, the present invention provides a method of producing a composition comprising cyclodextrin, the method comprising: (a) contacting sucrose with an enzyme or an enzyme mixture capable of converting sucrose to amylose under conditions that permit the conversion of the sucrose to amylose, thereby producing amylose; (b) contacting the amylose produced in (a) with cyclodextrin glucanotransferase, thereby producing the composition comprising cyclodextrin, wherein the cyclodextrin glucanotransferase in (b) is a variant enzyme capable of producing a greater amount and/or concentration of beta-cyclodextrin than alpha-cyclodextrin, gamma-cyclodextrin, or both, relative to a wild-type enzyme capable of converting amylose to cyclodextrin, wherein the composition comprising cyclodextrin comprises beta-cyclodextrin, and may optionally further comprise alpha-cyclodextrin, gamma-cyclodextrin, or any combination thereof, and preferably wherein the ratio of beta-cyclodextrin to alpha-cyclodextrin, gamma-cyclodextrin, or both in the composition is at least 10:1, wherein steps (a) and (b) are carried out simultaneously, wherein steps (a) and (b) are carried out at from about 45° C. to about 55° C., wherein steps (a) and (b) are carried out at a pH of from about 7.0 to about 7.5, wherein steps and (b) are carried out in a reaction mixture comprising water and an organic solvent (preferably toluene), and wherein the total reaction is carried out for no more than 8 hours.

Also provided herein is beta-cyclodextrin. Preferably, the beta-cyclodextrin is obtained from the methods provided herein.

Also provided herein is the use of sucrose as a starting material for the manufacture of beta-cyclodextrin. Also provided herein is the use of sucrose in a method for producing beta-cyclodextrin, wherein the method does not use starch.

Also provided herein is the use of any one of the enzymes, or enzyme mixtures, capable of converting sucrose to amylose described herein for converting sucrose into amylose.

Also provided herein is the use of any one of the variant enzymes capable of converting amylose to cyclodextrin described herein for converting amylose to cyclodextrin and/or for producing a greater amount and/or concentration of beta-cyclodextrin than alpha-cyclodextrin, gamma-cyclodextrin, or both.

Also provided herein is the use of any one of the enzymes, or enzyme mixtures, described herein for the manufacture of beta-cyclodextrin, wherein the manufacture does not require starch as a starting material.

Also provided herein is any one of the enzymes, or enzyme mixtures, described herein. For example, provided herein is an enzyme comprising or consisting of an amino acid sequence of any one of SEQ ID NOs: 1-48. Also provided herein is an enzyme comprising or consisting of an amino acid sequence having at least about 70% sequence identity, preferably at least about 90% sequence identity, to the amino acid sequence of any one of SEQ ID NOs: 1-48.

Preferably, the enzyme is a variant amylosucrase enzyme comprising or consisting of an amino acid sequence of any one of SEQ ID NOs: 3-16 or 48. Also provided herein is an enzyme comprising or consisting of an amino acid sequence having at least about 70% sequence identity, preferably at least about 90% sequence identity, to the amino acid sequence of any one of SEQ ID NOs: 3-16 or 48.

Preferably the enzyme is a variant sucrose phosphorylase enzyme comprising or consisting of an amino acid sequence of SEQ ID NO: 20. Also provided herein is an enzyme comprising or consisting of an amino acid sequence having at least about 70% sequence identity, preferably at least about 90% sequence identity, to the amino acid sequence of SEQ ID NO: 20.

Preferably the enzyme is a variant alpha-glucan phosphorylase enzyme comprising or consisting of an amino acid sequence of SEQ ID NO: 24. Also provided herein is an enzyme comprising or consisting of an amino acid sequence having at least about 70% sequence identity, preferably at least about 90% sequence identity, to the amino acid sequence of SEQ ID NO: 24.

Preferably the enzyme is a variant cyclodextrin glucanotransferase enzyme comprising or consisting of an amino acid sequence of any one of SEQ ID NOs: 28-30 or 35-47. Also provided herein is an enzyme comprising or consisting of an amino acid sequence having at least about 70% sequence identity, preferably at least about 90% sequence identity, to the amino acid sequence of any one of SEQ ID NOs: 28-30 or 35-47.

Also provided herein is an enzyme composition comprising one or more of the enzymes described herein.

Also provided herein is a gene encoding any one of the variant enzymes described herein. Also provided herein is a vector encoding any one of the variant enzymes described herein.

Also provided herein is a recombinant host cell comprising any one of the genes, vectors or enzymes described herein.

Also provided herein is the use of an organic solvent, preferably toluene, for increasing the yield of beta-cyclodextrin obtained in a method for producing beta-cyclodextrin, such as the beta-cyclodextrin obtained from any one of the methods described herein.

### Purification Methods

Also provided herein is a method of purifying beta-cyclodextrin, the method comprising the steps of:
i. providing a crude composition comprising beta-cyclodextrin;
ii. obtaining a first precipitate comprising beta-cyclodextrin from the crude composition, for example by: filtering the crude composition, subjecting the crude composition to centrifugation, subjecting the crude composition to a settling operation, and/or washing with water;
iii. dissolving the first precipitate to obtain a first solution comprising beta-cyclodextrin, for example by dissolving the first precipitate in water;
iv. filtering the first solution to obtain a second solution comprising beta-cyclodextrin; and
V. crystallizing and/or precipitating the second solution to obtain a purified beta-cyclodextrin composition.

### Steps (ii) and/or (iv)

The filtration step (iv) may remove insoluble material.

In some embodiments, steps (ii) and/or (iv) comprise washing the material obtained by filtration, for example with water or alkaline water.

In some embodiments, step (iv) comprises filtration through a filter aid. In some embodiments, the filter aid comprises silicon dioxide. One example of a suitable filter aid is 1% Celite®, which is commercially available from Sigma-Aldrich. The use of a filter aid may be advantageous in order to reduce the overall filtration time of step (iv).

The filtration step (iv) may be conducted at a temperature from about 4° C. to about 25° C.

### Dissolution Step (iii)

In some embodiments, step (iii) comprises dissolving the first precipitate in an alkaline solution. The precipitate may be dissolved in NaOH, for example in 1M NaOH, for example by adding multiple (e.g., five) volumes of 1M NaOH.

In some embodiments, step (iii) may comprise heating the solution until the beta-cyclodextrin dissolves. For example, this may require heating the solution to about 60° C. or more, for example to about 65° C. or more, for example to about 70° C. or more, for example to about 75° C. or more. The temperature of the solution may then be lowered, for example lowered by about 5° C. or more, prior to the subsequent steps.

### Crystallization Step (v)

Step (v) may comprise neutralizing the second solution, optionally wherein the neutralization comprises the addition of HCl. For example, the neutralization may comprise the addition of 6M HCl.

Step (v) may comprise seeding the second solution with crystalline beta-cyclodextrin.

In some embodiments, step (v) may further comprise heating the solution until the beta-cyclodextrin dissolves. For example, this may require heating the solution to about 60° C. or more, for example to about 65° C. or more, for example to about 70° C. or more, for example to about 75° C. or more. In a preferred embodiment, the solution is heated to about 75° C. The temperature of the solution may then be lowered, for example lowered by about 5° C. or more, before seeding with crystalline beta-cyclodextrin. In a preferred embodiment, the solution is heated to about 75° C. and then lowered to about 70° C. prior to seeding.

In some embodiments, step (v) may comprise cooling the solution to below room temperature after seeding, for example to about 20° C. or less, about 15° C. or less, about 10° C. or less, or about 5° C. or less. In a preferred embodiment, the solution is cooled to about 4° C. In some embodiments, the solution is cooled over about 1 to about 12 hours. In some embodiments, the solution is cooled over about 1 hour, about 2 hours, about 3 hours, about 4 hours, about 5 hours, about 6 hours, about 7 hours, about 8 hours, about 9 hours, about 10 hours, about 11 hours, or about 12 hours. In a preferred embodiment, the solution is cooled to about 4° C. over about 4 hours.

The seeded solution may be maintained under conditions suitable for beta-cyclodextrin crystal formation. For example, the solution may be maintained below room temperature, for example at about 20° C. or less, about 15° C. or less, about 10° C. or less, or about 5° C. about. In a preferred embodiment, the solution is maintained at about 4° C. In some embodiments, the solution is maintained below room temperature for at least about 1 hour, at least about 2 hours, at least about 3 hours, at least about 4 hours, at least about 5 hours, at least about 6 hours, at least 7 about hours, at least about 8 hours, at least about 9 hours, at least about 10 hours, at least about 11 hours, or at least about 12 hours. Preferably, the solution is maintained for 12 or more hours at about 4° C.

The crystallization step (v) may comprise a filtration step. The filtration step may comprise vacuum filtration.

In some embodiments, step (v) further comprises washing the composition with water.

In some embodiments, step (v) further comprises drying the composition, optionally wherein the composition is dried (e.g. in a vacuum oven) at about 45° C.

### Precipitation Step (v)

Step (v) may comprise neutralizing the second solution, optionally wherein the neutralization comprises the addition of HCl. For example, the neutralization may comprise the addition of about 6M HCl.

Step (v) may comprise the addition of an anti-solvent. An anti-solvent may increase the yield of purified beta-cyclodextrin in the composition obtained by the purification method. An anti-solvent is a solvent in which beta-cyclodextrin is poorly soluble, for example a solvent in which beta-cyclodextrin does not dissolve at about 50° C. and at about 60° C. The anti-solvent may be THF, AcN, EtOH, toluene, acetone, or a mixture of acetone and water (for example, a mixture of 10:90, or 20:80, or 30:70, or 40:60, or 50:50, or 60:40, or 70:30, or 80:20, or 90:10 acetone:water). In some embodiments, where the anti-solvent is a mixture of acetone and water, the mixture may be between 10-90%, between 20-80%, between 30-70%, between 40-60%, or about 50% acetone. Preferably, the anti-solvent used is a mixture of acetone and water, such as a mixture of 50% acetone and 50% water.

In some embodiments, step (v) may comprise cooling the solution to below room temperature after addition of anti-solvent, for example to about 20° C. or less, about 15° C. or less, about 10° C. or less, or about 5° C. or less. In a preferred embodiment, the solution is cooled to about 4° C. In some embodiments, the solution is cooled over about 1 to about 12 hours. In some embodiments, the solution is cooled over about 1 hour, about 2 hours, about 3 hours, about 4 hours, about 5 hours, about 6 hours, about 7 hours, about 8 hours, about 9 hours, about 10 hours, about 11 hours, or about 12 hours. In a preferred embodiment, the solution is cooled to about 4° C. over about 4 hours.

The solution may be maintained under conditions suitable for beta-cyclodextrin precipitate formation. For example, the solution may be maintained below room temperature, for example at about 20° C. or less, about 15° C. or less, about 10° C. or less, or about 5° C. about. In a preferred embodiment, the solution is maintained at about 4° C. In some embodiments, the solution is maintained below room temperature for at least about 1 hour, at least about 2 hours, at least about 3 hours, at least about 4 hours, at least about 5 hours, at least about 6 hours, at least 7 about hours, at least about 8 hours, at least about 9 hours, at least about 10 hours, at least about 11 hours, or at least about 12 hours. Preferably, the solution is maintained for 12 or more hours at about 4° C.

In some embodiments, the solution is cooled to about 4° C. over about 4 hours, and then held for about 12 hours at about 4° C.

The precipitation of step (v) may comprise a filtration step. The filtration step may comprise vacuum filtration.

In some embodiments, step (v) further comprises washing the composition with water.

In some embodiments, step (v) further comprises drying the composition, optionally wherein the composition is dried (e.g. in a vacuum) at about 45° C.

### Compositions

Preferably, the crude composition of step (i) is obtained via any one of the enzymatic methods described and claimed herein.

In some embodiments, the crude composition is cooled prior to step (ii). For example, the crude composition may be allowed to cool to room temperature for at least about 3 hours, and then cooled to about 4° C. for at least about 3 hours.

Also provided herein is a purified beta-cyclodextrin composition. The purified beta-cyclodextrin composition may be obtained from any one of the purification methods described and claimed herein. The beta-cyclodextrin in the composition may have a purity of 75 wt % or more, such as 80 wt % or more, such as 85 wt % or more, such as 90 wt % or more, or such as 95 wt % or more.

The purity of beta-cyclodextrin may be measured by 1H-NMR, and may provide the anhydrous amount of beta-cyclodextrin.

Preferably, the purified beta-cyclodextrin composition consists essentially of beta-cyclodextrin and optionally water, and preferably consists of beta-cyclodextrin and optionally water. The purified beta-cyclodextrin composition may comprise 2 wt % or less of toluene, such as no toluene. The purified beta-cyclodextrin composition may comprise 1 wt % or less of sucrose, fructose and/or amylose, such as no sucrose, fructose and/or amylose. The purified beta-cyclodextrin composition may comprise 5 wt % or less, preferably 1 wt % or less, of alpha and/or gamma-cyclodextrin, such as no alpha and/or gamma cyclodextrin.

The beta-cyclodextrin recovery from the purification methods described herein may be at least 50%, at least 60%, at least 70%, or at least 80%. In other words, the amount of beta-cyclodextrin in the purified composition may be at least 50% (or at least 60%, at least 70% or at least 80%) of the amount of beta-cyclodextrin in the crude composition. The amount of beta-cyclodextrin, and any other components, in the composition may be measured by 1H-NMR (in wt %) or by HLPC-ELSD (in g/L).

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.”

As used herein, the term “filtering” or “filtration” expressly include nanofiltering and nanofiltration.

As used herein the term “liquid pharmaceutical” comprises an active pharmaceutical ingredient. During the modular manufacturing process and/or system, the liquid pharmaceutical may additionally comprise one or more solvents, excipients, intermediates, reactants, precursors, catalysts, and/or impurities.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

### EMBODIMENTS

1. A modular system for producing a pharmaceutical composition comprising a plurality of modules, the plurality of modules comprising:
   one or more flow modules;
   one or more mixing modules;
   one or more heat exchange modules; and,
   one or more reactor modules;
   wherein each of the modules is operably connected to one or more other modules, and
   wherein at least two modules are operably connected to the one or more reactors.
2. The modular system of embodiment 1, the system further comprising a controller in communication with at least one or more of the plurality of modules.
3. The modular system of embodiment 2, wherein the controller is connected electrically or wirelessly to at least one or more of the plurality of modules.
4. The modular system of embodiment 2, wherein the controller is configured to automatically adjust system parameters selected from the group consisting of temperature, pressure, flow rate, heat transfer rate, solvent content, solvent amount, filtration, or a combination thereof.
5. The modular system of embodiment 2, wherein the controller is configured to be operated remotely.
6. The modular system of embodiment 1, wherein the one or more modules in the system are mutually interchangeable.
7. The modular system of embodiment 1, wherein a plurality of modules are configured to be cleaned-in-place simultaneously with a chemical cleaning agent.
8. The modular system of embodiment 7, wherein each module does not need to be cleaned independently.
9. The modular system of embodiment 1, further comprising a back pressure regulator.
10. The modular system of embodiment 1, wherein the system comprises substituted and/or unsubstituted cyclodextrins, beta-cyclodextrins, hydroxypropyl beta-cyclodextrins, and combinations thereof as a pharmaceutical composition output.
11. The modular system of embodiment 1, wherein the system comprises substituted and/or unsubstituted cyclodextrins, beta-cyclodextrins, hydroxypropyl beta-cyclodextrins, and combinations thereof as a plurality of pharmaceutical composition outputs.
12. The modular system of embodiment 11, wherein the system is configured to simultaneously produce a plurality of pharmaceutical composition outputs.
13. The modular system of embodiment 12, wherein the system is configured to simultaneously produce a plurality of pharmaceutical composition outputs that comprise a mixture of common molecules in different constituent amounts.
14. The modular system of embodiment 1, wherein the system is configured to maintain flow rates and heat transfer rates in the plurality of modules at predetermined level.
15. The modular system of embodiment 1, wherein the pharmaceutical composition is a liquid pharmaceutical, solid pharmaceutical, pharmaceutical formulation, or a combination thereof.
16. A modular system for producing a pharmaceutical composition comprising a plurality of modules, the plurality of modules comprising:
   a plurality of flow modules;
   a plurality of mixing modules;
   a plurality heat exchange modules; and,
   a plurality of reactor modules;
   wherein each of the modules is operably connected to one or more other modules to provide in-line manufacture of the pharmaceutical composition.
17. A modular system for producing a pharmaceutical composition comprising a plurality of cases, the plurality of cases comprising two or more modules selected from:
   one or more flow modules;
   one or more mixing modules;
   one or more heat exchange modules; and,
   one or more reactor modules;
   wherein the two or more modules are vertically stacked in each case.
18. A modular system for producing a pharmaceutical composition comprising a plurality of modules,
   wherein each of the modules is operably connected to one or more other modules, and
   wherein the modules are stackable.
19. A remote controlled factory comprising the modular system of any one of the preceding embodiments.

1. A modular system for producing a pharmaceutical composition comprising a plurality of modules, the plurality of modules comprising:
one or more flow modules;
one or more mixing modules;
one or more heat exchange modules; and,
one or more reactor modules;
wherein each of the modules is operably connected to one or more other modules, and
wherein at least two modules are operably connected to the one or more reactors.

2. The modular system of claim 1, the system further comprising a controller in communication with at least one or more of the plurality of modules.

3. The modular system of claim 2, wherein the controller is connected electrically or wirelessly to at least one or more of the plurality of modules.

4. The modular system of claim 2, wherein the controller is configured to automatically adjust system parameters selected from the group consisting of temperature, pressure, flow rate, heat transfer rate, solvent content, solvent amount, filtration, or a combination thereof.

5. The modular system of claim 2, wherein the controller is configured to be operated remotely.

6. The modular system of claim 1, wherein the one or more modules in the system are mutually interchangeable.

7. The modular system of claim 1, wherein a plurality of modules are configured to be cleaned-in-place simultaneously with a chemical cleaning agent.

8. The modular system of claim 7, wherein each module does not need to be cleaned independently.

9. The modular system of claim 1, further comprising a back pressure regulator.

10. The modular system of claim 1, wherein the system comprises substituted and/or unsubstituted cyclodextrins, beta-cyclodextrins, hydroxypropyl beta-cyclodextrins, and combinations thereof as a pharmaceutical composition output.

11. The modular system of claim 1, wherein the system comprises substituted and/or unsubstituted cyclodextrins, beta-cyclodextrins, hydroxypropyl beta-cyclodextrins, and combinations thereof as a plurality of pharmaceutical composition outputs.

12. The modular system of claim 1, wherein the system is configured to simultaneously produce a plurality of pharmaceutical composition outputs.

13. The modular system of claim 12, wherein the system is configured to simultaneously produce a plurality of pharmaceutical composition outputs that comprise a mixture of common molecules in different constituent amounts.

14. The modular system of claim 1, wherein the system is configured to maintain flow rates and heat transfer rates in the plurality of modules at predetermined level.

15. The modular system of claim 1, wherein the pharmaceutical composition is a liquid pharmaceutical, solid pharmaceutical, pharmaceutical formulation, or a combination thereof.

16. A modular system for producing a pharmaceutical composition comprising a plurality of modules, the plurality of modules comprising:
a plurality of flow modules;
a plurality of mixing modules;
a plurality heat exchange modules; and,
a plurality of reactor modules;
wherein each of the modules is operably connected to one or more other modules to provide in-line manufacture of the pharmaceutical composition.

17. A modular system for producing a pharmaceutical composition comprising a plurality of cases, the plurality of cases comprising two or more modules selected from:
one or more flow modules;
one or more mixing modules;
one or more heat exchange modules; and,
one or more reactor modules;
wherein the two or more modules are vertically stacked in each case.

18. A modular system for producing a pharmaceutical composition comprising a plurality of modules,
wherein each of the modules is operably connected to one or more other modules, and
wherein the modules are stackable.

19. A remote controlled factory comprising the modular system of claim 1.


SEQUENCE LISTING (48 sequences)

SEQ ID NO: 1 - protein, 644 aa, Cellulomonas carbonis
  source 1..644: note = Cellulomonas carbonis T26
MRVSEPLHPSVTAAVAAARDPRTSAEHWAAIEARVAREWPRLERLFLEVYGEGERTRSELAALAHQLVVSAQERPADLRAVDVAREADPAWFTSHRMLGGVCYVDRYAGDLEGLRRHIPYLRELGLTYLHLMPLFEAPAENSDGGYAVSSYRRVNPALGTMEQLTALAAELRENGISLVLDFIFNHTSDEHEWARRALAGEREYEDYYWVFPDREMPDAYERTVREIFPDDHPGSFVPMPDSPDGSRTGRWIWATFHSFQWDLNYANPAVFRAMAGEMLFLANKGVDVLRMDAVAFIWKQLGTACESLPQAHLLIQAFNAALRIAAPGVLFKSEAIVHPDEVVQYISPDECQISYNPLQMALIWSSLATREANLLQQALERRHALPPGTAWVNYVRSHDDIGWTFADEDAAELGIDGFQHRRFLNAFYVDRFPGSFARGVPFQDNPRTGDCRISGTTASLAGLEARDPGAVDRILLAHSIVLSTGGIPLLYLGDEVGQLNDYSYRDQPGLAEDSRWVNRPWYPAQAYANRLVPSTAAGRVFRGLRHLLEVRRRTPELAGGTLVPFDAHNRHVVGYQRPGELDGVPTTVLCLASFADEPQAVEPLTLSGMPAEAEDLLTGATVDLRAGLVLRPHGFVWLRVRHAA

SEQ ID NO: 2 - protein, 636 aa, Neisseria polysaccharea
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLREIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 3 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLQEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 4 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLGEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 5 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLAEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 6 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLSEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 7 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLMEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 8 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLCEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 9 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLKEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 10 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLIEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 11 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLDEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 12 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLYEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 13 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLWEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 14 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLEEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 15 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLLEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 16 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLHEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 17 - protein, 508 aa, Bifidobacterium longum
MKNKVQLITYADRLGDGTLSSMADILRTRFDGVYDGVHILPFFTPFDGADAGFDPIDHTKVDERLGSWDDVAELSKTHNIMVDAIVNHMSWESKQFQDVLEKGEESEYYPMFLTMSSVFPNGATEEDLAGIYRPRPGLPFTHYKFAGKTRLVWVSFTPQQVDIDTDSDKGWEYLMSIFDQMAASHVSYIRLDAVGYGAKEAGTSCFMTPKTFKLISRLREEGVKRGLEILIEVHSYYKKQVEIASKVDRVYDFALPPLLLHSLFTGHVEPVAHWTEIRPNNAVTVLDTHDGIGVIDIGSDQLDRSLKGLVPDEDVDNLVNTIHANTHGESQAATGAAASNLDLYQVNSTYYSALGCNDQHYLAARAVQFFLPGVPQVYYVGALAGRNDMELLRRTNNGRDINRHYYSTAEIDENLERPVVKALNALAKFRNELPAFDGEFSYEVDGDTSITFRWTAADGTSTAALTFEPGRGLGTDNATPVASLAWSDAAGDHETRDLLANPPIADID

SEQ ID NO: 18 - protein, 490 aa, Leuconostoc mesenteroides
MEIQNKAMLITYADSLGKNLKDVHQVLKEDIGDAIGGVHLLPFFPSTGDRGFAPADYTRVDAAFGDWADVEALGEEYYLMFDFMINHISRESVMYQDFKKNHDDSKYKDFFIRWEKFWAKAGENRPTQADVDLIYKRKDKAPTQEITFDDGTTENLWNTFGEEQIDIDVNSAIAKEFIKTTLEDMVKHGANLIRLDAFAYAVKKVDTNDFFVEPEIWDTLNEVREILTPLKAEILPEIHEHYSIPKKINDHGYFTYDFALPMTTLYTLYSGKTNQLAKWLKMSPMKQFTTLDTHDGIGVVDARDILTDDEIDYASEQLYKVGANVKKTYSSASYNNLDIYQINSTYYSALGNDDAAYLLSRVFQVFAPGIPQIYYVGLLAGENDIALLESTKEGRNINRHYYTREEVKSEVKRPVVANLLKLLSWRNESPAFDLAGSITVDTPTDTTIVVTRQDENGQNKAVLTADAANKTFEIVENGQTVMSSDNLTQN

SEQ ID NO: 19 - protein, 481 aa, Streptococcus mutans
MPIINKTMLITYADSLGKNLKELNENIENYFGDAVGGVHLLPFFPSTGDRGFAPIDYHEVDSAFGDWDDVKCLGEKYYLMFDFMINHISRQSKYYKDYQEKHEASAYKDLFLNWDKFWPKNRPTQEDVDLIYKRKDRAPKQEIQFADGSVEHLWNTFGEEQIDLDVTKEVTMDFIRSTIENLAANGCDLIRLDAFAYAVKKLDTNDFFVEPEIWTLLDKVRDIAAVSGAEILPEIHEHYTIQFKIADHDYYVYDFALPMVTLYSLYSSKVDRLAKWLKMSPMKQFTTLDTHDGIGVVDVKDILTDEEITYTSNELYKVGANVNRKYSTAEYNNLDIYQINSTYYSALGDDDQKYFLARLIQAFAPGIPQVYYVGFLAGKNDLELLESTKEGRNINRHYYSSEEIAKEVKRPVVKALLNLFTYRNQSAAFDLDGRIEVETPNEATIVIERQNKDGSHIAKAEINLQDMTYRVTENDQTISFE

SEQ ID NO: 20 - protein, 481 aa, synthetic construct
MPITNKTMLITYADSLGKNLKELNENIENYFGDAVGGVHLLPFFPSSGDRGFAPIDYHEVDPAFGDWDDVKRLGEKHYLMFDFMINHISRQSKYYKDYQEKHEASAYKDLFLNWDKFWPKNRPTQEDLDLIYKRKDRAPMQEIRFADGSVEHLWSTFGEEQIDLDVTKEVTMDFIRSTIENLAANGCDLIRLDAFAYAVKKLDTNDFFVEPEIWTLLDKVRDIAAVSGAEILPEIHEHYTIQFKIADHGYYVYDFALPMVTLYSLYSGKVDRLAKWLKMSPMKQFTTLDTHDGIGVVDVKDILTDEEITYTSNELYKVGANVNRKYSTAEYNNLDIYQINSTYYSALGDDDQKYFLARLIQAFAPGIPQVYYVGFLAGKNDLELLESTKEGRNINRHYYSSEEIAKEVKRPVVKALLNLFTYRNQSAAFDLDGRIEVETPNEATIVIERQNKDGSHIATAEINLQDMTYRVTENDQTISFE

SEQ ID NO: 21 - protein, 916 aa, Solanum tuberosum
TLSEKIHHPITEQGGESDLSSFAPDAASITSSIKYHAEFTPVFSPERFELPKAFFATAQSVRDSLLINWNATYDIYEKLNMKQAYYLSMEFLQGRALLNAIGNLELTGAFAEALKNLGHNLENVASQEPDAALGNGGLGRLASCFLDSLATLNYPAWGYGLRYKYGLFKQRITKDGQEEVAEDWLEIGSPWEVVRNDVSYPIKFYGKVSTGSDGKRYWIGGEDIKAVAYDVPIPGYKTRTTISLRLWSTQVPSADFDLSAFNAGEHTKACEAQANAEKICYILYPGDESEEGKILRLKQQYTLCSASLQDIISRFERRSGDRIKWEEFPEKVAVQMNDTHPTLCIPELMRILIDLKGLNWNEAWNITQRTVAYTNHTVLPEALEKWSYELMQKLLPRHVEIIEAIDEELVHEIVLKYGSMDLNKLEEKLTTMRILENFDLPSSVAELFIKPEISVDDDTETVEVHDKVEASDKVVTNDEDDTGKKTSVKIEAAAEKDIDKKTPVSPEPAVIPPKKVRMANLCVVGGHAVNGVAEIHSEIVKEEVFNDFYELWPEKFQNKTNGVTPRRWIRFCNPPLSAIITKWTGTEDWVLKTEKLAELQKFADNEDLQNEWREAKRSNKIKVVSFLKEKTGYSVVPDAMFDIQVKRIHEYKRQLLNIFGIVYRYKKMKEMTAAERKTNFVPRVCIFGGKAFATYVQAKRIVKFITDVGATINHDPEIGDLLKVVFVPDYNVSVAELLIPASDLSEHISTAGMEASGTSNMKFAMNGCIQIGTLDGANVEIREEVGEENFFLFGAQAHEIAGLRKERADGKFVPDERFEEVKEFVRSGAFGSYNYDDLIGSLEGNEGFGRADYFLVGKDFPSYIECQEKVDEAYRDQKRWTTMSILNTAGSYKFSSDRTIHEYAKDIWNIEAVEIA

SEQ ID NO: 22 - protein, 480 aa, unidentified
  source 1..480: note = organism is S. tokodaii
MRKHLKGKAHKKLHMIISITAELGIDFGENFAGGLGVLEGDKFYASARLGIDYTVFTLFYRKGYTGNEEKQKELLKNLVKEWETEIELKKGKIKIEYLTYKLNTAKAIFINILSPDWAKRLNEKLYIENSEEDRFYKYLVLAKATEKYISEKIGWDKIKYVDLQEAYPSFLPLLKYFPRYRIIIHTPAPWGHPTFPARYFKEEFGFEFPFDPVVMTEIGLSSAVQGIVVSKKMLHHVSKTFPHHMHKIKAITNAVEIPRWRHPLLNNVKDLDDFIKKKKEVKKESLKKLGKESDKPTIGWVRRITQYKRPEFILRLIDELRDDVVFIIGGKAHPYEYYGVELEKKFKEYAQKRNNVIYVQGVDIQQMKLAIWSSDIWTFTPYSGWEASGTSFMKAGVNGVPSVASRDGAVPEIIKDGYNGWLYGEDRYELLPVDTYDREYEEFARKVKEALNKYYEVGYNAYHTFSDFCSMDRLMKEYAL

SEQ ID NO: 23 - protein, 796 aa, unidentified
  source 1..796: note = organism is C. callunae
MSPEKQPLPAALVGSHVRAAAGTPADLATDRKFWTGLSRAVQERIADDWERTREAYGAARQQHYFSAEFLMGRALLNNLTNLGLVDEAAAATRELGHELTDILEIENDAALGNGGLGRLAACFLDSAVTQDYPVTGYGLLYRFGLFRQSFNEGFQVEKPDPWREEEYPFTIRRASDQLVVCFDDMKTRAIPYDMPITGYGTHNVGTLRLWKAEPWEEFDYDAFNSQRFTDAIIERERVSDICRVLYPNDTTYEGKKLRVRQQYFFTSASLQAMIQDHLAHHKDLSNFAEFHSVQLNDTHPVLAIPELMRLLMDEHDMGWEESWAIVSKTFAYTNHTVLTEALEQWDEQIFQQLFWRVWEIIAEIDRRFRLERAADGLDEETINRMAPIQHGTVHMAWIACYAAYSINGVAALHTEIIKAETLADWYALWPEKFNNKTNGVTPRRWLRMINPGLSDLLTRLSGSDDWVTDLDELKKLRSYADDKSVLEELRAIKAANKQDFAEWILERQGIEIDPESIFDVQIKRLHEYKRQLMNALYVLDLYFRIKEDGLTDIPARTVIFGAKAAPGYVRAKAIIKLINSIADLVNNDPEVSPLLKVVFVENYNVSPAEHILPASDVSEQISTAGKEASGTSNMKFMMNGALTLGTMDGANVEIVDSVGEENAYIFGARVEELPALRESYKPYELYETVPGLKRALDALDNGTLNDNNSGLFYDLKHSLIHGYGKDASDTYYVLGDFADYRETRDRMAADYASDPLGWARMAWINICESGRFSSDRTIRDYATEIWKLEPTPAVKK

SEQ ID NO: 24 - protein, 916 aa, synthetic construct
TLSEKIHHPITEQGGESDLSSFAPDAASITSSIKYHAELTPVFSPERFELPKAFFATAQSVRDSLLINWNATYDIYEKLNMKQAYYLSMEFLQGRALLNAIGNLELTGAFAEALKNLGHNLENVASQEPDAALGSGGLGRLASCFLDSLATLNYPAWGYGLRYKYGLFKQRITKDGQEEVAEDWLEIGSPWEVVRNDVSYPIKFYGKVSTGSDGKRYWIGGEDIKAVAYDVPIPGYKTRTTISLRLWSTQVPSADFDLSAFNAGEHTKACEAQANAEKICYILYPGDESEEGKILRLKQQYTLCSASLQDIISRFERRSGDRIKWEEFPEKVAVQMNDTHPTLCIPELMRILIDLKGLNWNEAWNITQRTVAYTNHTVLPEALEKWSYELMQKLLPRHVEIIEAIDEELVHEIVLKYGSMDLNKLEEKLTTMRILENFDLPSSVAELFIKPEISVDDDTETVEVHDKVEASDKVVTNDEDDTGKKTSVKIEAAAEKDIDKKTPVSPEPAVIPPKKVRMANLCVVGGHAVNGVAEIHSEIVKEEVFNDFYELWPEKFQNKTNGVTPRRWIRFCNPPLSAIITKWTGTEDWVLKTEKLAELQKFADNEDLQNEWREAKRSNKIKVVSFLKEKTGYSVVPDAMFDIQVKRIHEYKRQLLNIFGIVYRYKKMKEMTAAERKTNFVPRVCIFGGKAFATYVQAKRIVKFIIDVGATINHDPEIGDLLKVVFVPDYNVSVAELLIPASDLSEHISTAGMEASGTSNMKFAMNGCIQIGTLDGANVEIREEVGEENFFLFGAQAHEIAGLRKERADGKFVPDERFEEVKEFVRSGAFGSYNYDDLIGSLEGNEGFGRADYFLVGKDFPSYIECQEKVDEAYRDQKRWTTMSILNTAGSYKFSSDRTIHEYAKDIWNIEAVEIA

SEQ ID NO: 25 - protein, 712 aa, Bacillus sp.
MKRFMKLTAVWTLWLSLTLGLLSPVHAAPDTSVSNKQNFSTDVIYQIFTDRFSDGNPANNPTGAAFDGSCTNLRLYCGGDWQGIINKINDGYLTGMGITAIWISQPVENIYSVINYSGVHNTAYHGYWARDFKKTNPAYGTMQDFKNLIDTAHAHNIKVIIDFAPNHTSPASSDDPSFAENGRLYDNGNLLGGYTNDTQNLFHHYGGTDFSTIENGIYKNLYDLADLNHNNSSVDVYLKDAIKMWLDLGVDGIRVDAVKHMPFGWQKSFMSTINNYKPVFNFGEWFLGVNEISPEYHQFANESGMSLLDFPFAQKARQVFRDNTDNMYGLKAMLEGSEVDYAQVNDQVTFIDNHDMERFHTSNGDRRKLEQALAFTLTSRGVPAIYYGSEQYMSGGNDPDNRARIPSFSTTTTAYQVIQKLAPLRKSNPAIAYGSTQERWINNDVIIYERKFGNNVAVVAINRNMNTPASITGLVTSLPQGSYNDVLGGILNGNTLTVGAGGAASNFTLAPGGTAVWQYTTDATAPINGNVGPMMAKAGVTITIDGRASARQGTVYFGTTAVTGADIVAWEDTQIQVKILRVPGGIYDIRVANAAGAASNIYDNFEVLTGDQVTVRFVINNATTALGQNVFLTGNVSELGNWDPNNAIGPMYNQVVYQYPTWYYDVSVPAGQTIEFKFLKKQGSTVTWEGGANRTFTTPTSGTATVNVNWQP

SEQ ID NO: 26 - protein, 713 aa, Bacillus circulans
MKKFLKSTAALALGLSLTFGLFSPAQAAPDTSVSNKQNFSTDVIYQIFTDRFSDGNPANNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 27 - protein, 686 aa, Bacillus circulans
APDTSVSNKQNFSTDVIYQIFTDRFSDGNPANNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 28 - protein, 686 aa, synthetic construct
APDTSVSNKQNFSTDVIYQIFTDRFSDGNPRNNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 29 - protein, 685 aa, synthetic construct
APDTSVSNKQNFSTDVIYQIFTDRFSDGNPPNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 30 - protein, 685 aa, synthetic construct
APDTSVSNKQNFSTDVIYQIFTDRFSDGNPTNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 31 - protein, 714 aa, Paenibacillus macerans
MKSRYKRLTSLALSLSMALGISLPAWASPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 32 - protein, 687 aa, Paenibacillus macerans
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 33 - protein, 714 aa, Paenibacillus macerans
MKSRYKRLTSLALSLSMALGISLPAWASPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 34 - protein, 687 aa, Paenibacillus macerans
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 35 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADADNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 36 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADPDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 37 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRANPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 38 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRPNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 39 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADAPNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 40 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADPANPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 41 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADPPNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 42 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGKPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 43 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKRSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 44 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKRSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGKPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 45 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGKPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 46 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKRSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 47 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKRSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGKPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 48 - protein, 629 aa, synthetic construct
MGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLNEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA